(19) United States
(12) Patent Application Publication
(10) Pub. No.: US 2026/0319816 A1
(43) Pub. Date: Oct. 15, 2026

(54) ELECTRONIC DEVICE AND SCREEN DISPLAY METHOD

(71) Applicant: SAMSUNG ELECTRONICS CO., LTD., Suwon-si (KR)

(72) Inventors: Munhwi KIM, Suwon-si (KR); Hyunjung KIM, Suwon-si (KR); Heelim HAN, Suwon-si (KR); Dongjoo KO, Suwon-si (KR); Hyun KIM, Suwon-si (KR); Guhyun YANG, Suwon-si (KR); Ilku CHANG, Suwon-si (KR)

(21) Appl. No.: 19/689,635

(22) Filed: May 27, 2026

Related U.S. Application Data
(63) Continuation of application No. PCT/KR2024/019917, filed on Dec. 6, 2024.

(30) Foreign Application Priority Data
Dec. 7, 2023 (KR) 10-2023-0176699
Mar. 28, 2024 (KR) 10-2024-0042606

(51) Int. Cl. G06F 9/451; G06F 3/04817; G06F 3/0482; G06F 3/0483; G06F 3/0484; G06F 3/0488

(52) U.S. Cl. CPC G06F 9/451; G06F 3/04817; G06F 3/0482; G06F 3/0483; G06F 3/0484; G06F 3/0488; G06F 2203/04803; G06F 2203/04808

(57) ABSTRACT

A method of displaying a screen of an electronic device, may include: entering a multi-window preview mode in response to receiving, an input of a recent screen view, a second input on a first recently used screen displayed on a display; displaying at least some of the plurality of recently used screens in the multi-window preview mode; while the second input is maintained in the multi-window preview mode, when the first recently used screen is moved to a specific position for a target recently used screen, according to the second input, displaying, as a preview image, a layout of a multi-window in which the first recently used screen and the target recently used screen can be displayed together; and displaying, when the second input is released, the multi-window including the first recently used screen and the target recently used screen and corresponding to the preview image.

### CROSS-REFERENCE TO RELATED APPLICATIONS

This application is a continuation of International Application No. PCT/KR2024/019917 designating the United States, filed on Dec. 6, 2024, in the Korean Ministry of Intellectual Property Receiving Office and claiming priority to Korean Patent Application Nos. 10-2023-0176699, filed on Dec. 7, 2023, and 10-2024-0042606, filed on Mar. 28, 2024, in the Korean Ministry of Intellectual Property, the disclosures of each of which are incorporated by reference herein in their entireties.

### BACKGROUND

### Field

The disclosure relates to an electronic device and a screen display method.

### Description of Related Art

An electronic device, such as a smartphone, a tablet PC, a laptop PC, and a wearable device, may include a display. As the size of the display included in the electronic device has increased, it has become possible to display a plurality of application execution screens or windows on the electronic device.

### SUMMARY

An electronic device according to an example embodiment may include a display.

The electronic device according to an example embodiment may include a memory configured to store instructions.

The electronic device according to an example embodiment may include at least one processor comprising processing circuitry.

The instructions according to an example embodiment may, when executed by the at least one processor, individually and/or collectively, cause the electronic device to display a user interface of a recent screen view, to enable browsing a plurality of recently used screens, on the display by executing the recent screen view, based on a first input, each of the plurality of recently used screens indicating an execution screen of an application previously executed or currently being executed in the electronic device.

The instructions according to an example embodiment may, when executed by the at least one processor, individually and/or collectively, cause the electronic device to enter a multi-window preview mode in response to receiving a second input to a first recently used screen displayed on the display among the plurality of recently used screens through the user interface of the recent screen view.

The instructions according to an example embodiment may, when executed by the at least one processor, individually and/or collectively, cause the electronic device to display at least some of the plurality of recently used screens in the multi-window preview mode and, based on the first recently used screen moving to a specific location for a target recently used screen among the plurality of recently used screens in which the first recently used screen is displayed according to the second input while the second input is maintained in the multi-window preview mode, display a layout of a multi-window for displaying both the first recently used screen and the target recently used screen as a preview image. The instructions according to an example embodiment may cause, when executed by the at least one processor, individually and/or collectively, may cause the electronic device to display the multi-window including the first recently used screen and the target recently used screen and corresponding to the preview image based on the second input being released.

A method of displaying a screen by an electronic device according to an example embodiment may include displaying a user interface of a recent screen view, to enable browsing a plurality of recently used screens, on a display by executing the recent screen view, based on a first input. Each of the plurality of recently used screens may indicate an execution screen of an application previously executed or currently being executed in the electronic device. The method may include entering a multi-window preview mode in response to receiving a second input to a first recently used screen displayed on the display among the plurality of recently used screens through the user interface of the recent screen view. The method may include displaying at least some of the plurality of recently used screens in the multi-window preview mode. The method may include, based on the first recently used screen moving to a specific location for a target recently used screen among the plurality of recently used screens in which the first recently used screen is displayed according to the second input while the second input is maintained in the multi-window preview mode, displaying a layout of a multi-window for displaying both the first recently used screen and the target recently used screen as a preview image. The method may include, based on the second input being released, displaying the multi-window including the first recently used screen and the target recently used screen and corresponding to the preview image.

### BRIEF DESCRIPTION OF THE DRAWINGS

With regard to the description of the drawings, the same or like reference signs may be used to designate the same or like elements. Further, the above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIGS. 2A and 2B are diagrams illustrating an example screen display method of the electronic device according to various example embodiments.

FIG. 2C is a diagram illustrating an example screen display method of the electronic device according to various example embodiments.

FIG. 3 is a flowchart illustrating an example screen display method of the electronic device according to various example embodiments.

FIGS. 4A and 4B are diagrams illustrating an example screen display method of the electronic device according to various example embodiments.

FIG. 5 is a flowchart illustrating an example screen display method of the electronic device according to various example embodiments.

FIG. 6 is a diagram illustrating an example operation of terminating a multi-window preview mode of the electronic device according to various example embodiments.

FIG. 7 is a diagram illustrating an example operation of terminating a multi-window preview mode of then electronic device according to various example embodiments.

FIGS. 8A and 8B are diagrams illustrating an example operation of terminating a multi-window preview mode of the electronic device according to various example embodiments.

FIGS. 9A and 9B are diagrams illustrating an example operation of terminating a multi-window preview mode of the electronic device according to various example embodiments.

FIG. 10 is a flowchart illustrating an example operation of terminating a multi-window preview mode of the electronic device according to various example embodiments.

FIGS. 11A and 11B are diagrams illustrating an example screen display method of the electronic device according to various example embodiments.

FIGS. 12A and 12B are diagrams illustrating an example screen display method of the electronic device according to various example embodiments.

FIG. 13 is a diagram illustrating an example screen display method of the electronic device according to various example embodiments.

FIG. 14 is a diagram illustrating an example screen display method of the electronic device according to various example embodiments.

FIGS. 15A and 15B are diagrams illustrating an example screen display method of the electronic device according to various example embodiments.

FIGS. 16A and 16B are diagrams illustrating an example screen display method of the electronic device according to various example embodiments.

FIG. 17 is a flowchart illustrating an example screen display method of the electronic device according to various example embodiments.

FIGS. 18A and 18B are diagrams illustrating an example screen display method of the electronic device according to various example embodiments.

FIG. 19 is a diagram illustrating an example screen display method of the electronic device according to various example embodiments.

FIG. 20 is a flowchart illustrating an example screen display method of the electronic device according to various example embodiments.

FIG. 21 is a flowchart illustrating an example screen display method of the electronic device according to various example embodiments.

FIG. 22 is a diagram illustrating an example screen display method of the electronic device according to various example embodiments.

FIG. 23 is a diagram illustrating an example screen display method of the electronic device according to various example embodiments.

FIG. 24 is a flowchart illustrating an example screen display method of the electronic device according to various example embodiments.

FIGS. 25A and 25B are diagrams illustrating an example screen display method of the electronic device according to various example embodiments.

FIG. 26 is a diagram illustrating an example screen display method of the electronic device according to various example embodiments.

FIGS. 27A and 27B are diagrams illustrating an example screen display method of the electronic device according to various example embodiments.

FIG. 28 is a diagram illustrating an example screen display method of the electronic device according to various example embodiments.

FIGS. 29A and 29B are diagrams illustrating an example screen display method of the electronic device according to various example embodiments.

FIG. 30 is a diagram illustrating an example screen display method of the electronic device according to various example embodiments.

FIG. 31 is a flowchart illustrating an example screen display method of the electronic device according to various example embodiments.

FIG. 32 is a diagram illustrating an example screen display method of the electronic device according to various example embodiments.

FIG. 33 is a diagram illustrating an example screen display method of the electronic device according to various example embodiments.

FIG. 34 is a diagram illustrating an example screen display method of the electronic device according to various example embodiments.

FIG. 35 is a flowchart illustrating an example screen display method of the electronic device according to various example embodiments.

FIG. 36 is a diagram illustrating an example screen display method of the electronic device according to various example embodiments.

### DETAILED DESCRIPTION

While performing tasks through a plurality of application execution screens or windows, a user may temporarily use the home screen or other applications. In this case, the plurality of application execution screens or windows that were being executed may be in a paused state in the background.

When the user has used the home screen or other applications and then wants to perform tasks through a plurality of application execution screens or windows again, the user may make a request for providing a list or image of recently used applications (e.g., a recent screen) to the electronic device and select the plurality of application execution screens or windows again.

An aspect of the disclosure is to display a multi-window or a split window by selecting a pairing target application in a recent screen view in which a plurality of application execution screens or windows are being displayed

An electronic device and a screen display method according to an example embodiment of the disclosure may provide a multi-window or split window according to selection of applications in a recent screen view, thereby providing the user with various interaction screens.

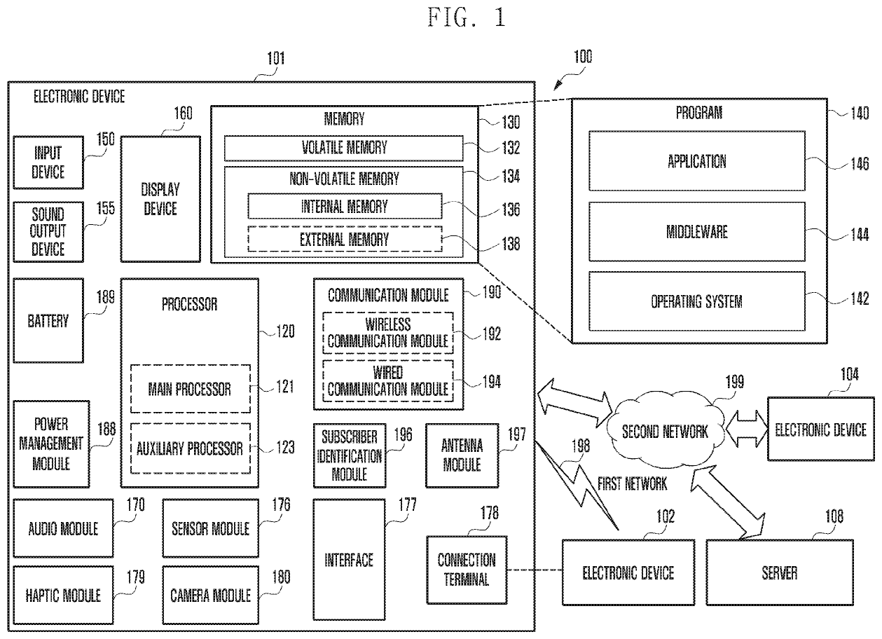

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

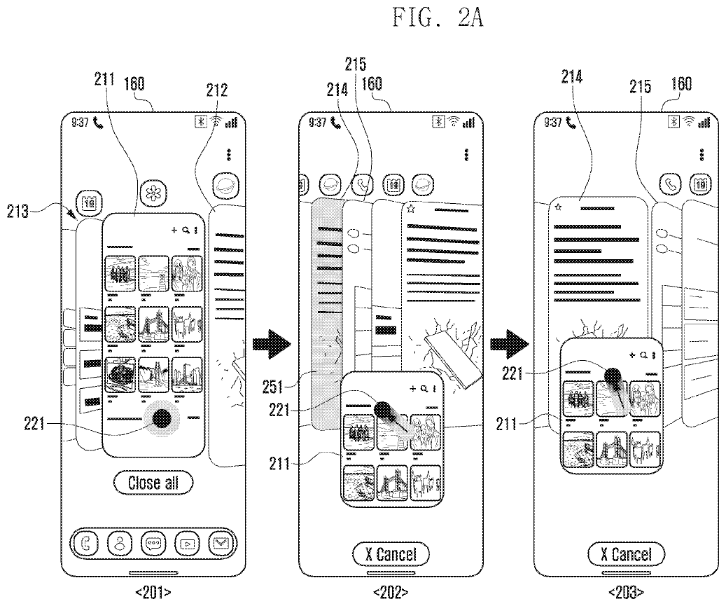

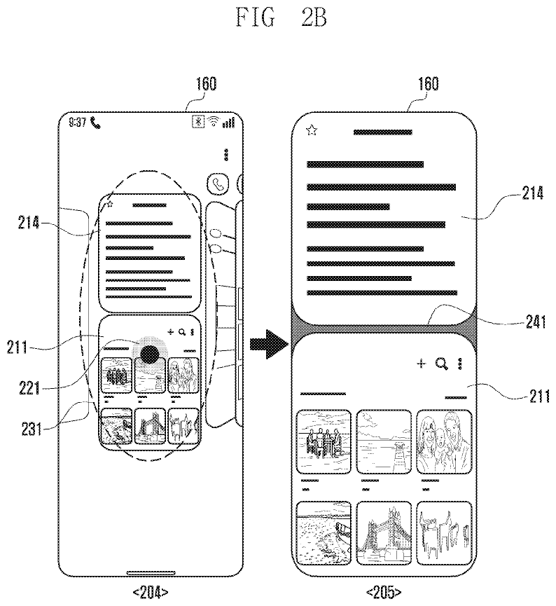

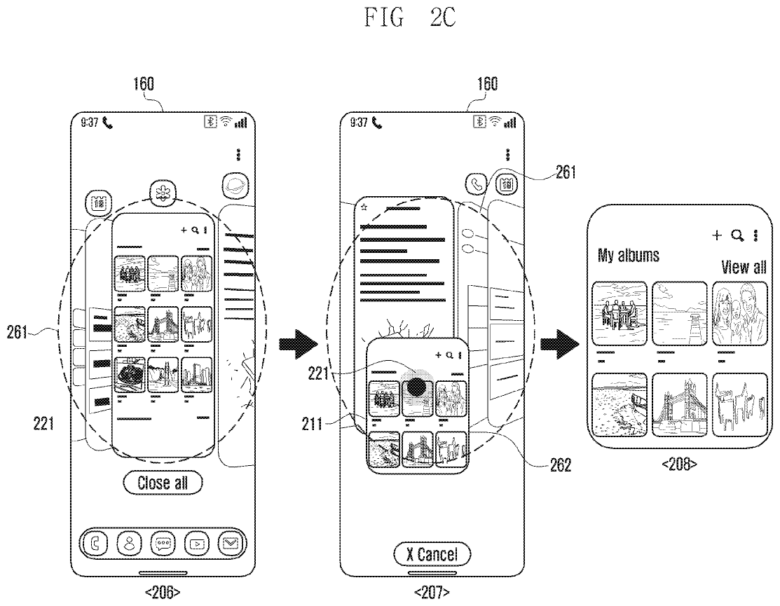

FIGS. 2A and 2B are diagrams illustrating an example screen display method of the electronic device 101 according to various example embodiments.

In an embodiment, the memory 130 may store instructions. The instructions, when executed by the processor 120, may cause the electronic device 101 to perform the screen display method in FIG. 2A.

The instructions stored in the memory 130 may, when executed by the processor 120, cause the electronic device 101 to display a recent screen view on the display 160, based on an input (e.g., a user input), in the screen 201.

In the screen 201, when the recent screen view is executed, the instructions stored in the memory 130 may, when executed by the processor 120, cause the electronic device 101 to display recently used screens 211, 212, and 213 of previously or currently executed applications on the display 160.

In the screen 201, each of the recently used screens 211, 212, and 213 of previously or currently executed applications may include a thumbnail image in the recent screen display screen.

In the screen 201, when the recent screen view is executed, the instructions stored in the memory 130 may, when executed by the processor 120, cause the electronic device 101 to display the recently used screens 211, 212, and 213 of the previously or currently executed applications three-dimensionally on the display 160.

In the screen 201, in the recent screen view screen, each of the recently used screens 211, 212, and 213 of previously or currently executed applications may include an image rendered in perspective.

In the screen 201, when the recent screen view is executed, the instructions stored in the memory 130 may, when executed by the processor 120, cause the electronic device 101 to start an operation of executing a multi-window if a user input 221 for a first recently used screen 211 is received.

When the recent screen view is executed in screen 201, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of the plurality of recently used screens, entering a multi-window mode, and/or performing full-screen execution with regard to a selected recently used screen.

In the screen 201, when the recent screen view is executed, the instructions stored in the memory 130 may, when executed by the processor 120, cause the electronic device 101 to trigger an operation of executing a multi-window if a user input 221 for the first recently used screen 211 is received. The user input 221 may include a press (e.g., a long press or a short press) input for the first recently used screen 211. The user input 221 may include a press input and a drag input. The user input 221 may include a drag input which is continuous to a press input.

In the screen 201, the user input 221 may include a long-press input for one (e.g., the first recently used screen 211) of the recently used screens 211, 212, and 213. However, the disclosure is not limited thereto, and the user input 221 may be a touch input for one (e.g., the first recently used screen 211) of the recently used screens 211, 212, and 213.

In an embodiment, the operation of executing the multi-window may include an operation of entering a multi-window preview mode or an operation of entering a multi-window editing mode. A mode may include a state in which the electronic device 101 may perform a specific task. The operation of entering the multi-window preview mode or the operation of entering the multi-window editing mode may include a state in which the electronic device 101 may perform an editing task for the multi-window using the recently used screens 211, 212, and 213.

When the operation of executing the multi-window is triggered in the screen 202, the instructions stored in the memory 130 may, when executed by the processor 120, cause the electronic device 101 to display a recently used screen (e.g., the first recently used screen 211) selected according to a user input (e.g., the user input 221) as a preview on the display 160.

In the screen 202, the instructions stored in the memory 130 may, when executed by the processor 120, cause the electronic device 101 to arrange and display other recently used screens (e.g., another recently used screen 214) excluding the selected recently used screen (e.g., first recently used screen 211) on the display 160.

In the screen 202, the instructions stored in the memory 130 may, when executed by the processor 120, cause the electronic device 101 to display, on the display 160, other recently used screens (e.g., another recently used screen 214) excluding the selected recently used screen (e.g., the first recent use screen 211) as images rendered in perspective.

In the screen 202, the instructions stored in the memory 130 may, when executed by the processor 120, cause the electronic device 101 to arrange other recently used screens 214 and 215 excluding the selected recently used screen (for example, the first recent use screen 211)) as images rendered in perspective and display the same on the display 160.

In the screen 202, the instructions stored in the memory 130 may, when executed by the processor 120, cause the electronic device 101 to reduce the size of the selected recently used screen (e.g., first recently used screen 211) compared to the size of the screen and display the same on the display 160.

In the screen 202, the instructions stored in the memory 130 may, when executed by the processor 120, cause the electronic device 101 to change the size of the selected recently used screen (e.g., the first recently used screen 211) and display the same on the display 160.

The user inputs 221 of the 202 screen, 203 screen, and 204 screen may be inputs that are continuously input into to the user input 221 of the screen 201. The user inputs 221 of the screen 202 and the screen 203 may be drag inputs.

The user inputs 221 of the screen 202, screen 203, and screen 204 screens may be user inputs of moving while the user input 221 of the 201 screen is maintained.

In the screen 202, the instructions stored in the memory 130 may, when executed by the processor 120, cause the electronic device 101 to display movement of the recently used screen (e.g., the first recently used screen 211) selected based on the user input 221 on the display 160.

In the screen 202, the recently used screen (e.g., the first recently used screen 211) may be displayed while being overlaid on the other recently used screens 214 and 215.

In the screen 202, the instructions stored in the memory 130 may, when executed by the processor 120, cause the electronic device 101 to display the recently used screen (e.g., the first recently used screen 211) moving according to the user input 221 to be overlaid on other recently used screens 214 and 215.

When the selected recently used screen (e.g., the first recent usage screen 211) moving according to the user input 221 moves to the target recently used screen (e.g., the second recent usage screen 214), the instructions stored in the memory 130 may, when executed by the processor 120, cause the electronic device 101 to display the target recently used screen (e.g., the second recent usage screen 214) on the display 160 as a plane (or front) image.

In an embodiment, the target recently used screen (for example, the second recent used screen 214) may be displayed as a multi-window together with the selected recently used screen (for example, the first recent used screen 211).

When the selected recently used screen (e.g., the first recently used screen 211) moving according to the user input 221 moves beyond a specific position of the target recently used screen (e.g., the second recent use screen 214) in the screen 204, the instructions stored in the memory 130 may, when executed by the processor 120, cause the electronic device 101 to display a preview image 231 on the display 160. Other recently used screens (e.g., other recently used screen 215) that are not the target recently used screen (e.g., the second recent use screen 214) may be displayed on the display 160 as images rendered in perspective.

In the screen 204, the preview image 231 may include the target recently used screen (e.g., the second recently used screen 214) and the selected recently used screen (e.g., the first recently used screen 211). The preview image 231 may include a layout when the preview image is shown as a multi-window.

In the screen 205, when the user input 221 is released, the instructions stored in the memory 130 may, when executed by the processor 120, cause the electronic device 101 to display the target recently used screen (e.g., the second recent use screen 214) and the selected recently used screen (e.g., the first recently used screen 211) on the display 160 as a multi-window.

In the screen 205, when the user input 221 is released, the electronic device 101 may, according to the control of the processor 120, display the target recently used screen (e.g., the second recently used screen 214) and the selected recently used screen (e.g., the first recent use screen 211) on the display 160 as split windows. According to the control of the processor 120, the electronic device 101 may display a bar 241 between the target recently used screen (e.g., the second recent use screen 214) and the selected recently used screen (e.g., the first recent use screen 211) on the display 160. Under the control of the processor 120, the electronic device 101 may move the bar in accordance with the user input and display the same on the display 160. As the bar moves, the screen ratio of the target recently used screen (e.g., the second recently used screen 214) and the selected recently used screen (e.g., the first recently used screen 211) may be different.

In the screen 205, when the user input 221 is released, the instructions stored in the memory 130 may, when executed by the processor 120, cause the electronic device 101 to display the target recently used screen (e.g., the second recent use screen 214) and the selected recently used screen (e.g., the first recently used screen 211) on the display 160 as split windows. The instructions stored in the memory 130 may, when executed by the processor 120, cause the electronic device 101 to display the bar 241 between the target recently used screen (e.g., the second recent use screen 214) and the selected recently used screen (e.g., the first recent use screen 211) on the display 160. The instructions stored in the memory 130 may, when executed by the processor 120, cause the electronic device 101 to move the bar according to the user input and display the same on the display 160.

FIG. 2C is a diagram illustrating an example screen display method the an electronic device 101 according to various example embodiments.

The instructions stored in the memory 130 may, when executed by the processor 120, cause the electronic device 101 to display a recent screen view on the display 160, based on an input (e.g., a user input), in the screen 206.

In the screen 206, when the recent screen view is executed, the instructions stored in the memory 130 may, when executed by the processor 120, cause the electronic device 101 to display recently used screens 261 of previously or currently executed applications on the display 160. Each of the recently used screens 261 may include a thumbnail image. Each of the recently used screens 261 may include an image rendered in perspective.

In the screen 207, when the user input for the selected recently used screen 262 is received, the instructions stored in the memory 130 may, when executed by the processor 120, cause the electronic device 101 to start the operation of executing the multi-window. When the operation of executing the multi-window is triggered, the instructions stored in the memory 130 may, when executed by the processor 120, cause the electronic device 101 to display the selected recently used screen 262 according to the user input as a preview on the display 160. The instructions stored in the memory 130 may, when executed by the processor 120, cause the electronic device 101 to display, on the display 160, other recently used screens excluding the selected recently used screen 262 as images rendered in perspective.

Referring to screens 207 and 208, when the selected recently used screen 262 is displayed as the preview, the instructions stored in the memory 130 may, when executed by the processor 120, cause the electronic device 101 to reduce the size of the selected recently used screen 262 compared to the previous size and display the recently used screen.

In the screen 207, when the selected recently used screen 262 moving according to the user input moves to the target recently used screen, the electronic device 101 may, under control of the processor 120, display the target recently used screen as a plane (or front) image on the display 160.

In the screen 207, when the selected recently used screen 262 moving according to the user input moves to the target recently used screen, the instructions stored in the memory 130 may, when executed by the processor 120, cause the electronic device 101 to display the target recently used screen as a plane (or front) image on the display 160.

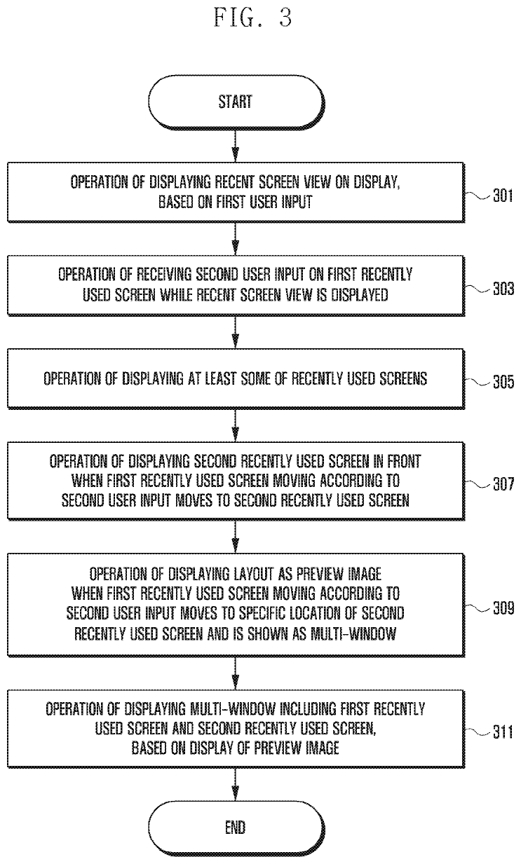

FIG. 3 is a flowchart illustrating an example screen display method of the electronic device 101 according to various example embodiments.

In an embodiment, the memory 130 may store instructions. The instructions may, when executed by the processor 120, cause the electronic device 101 to perform the screen display method of FIG. 3.

In an embodiment, in operation 301, the instructions stored in the memory 130 may, when executed by the processor 120, cause the electronic device 101 to display a recent screen view on the display 160, based on a first user input.

In an embodiment, in operation 301, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, the display 160 may include a touch panel or a touch sensor configured to receive a touch input. The first input (e.g., first user input) may include an input of swiping the display 160. For example, the electronic device 101 may receive the first user input on the display 160 while displaying a home screen or an application screen being executed. However, the disclosure is not limited thereto, and the first user input may include a touch input for a control graphical user interface (GUI) on the display 160. The control GUI may include a GUI for the recent screen view. For example, when receiving a touch input for the GUI for the recent screen view, the electronic device 101 may display the recent screen on the display 160.

However, the disclosure is not limited thereto, and operation 301 may be omitted.

In an embodiment, in operation 303, the instructions stored in the memory 130 may, when executed by the processor 120, cause the electronic device 101 to receive a second input (e.g., a second user input) to the first recently used screen (e.g., the first recently used screen 211 of FIG. 2A) while displaying the recent screen view. The first recently used screen may be included in the recent screen view.

In an embodiment, the second user input may include, for example, the user input 221 mentioned in FIGS. 2A and 2B. The second user input may include a press (e.g., long press or short press) input for the first recent usage screen (e.g., the first recently used screen 211 of FIG. 2A). The second user input may include a press input and a drag input. The second user input may include a drag input following a press input.

In an embodiment, in operation 303, when receiving the second user input to the first recently used screen (e.g., the first recent use screen 211 in FIG. 2A), the instructions stored in the memory 130 may, when executed by the processor 120, cause the electronic device 101 to perform a multi-window editing operation.

In an embodiment, in operation 303, when receiving the second user input to the first recently used screen (e.g., the first recent use screen 211 in FIG. 2A), the instructions stored in the memory 130 may, when executed by the processor 120, cause the electronic device 101 to enter a multi-window preview mode.

In an embodiment, in operation 303, when receiving the second user input to the first recently used screen (e.g., the first recently used screen 211 in FIG. 2A), the instructions stored in the memory 130 may, when executed by the processor 120, cause the electronic device 101 to determine that the first recently used screen (e.g., the first recently used screen 211 in FIG. 2A) has been selected.

In an embodiment, in operation 305, the instructions stored in the memory 130 may, when executed by the processor 120, cause the electronic device 101 to display at least some of the recently used screens on the display 160.

In an embodiment, in operation 305, the instructions stored in the memory 130 may, when executed by the processor 120, cause the electronic device 101 to display other recently used screens as images rendered in perspective.

However, the disclosure is not limited thereto, and in operation 305, the instructions stored in the memory 130 may, when executed by the processor 120, cause the electronic device 101 to rotate at least some of the recently used screens about a specific axis or render them frontally without rotation and display them as images.

In an embodiment, in operation 305, the instructions stored in the memory 130 may, when executed by the processor 120, cause the electronic device 101 to display images by rendering the recently used screens in a form in which they vanish into one point.

In an embodiment, in operation 305, the instructions stored in the memory 130 may, when executed by the processor 120, cause the electronic device 101 to display other recently used screens which have not been selected as images rendered in perspective.

In an embodiment, the images rendered in perspective may include an image to which a linear perspective technique for three-dimensionally expressing the image, based on a line extending from a vanishing point, is applied.

In an embodiment, the recently used screen being displayed in the recent screen view may be displayed in a state of being rotated around a specific axis (for example, a vertical axis). The other recently used screens excluding the first recently used screen (e.g., the first recently used screen 211 in FIG. 2A) may include an image rotated with respect to the vertical axis.

In an embodiment, in operation 307, when the first recently used screen (e.g., the first recently used screen 211 in FIG. 2A) moving according to the second user input (e.g., drag input) moves to the second recently used screen (e.g., the second recently used screen 214 in FIG. 2A) or the target recently used screen (e.g., the second recently used screen 214 in FIG. 2A), the instructions stored in the memory 130 may, when executed by the processor 120, cause the electronic device 101 to display the second recently used screen (e.g., the second recently used screen 214 in FIG. 2A) on the display 160 in front.

In an embodiment, in operation 307, when the first recently used screen (e.g., the first recently used screen 211 in FIG. 2A) moving according to the second user input (e.g., drag input) moves to the second recently used screen (e.g., the second recently used screen 214 in FIG. 2A) or a target recent use screen (e.g., the second recent use screen 214 in FIG. 2A) while the second user input is maintained, the instructions stored in the memory 130 may, when executed by the processor 120, cause the electronic device 101 to display the second recently used screen (e.g., the second recent use screen 214 in FIG. 2A) on the display 160 in the front.

However, the disclosure is not limited, in operation 307, when the first recently used screen (e.g., the first recently used screen 211 in FIG. 2A) moving according to the second user input (e.g., drag input) moves to the second recently used screen (e.g., the second recently used screen 214 in FIG. 2A) or the target recently used screen (e.g., the second recently used screen 214 in FIG. 2A), the instructions stored in the memory 130 may, when executed by the processor 120, cause the electronic device 101 to rotate the second recently used screen (e.g., the second recently used screen 214 in FIG. 2A) around a specific axis or to display the second recently used screen on the display 160 in front without rotation. When the first recently used screen (e.g., the first recently used screen 211 in FIG. 2A) moving according to the second user input (e.g., drag input) moves to the second recently used screen (e.g., the second recently used screen 214 in FIG. 2A) or the target recently used screen (e.g., the second recently used screen 214 in FIG. 2A), the instructions stored in the memory 130 may, when executed by the processor 120, cause the electronic device 101 to display the second recently used screen (e.g., the second recently used screen 214 in FIG. 2A) on the display 160 in various ways.

In an embodiment, in operation 307, when the first recently used screen (e.g., the first recently used screen 211 in FIG. 2A) moving according to the second user input (e.g., the drag input) moves to the second recently used screen (e.g., the second recently used screen 214 in FIG. 2A) or the target recently used screen (e.g., the second recently used screen 214 in FIG. 2A) among the recently used screens, the instructions stored in the memory 130 may, when executed by the processor 120, cause the electronic device 101 to display a layout as a preview image on the display 160.

In an embodiment, in operation 307, when the first recently used screen (e.g., the first recently used screen 211 in FIG. 2A) moving according to the second user input (e.g., the drag input) moves to the second recently used screen (e.g., the second recently used screen 214 in FIG. 2A) or the target recently used screen (e.g., the second recently used screen 214 in FIG. 2A), the instructions stored in the memory 130 may, when executed by the processor 120, cause the electronic device 101 to display the first recently used screen in a plane without a sense of depth.

In an embodiment, in operation 307, when the first recently used screen (e.g., the first recently used screen 211 in FIG. 2A) moving according to the second user input (e.g., the drag input) moves to the second recently used screen (e.g., the second recently used screen 214 in FIG. 2A) or the target recently used screen (e.g., the second recently used screen 214 in FIG. 2A), the instructions stored in the memory 130 may, when executed by the processor 120, cause the electronic device 101 to rotate the image displayed in perspective and display the same in a plane.

In an embodiment, operation 305 and operation 307 may be omitted.

In an embodiment, in operation 309, when the instructions stored in the memory 130, when the first recently used screen (e.g., the first recently used screen 211 in FIG. 2A) moving according to the second user input (e.g., the drag input) moves to a specific position of the target recently used screen (for example, the second recently used screen 214 in FIG. 2A), the instructions stored in the memory 130 may, when executed by the processor 120, cause the electronic device 101 to display a layout as a preview image when it is shown as a multi-window.

In an embodiment, in operation 309, when the instructions stored in the memory 130, when the first recently used screen (e.g., the first recently used screen 211 in FIG. 2A) moving according to the second user input moves to a specific position of the target recently used screen (for example, the second recently used screen 214 in FIG. 2A) while the second user input is maintained in the multi-window preview mode, the instructions stored in the memory 130 may, when executed by the processor 120, cause the electronic device 101 to display a layout as a preview image when it is shown as a multi-window.

In an embodiment, the layout of the multi-window may be differently displayed according to the position of the first recently used screen (e.g., the first recently used screen 211 in FIG. 2A) placed on the second recently used screen (e.g., the second recently used screen 214 in FIG. 2A).

For example, the first recently used screen (e.g., the first recently used screen 211 in FIG. 2A) may be displayed in the upper part of the multi-window, and the second recently used screen (e.g., the second recently used screen 214 in FIG. 2A) may be displayed in the lower part of the multi-window, according to the position of the first recently used screen (e.g., the first recently used screen 211 in FIG. 2A) placed on the second recently used screen (e.g., the second recently used screen 214 in FIG. 2A). However, the disclosure is not limited thereto, and the first recently used screen (e.g., the first recently used screen 211 in FIG. 2A) may be displayed in the lower part of the multi-window, and the second recently used screen (e.g., the second recently used screen 214 in FIG. 2A) may be displayed in the lower part of the multi-window, according to the position of the first recently used screen (e.g., the first recently used screen 211 in FIG. 2A) placed on the second recently used screen (e.g., the second recently used screen 214 in FIG. 2A). The first recently used screen (for example, the first recently used screen 211 in FIG. 2A) may be overlaid on the second recently used screen (for example, the second recently used screen 214 in FIG. 2A) and displayed as a pop-up window according to the position of the first recently used screen (for example, the first recently used screen 211 in FIG. 2A) placed on the second recently used screen (for example, the second recently used screen 214 in FIG. 2A).

In an embodiment, in operation 311, the instructions stored in the memory 130 may, when executed by the processor 120, cause the electronic device 101 to display a multi-window including the first recently used screen (e.g., first recently used screen 211 in FIG. 2A) and the second recently used screen (e.g., second recently used screen 214 in FIG. 2A), based on the display of the preview image.

In an embodiment, in operation 311, when the second user input is released while the preview image is being displayed, the instructions stored in the memory 130 may, when executed by the processor 120, cause the electronic device 101 to display a multi-window including the first recently used screen (e.g., the first recently used screen 211 in FIG. 2A) and the second recently used screen (e.g., the second recently used screen 214 in FIG. 2A), based on the display of the preview image.

In an embodiment, in operation 311, when a specified time arrives while the preview image is being displayed, the instructions stored in the memory 130 may, when executed by the processor 120, cause the electronic device 101 to display a multi-window including the first recently used screen (e.g., the first recently used screen 211 in FIG. 2A) and the second recently used screen (e.g., the second recently used screen 214 in FIG. 2A), based on the display of the preview image.

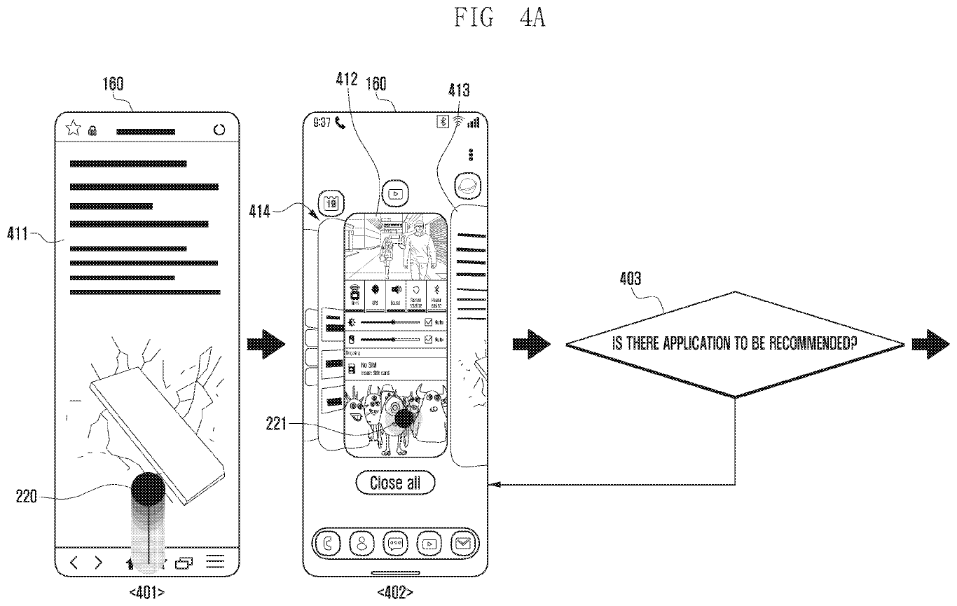

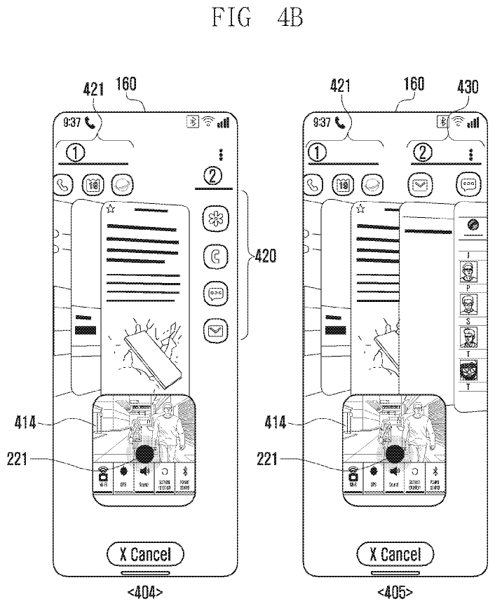

FIG. 4 is a diagram illustrating an example screen display method of the electronic device 101 according to various example embodiments.

In an embodiment, the screen display method of FIG. 4 may recommend applications that may be displayed together in a multi-window.

In an embodiment, the memory 130 may store instructions. The instructions stored in the memory 130 may, when executed by the processor 120, cause the electronic device 101 to perform the screen display method of FIG. 4.

In the screen 401, the instructions stored in the memory 130 may, when executed by the processor 120, cause the electronic device 101 to display a screen 411 corresponding to an application being executed on the display 160. However, the disclosure is not limited thereto, and the screen displayed on the display 160 in screen 401 may include one of a screen corresponding to the application being executed, a home screen, or a lock screen.

In the screen 401, while the screen 411 corresponding to the application being executed is displayed, the instructions stored in the memory 130 may, when executed by the processor 120, cause the electronic device 101 to determine whether a third user input 220 has been received.

In the screen 402, the instructions stored in the memory 130 may, when executed by the processor 120, cause the electronic device 101 to display a recent screen view (e.g., recent view) on the display 160, based on the third user input 220. When the recent screen view is executed, the instructions stored in the memory 130 may, when executed by the processor 120, cause the electronic device 101 to display one or more recently used screens 412, 413, and 414 on the display 160. For example, when the recent screen view is executed, the instructions stored in the memory 130 may, when executed by the processor 120, cause the electronic device 101 to display a third recently used screen 412, a fourth recently used screen 413, and a fifth recently used screen 414 on the display 160.

In the screen 402, the instructions stored in the memory 130 may, when executed by the processor 120, cause the electronic device 101 to receive a user input 221 for the third recently used screen 412. When the user input 221 is received for the third recently used screen 412, the instructions stored in the memory 130 may, when executed by the processor 120, cause the electronic device 101 to enter the multi-window preview mode.

In the screen 402, when the recent screen view is executed, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In operation 403, when entering the multi-window preview mode, the instructions stored in the memory 130 may, when executed by the processor 120, cause the electronic device 101 to identify whether there are applications to be recommended.

For example, the third recently used screen 412 receiving the user input 221 may include a third application execution or use screen. The third recently used screen 412 may correspond to the third application execution or use screen.

In an embodiment, the standard by which the electronic device 101 selects an application to be recommended may be based on at least one of a multi-window usage history learned in relation to the third application, an association between the third application and the application to be recommended, categories of the third application and the application to be recommended, or a usage time of the application to be recommended.

In an embodiment, the electronic device 101 may recommend an application which has been continuously used in a time or a location adjacent to the current time and/or current location information acquired by the electronic device 101 among applications which have not been recently used.

For example, when there is a multi-window usage history learned in relation to the third application, the instructions stored in the memory 130 may, when executed by the processor 120, cause the electronic device 101 to display recently used screens for applications to be recommended on the display 160.

For example, when there is a multi-window usage history learned in relation to the third application, the instructions stored in the memory 130 may, when executed by the processor 120, cause the electronic device 101 to display recently used screens for the applications to be recommended on the display 160.

For example, when there is an association between the third application and the application to be recommended, the instructions stored in the memory 130 may, when executed by the processor 120, cause the electronic device 101 to display a recently used screen for the application to be recommended on the display 160. The instructions stored in the memory 130 may, when executed by the processor 120, cause the electronic device 101 to analyze the association between applications, based on at least one of a usage pattern or a usage time of the application.

For example, when the categories of the third application and the application to be recommended are the same, the instructions stored in the memory 130 may, when executed by the processor 120, cause the electronic device 101 to display a recently used screen for the application to be recommended on the display 160.

For example, when the usage time of the application to be recommended is equal to or longer than a specific time, the instructions stored in the memory 130 may, when executed by the processor 120, cause the electronic device 101 to display a recently used screen for the application to be recommended on the display 160.

For example, the instructions stored in the memory 130 may, when executed by the processor 120, cause the electronic device 101 to display, on the display 160, a recently used screen for an application which has been continuously used in an adjacent time or an adjacent location to the current time and/or current location information acquired by the electronic device 101 among applications which have not been recently used.

In an embodiment, when there are applications to be recommended, the instructions stored in the memory 130 may, when executed by the processor 120, cause the electronic device 101 to display icons 420 of the applications to be recommended in the screen 404.

In an embodiment, when there are applications to be recommended, the instructions stored in the memory 130 may, when executed by the processor 120, cause the electronic device 101 to display the icons 420 of the applications to be recommended and recently used screens 421 in operation 403.

When there are applications to be recommended, the instructions stored in the memory 130 may, when executed by the processor 120, cause the electronic device 101 to display usage screens 430 of the applications to be recommendation in the screen 405.

In an embodiment, when there are applications to be recommended, instructions stored in the memory 130 may, when executed by the processor 120, cause the electronic device 101 to display usage screens 430 of the applications to be recommended and the recently used screens 421 in operation 403.

In an embodiment, when there are no applications to be recommended, the instructions stored in the memory 130 may, when executed by the processor 120, cause the electronic device 101 to continuously display the recently used screens being displayed in the 402 screen on the display 160.

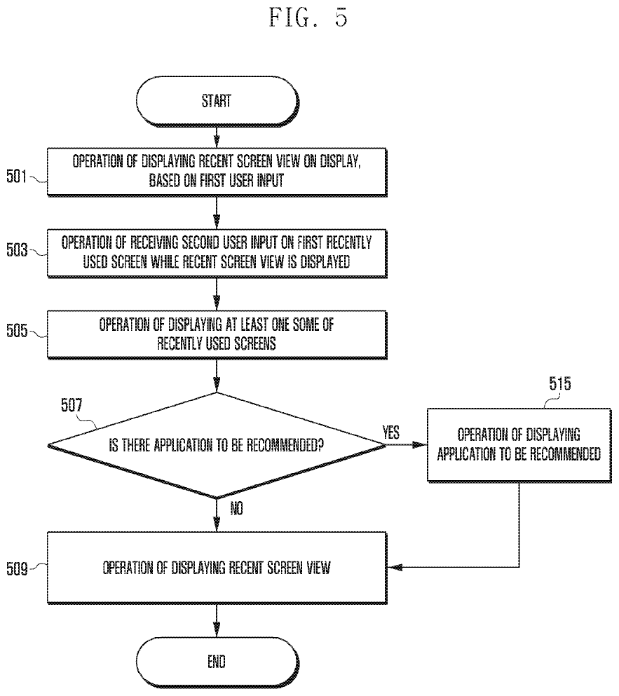

FIG. 5 is a flowchart illustrating an example screen display method of the electronic device 101 according to various example embodiments.

In an embodiment, the memory 130 may store instructions. The instructions may, when executed by the processor 120, cause the electronic device 101 to perform the screen display method in FIG. 5.

In an embodiment, in operation 501, the instructions stored in the memory 130 may, when executed by the processor 120, cause the electronic device 101 to display a recent screen view on the display 160, based on a first user input. The first user input may include the first user input mentioned in FIG. 3. However, the disclosure is not limited thereto, and operation 501 may be omitted.

In an embodiment, in operation 501, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 503, the instructions stored in the memory 130 may, when executed by the processor 120, cause the electronic device 101 to receive a second user input to the first recently used screen (e.g., the first recently used screen 211 of FIG. 2A) while displaying the recent screen view. The first recently used screen may be included in the recent screen view.

In an embodiment, the second user input may include, for example, the user input 221 mentioned in FIGS. 2A, 2B, 2C, 3, and 4A and 4B (which may be referred to as FIG. 4).

In an embodiment, in operation 503, when receiving the second user input to the first recently used screen (e.g., the first recent use screen 211 in FIG. 2A), the instructions stored in the memory 130 may, when executed by the processor 120, cause the electronic device 101 to perform a multi-window editing operation.

In an embodiment, in operation 503, when receiving the second user input to the first recently used screen (e.g., the first recent use screen 211 in FIG. 2A), the instructions stored in the memory 130 may, when executed by the processor 120, cause the electronic device 101 to enter a multi-window preview mode.

In an embodiment, in operation 503, when receiving the second user input to the first recently used screen (e.g., the first recently used screen 211 in FIG. 2A), the instructions stored in the memory 130 may, when executed by the processor 120, cause the electronic device 101 to determine that the first recently used screen (e.g., the first recently used screen 211 in FIG. 2A) has been selected.

In an embodiment, in operation 505, the instructions stored in the memory 130 may, when executed by the processor 120, cause the electronic device 101 to display at least some of the recently used screens on the display 160.

In an embodiment, in operation 505, the instructions stored in the memory 130 may, when executed by the processor 120, cause the electronic device 101 to display other recently used screens as images rendered in perspective.

However, the disclosure is not limited thereto, and in operation 505, the instructions stored in the memory 130 may, when executed by the processor 120, cause the electronic device 101 to rotate at least some of the recently used screens about a specific axis or render them frontally without rotation and display them as images.

In an embodiment, in operation 505, the instructions stored in the memory 130 may, when executed by the processor 120, cause the electronic device 101 to render and display the recently used screens in a form in which they vanish into one point, and display images.

In an embodiment, in operation 505, the instructions stored in the memory 130 may, when executed by the processor 120, cause the electronic device 101 to display other recently used screens excluding the first recently used screen (e.g., the first recently used screen 211 in FIG. 2A)) as images rendered in perspective.

In an embodiment, in operation 505, the instructions stored in the memory 130 may, when executed by the processor 120, cause the electronic device 101 to display other recently used screens which have not been selected as images rendered in perspective.

In an embodiment, in operation 507, the instructions stored in the memory 130 may, when executed by the processor 120, cause the electronic device 101 to determine whether there are applications to be recommended.

In an embodiment, in operation 507, when entering the multi-window preview mode, the instructions stored in the memory 130 may, when executed by the processor 120, cause the electronic device 101 to identify whether there are applications to be recommended.

For example, the first recently used screen (e.g., the first recently used screen 211 in FIG. 2A) receiving the user input 221 may include a first application execution or use screen. The first recently used screen (e.g., the first recently used screen 211 in FIG. 2A) may correspond to the first application execution or use screen.

In an embodiment, the instructions stored in the memory 130 may, when executed by the processor 120, cause the electronic device 101 to recommend an application, based on at least one of a multi-window usage history learned in relation to the first application, an association between the first application and the application to be recommended, categories of the first application and the application to be recommended, or the usage time of the application to be recommended.

In an embodiment, the instructions stored in the memory 130 may, when executed by the processor 120, cause the electronic device 101 to recommend an application that has been continuously used in an adjacent time or an adjacent location to the current time and/or current location information acquired by the electronic device 101, among applications that have not been recently used.

In an embodiment, when there are no applications to be recommended, the instructions stored in the memory 130 may, when executed by the processor 120, cause the electronic device 101 to branch from operation 507 to operation 509.

In an embodiment, when there are applications to be recommended, the instructions stored in the memory 130 may, when executed by the processor 120, cause the electronic device 101 to branch from operation 507 to operation 515.

In an embodiment, in operation 515, when there is a multi-window usage history learned in relation to the first application, the instructions stored in the memory 130 may, when executed by the processor 120, cause the electronic device 101 to display recently used screens for applications to be recommended on the display 160.

In an embodiment, in operation 515, when there is a multi-window usage history learned in relation to the first application, the instructions stored in the memory 130 may, when executed by the processor 120, cause the electronic device 101 to display recently used screens for applications to be recommended on the display 160.

In an embodiment, in operation 515, when there is an association between the first application and the application to be recommended, the instructions stored in the memory 130 may, when executed by the processor 120, cause the electronic device 101 to display recently used screens for applications to recommended on the display 160. The instructions stored in the memory 130 may, when executed by the processor 120, cause the electronic device 101 to analyze the association between applications, based on at least one of a usage pattern or a usage time of the application.

In an embodiment, in operation 515, when categories of the first application and the application to be recommended are the same, the instructions stored in the memory 130 may, when executed by the processor 120, cause the electronic device 101 to display the recently used screen for the application to be recommended on the display 160.

In an embodiment, in operation 515, the instructions stored in the memory 130 may, when executed by the processor 120, cause the electronic device 101 to recommend an application which has been continuously used in an adjacent time or an adjacent location to the current time and/or current location information acquired by the electronic device 101 among the applications that have not been recently used.

In an embodiment, in operation 515, when the usage time of the application to be recommended is equal to or longer than a specific time, the instructions stored in the memory 130 may, when executed by the processor 120, cause the electronic device 101 to display a recently used screen of the application to be recommend on the display 160.

In an embodiment, in operation 515, when there is an application to be recommended, the instructions stored in the memory 130 may, when executed by the processor 120, cause the electronic device 101 to display icons (e.g., the icons 420 of the applications to be recommended in FIG. 4) of the applications to be recommended.

In an embodiment, in operation 515, when there is an application to be recommended, the instructions stored in the memory 130 may, when executed by the processor 120, cause the electronic device 101 to display icons of the applications to be recommended (e.g., the icons 420 of the applications to be recommended in FIG. 4) and recently used screens (e.g., the recently used screens 421 in FIG. 4).

In an embodiment, in operation 515, when there is an application to be recommended, the instructions stored in the memory 130 may, when executed by the processor 120, cause the electronic device 101 to display usage screens (e.g., the usage screens 430 of the applications to be recommended in FIG. 4) of the applications to be recommended.

In an embodiment, in operation 515, when there is an application to be recommended, the instructions stored in the memory 130 may, when executed by the processor 120, cause the electronic device 101 to display usage screens of the applications (e.g., the usage screens 430 of the applications to be recommended in FIG. 4) and the recently used screens (e.g., the recently used screens 421 in FIG. 4).

In an embodiment, in operation 509, when there are no applications to be recommended, the instructions stored in the memory 130 may, when executed by the processor 120, cause the electronic device 101 to display the recent screen view displayed on the display 160.

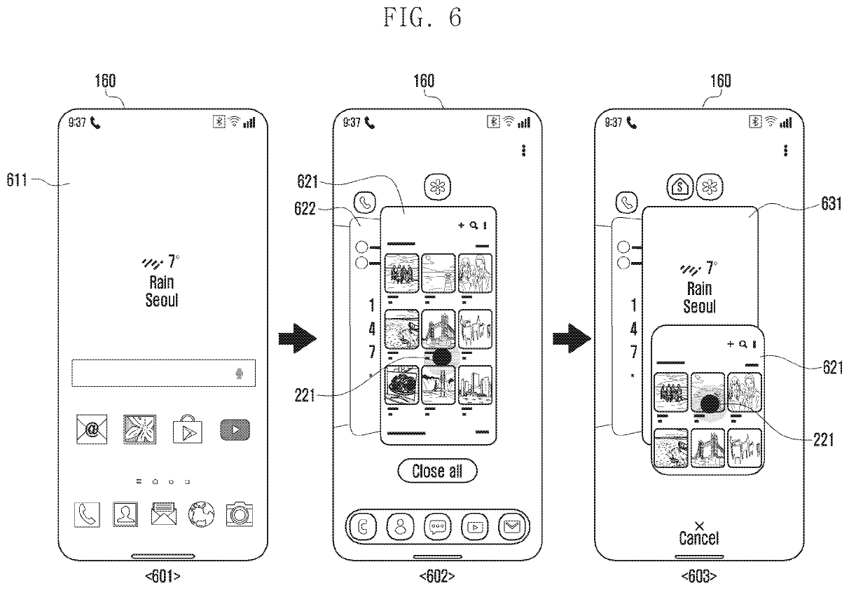

FIG. 6 is a diagram illustrating an example operation of terminating a multi-window preview mode of the electronic device 101 according to various example embodiments.

In the screen 601, the instructions stored in the memory 130 may, when executed by the processor 120, cause the electronic device 101 to display a home screen on the display 160. However, the disclosure is not limited, and the screen displayed on the display 160 in the screen 601 may include one of the screen corresponding to the application being executed, the home screen, or the lock screen.

In the screen 602, the instructions stored in the memory 130 may, when executed by the processor 120, cause the electronic device 101 to display the recent screen view on the display 160. The recent screen view may include recently used screens (e.g., a 6th recently used screen 621 and a 7th recently used screen 622).

In the screen 602, the instructions stored in the memory 130 may, when executed by the processor 120, cause the electronic device 101 to start an operation of executing a multi-window upon receiving the user input 221 for one of the recently used screens (e.g., the sixth recently used screen 621 and the seventh recently used screen 622).

When the recent screen view is executed in screen 602, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 603, when the operation of executing the multi-window is started, the instructions stored in the memory 130 may, when executed by the processor 120, cause the electronic device 101 to display a home card 631 corresponding to the home screen in the recent screen view. After the sixth recently used screen 621 moving according to the user input 221 has moved to the home card 631, when the user input 221 is released, the instructions stored in the memory 130 may, when executed by the processor 120, cause the electronic device 101 to terminate the operation of executing the multi-window.

In the screen 603, after the sixth recently used screen 621 moving according to the user input 221 has moved to the home card 631, when the user input 221 is released, the instructions stored in the memory 130 may, when executed by the processor 120, cause the electronic device 101 to terminate the operation of executing the multi-window.

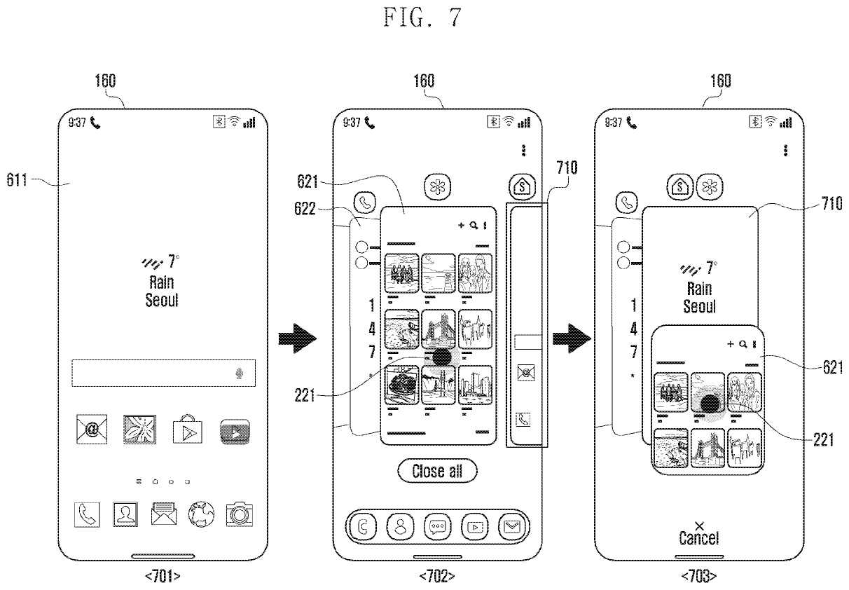

FIG. 7 is a diagram illustrating an example operation of terminating a multi-window preview mode of the electronic device 101 according to various example embodiments.

FIG. 6 and FIG. 7 may have the difference in the operation of displaying the home card (e.g., the home card 631 of FIG. 6 or a home card 710 of FIG. 7), and other parts may be the same.

In the screen 701, the instructions stored in the memory 130 may, when executed by the processor 120, cause the electronic device 101 to display a home screen on the display 160. However, the disclosure is not limited, and the screen displayed on the display 160 in the screen 701 may include one of the screen corresponding to the application being executed, the home screen, or the lock screen.

In the screen 702, the instructions stored in the memory 130 may, when executed by the processor 120, cause the electronic device 101 to display the recent screen view on the display 160 in screen 702. The recent screen view may include recently used screens (e.g., a 6th recently used screen 621 and a 7th recently used screen 622).

When the recent screen view is executed in screen 702, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 702, the instructions stored in the memory 130 may, when executed by the processor 120, cause the electronic device 101 to start an operation of executing a multi-window upon receiving the user input 221 for one of the recently used screens (e.g., the sixth recently used screen 621 and the seventh recently used screen 622).

In the screen 702, when the operation of executing the multi-window is started, the instructions stored in the memory 130 may, when executed by the processor 120, cause the electronic device 101 to display a home card 710 corresponding to the home screen in the recent screen view.

In an embodiment, the home card 631 of FIG. 6 may be displayed on the left part of the sixth recently used screen 621, but the home card 710 of FIG. 7 may be displayed on the right part of the sixth recently used screen 621.

In the screen 703, after the sixth recently used screen 621 moving according to the user input 221 has moved to the home card 710, when the user input 221 is released, the instructions stored in the memory 130 may, when executed by the processor 120, cause the electronic device 101 to terminate the operation of executing the multi-window.

In the screen 703, after the sixth recently used screen 621 moving according to the user input 221 has moved to the home card 710, when a predetermined time has passed, the instructions stored in the memory 130 may, when executed by the processor 120, cause the electronic device 101 to terminate the operation of executing the multi-window.

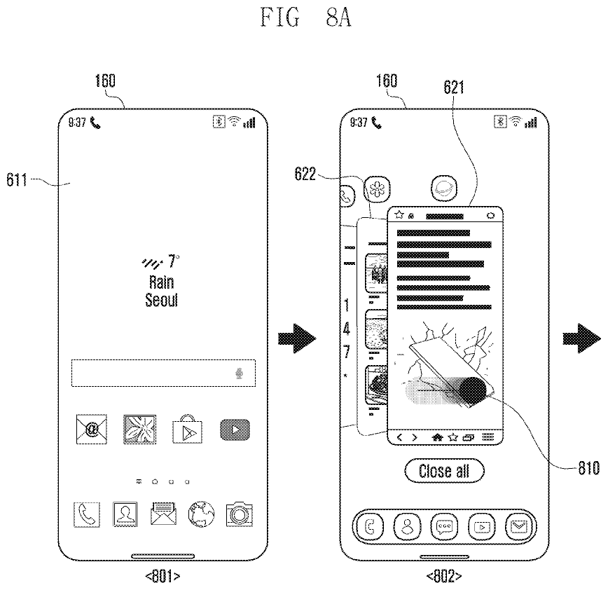

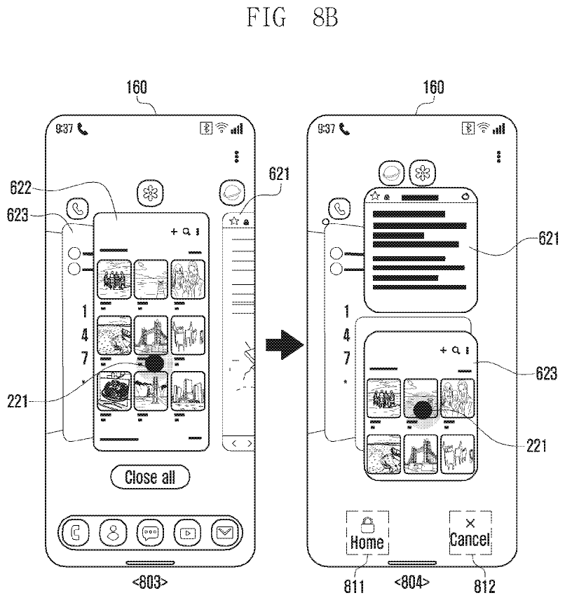

FIGS. 8A and 8B are diagrams illustrating an example operation of terminating a multi-window preview mode of the electronic device 101 according to various example embodiment.

In the screen 801, the instructions stored in the memory 130 may, when executed by the processor 120, cause the electronic device 101 to display a home screen on the display 160. However, the disclosure is not limited, and the screen displayed on the display 160 in the screen 801 may include one of the screen corresponding to the application being executed, the home screen, or the lock screen.

In the screen 802, the instructions stored in the memory 130 may, when executed by the processor 120, cause the electronic device 101 to display the recent screen view on the display 160 in screen 802. The recent screen view may include recently used screens (e.g., a 6th recently used screen 621 and a 7th recently used screen 622).

In the 802 screen, the instructions stored in the memory 130 may, when executed by the processor 120, cause the electronic device 101 to receive a fourth user input 810 in the recent screen view. The fourth user input 810 may include an input of swiping the display 160. The fourth user input 810 may include a gesture of swiping to the left or right.

When the recent screen view is executed in screen 802, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 803, when the fourth user input 810 to the recent screen view is received, the instructions stored in the memory 130 may, when executed by the processor 120, cause the electronic device 101 to move the displayed recently used screens (e.g., the sixth recently used screen 621 and the seventh recently used screen 622) in the direction of the fourth user input 810 and display the same, or to display an additional recently used screen (e.g., an eighth recently used screen 623).

In the screen 803, the instructions stored in the memory 130 may cause, executed by the processor 120, the electronic device 101 to start an operation of executing a multi-window when receiving the user input 221 for one of the recently used screens (e.g., the sixth recently used screen 621, the seventh recently used screen 622, and the eighth recently used screen 623).

In the 804 screen, the instructions stored in the memory 130 may, when executed by the processor 120, cause the electronic device 101 to display a layout on the display 160 as a preview image when the eighth recently used screen 623 moving according to the user input 221 moves to a specific location of the sixth recently used screen 621 and is shown as a multi-window.

In the 804 screen, the instructions stored in the memory 130 may, when executed by the processor 120, cause the electronic device 101 to display a layout on the display 160 as a preview image when the eighth recently used screen 623 moving according to the user input 221 moves to a specific location of the sixth recently used screen 621 and is shown as a multi-window while the user input 221 is maintained in the multi-window preview mode.

In the screen 804, while the preview image for a multi-window is displayed, the instructions stored in the memory 130 may, when executed by the processor 120, cause the electronic device 101 to display at least one of a home button 811 or a cancel button 812 on at least some of the display 160.

For example, when a user input is received on the home button 811, the instructions stored in the memory 130 may, when executed by the processor 120, cause the electronic device 101 to terminate the operation of executing the multi-window and display the home screen.

For example, when the eighth recently used screen 623 moving according to the user input 221 moves to the home button 811 and then the user input 221 is released, the instructions stored in the memory 130 may, when executed by the processor 120, cause the electronic device 101 to terminate the operation of executing the multi-window and display the home screen.

For example, when a predetermined time has passed after the eighth recently used screen 623 moving according to the user input 221 moves to the home button 811, the instructions stored in the memory 130 may, when executed by the processor 120, cause the electronic device 101 to terminate the operation of executing the multi-window and display the home screen.

For example, when a user input is received on the cancel button 812, the instructions stored in the memory 130 may, when executed by the processor 120, cause the electronic device 101 to terminate the operation of executing the multi-window.

For example, when the user input 221 is released after the eighth recently used screen 623 moving according to the user input 221 moves to the cancel button 812, the instructions stored in the memory 130 may, when executed by the processor 120, cause the electronic device 101 to terminate the operation of executing the multi-window.

For example, when a predetermined time has passed after the user input 221 is released after the eighth recently used screen 623 moving according to the user input 221 moves to the cancel button 812, the instructions stored in the memory 130 may, when executed by the processor 120, cause the electronic device 101 to terminate the operation of executing the multi-window.

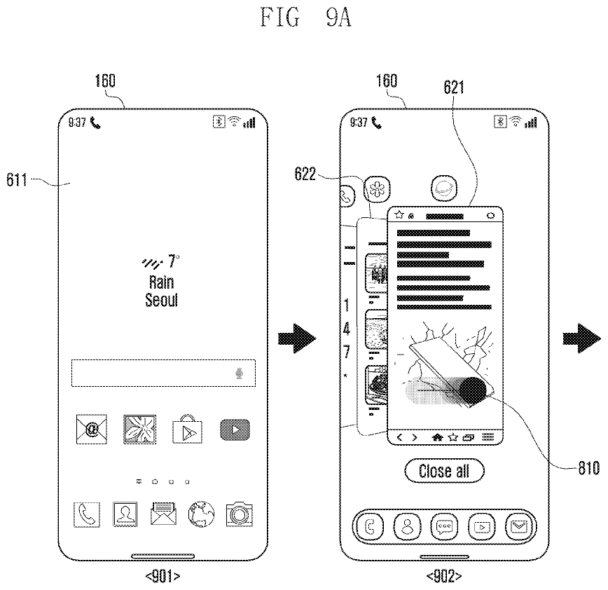

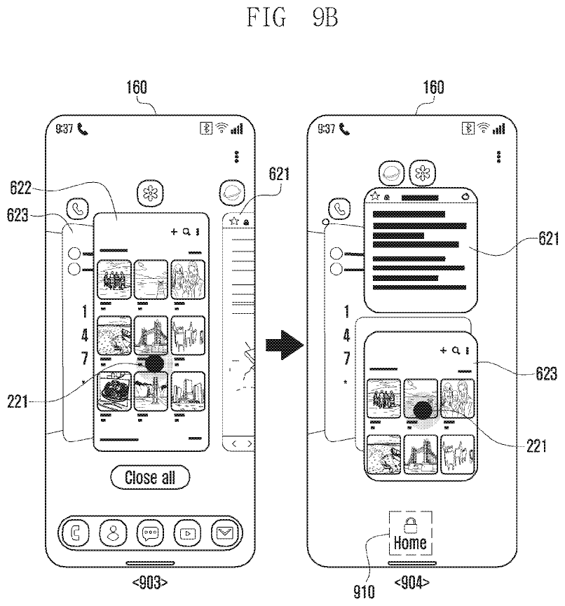

FIGS. 9A and 9B are diagrams illustrating an example operation of terminating a multi-window preview mode of the electronic device 101 according to various example embodiment.

FIG. 9 may not include a cancel button.

In the screen 901, the instructions stored in the memory 130 may, when executed by the processor 120, cause the electronic device 101 to display a home screen on the display 160. However, the disclosure is not limited, and the screen displayed on the display 160 in the screen 901 may include one of the screen corresponding to the application being executed, the home screen, or the lock screen.

The instructions stored in the memory 130 may, when executed by the processor 120, cause the electronic device 101 to display the recent screen view on the display 160 in screen 902. The recent screen view may include recently used screens (e.g., a 6th recently used screen 621 and a 7th recently used screen 622).

When the recent screen view is executed in screen 902, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the 902 screen, the instructions stored in the memory 130 may, when executed by the processor 120, cause the electronic device 101 to receive a fourth user input 810 in the recent screen view. The fourth user input 810 may include an input of swiping the display 160. The fourth user input 810 may include a gesture of swiping to the left or right.

In the screen 903, when the fourth user input 810 to the recent screen view is received, the instructions stored in the memory 130 may, when executed by the processor 120, cause the electronic device 101 to move the displayed recently used screens (e.g., the sixth recently used screen 621 and the seventh recently used screen 622) in the direction of the fourth user input 810 and display the same, or to display an additional recently used screen (e.g., an eighth recently used screen 623).

In the screen 903, the instructions stored in the memory 130 may cause, executed by the processor 120, the electronic device 101 to start an operation of executing a multi-window when receiving the user input 221 for one of the recently used screens (e.g., the sixth recently used screen 621, the seventh recently used screen 622, and the eighth recently used screen 623).

In the 904 screen, the instructions stored in the memory 130 may, when executed by the processor 120, cause the electronic device 101 to display a layout on the display 160 as a preview image when the eighth recently used screen 623 moving according to the user input 221 moves to a specific position of the sixth recently used screen 621 and shown as a multi-window.

In the 904 screen, the instructions stored in the memory 130 may, when executed by the processor 120, cause the electronic device 101 to display a layout on the display 160 as a preview image when the eighth recently used screen 623 moving according to the user input 221 moves to a specific location of the sixth recently used screen 621 and is shown as a multi-window while the user input 221 is maintained in the multi-window preview mode.

In the screen 904, while a preview image for the multi-window is displayed, the instructions stored in the memory 130 may, when executed by the processor 120, cause the electronic device 101 to display a home button 910 on at least a portion of the display 160.

For example, when a user input is received on the home button 910, the instructions stored in the memory 130 may, when executed by the processor 120, cause the electronic device 101 to terminate the operation of executing the multi-window and display the home screen.

For example, when the eighth recently used screen 623 moving according to the user input 221 moves to the home button 910 and then the user input 221 is released, the instructions stored in the memory 130 may, when executed by the processor 120, cause the electronic device 101 to terminate the operation of executing the multi-window and display the home screen.

For example, when a predetermined time has passed after the eighth recently used screen 623 moving according to the user input 221 moves to the home button 910, the instructions stored in the memory 130 may, when executed by the processor 120, cause the electronic device 101 to terminate the operation of executing the multi-window and display the home screen.

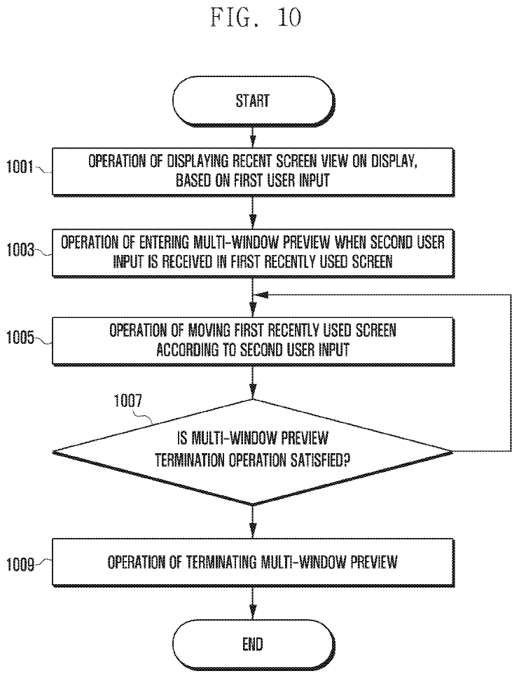

FIG. 10 is a flowchart illustrating an example operation of terminating a multi-window preview mode of the electronic device 101 according to various example embodiments.

In an embodiment, in operation 1001, the instructions stored in the memory 130 may, when executed by the processor 120, cause the electronic device 101 to display a recent screen view on the display 160, based on a first user input. The first user input may include the first user input mentioned in FIG. 3. However, the disclosure is not limited thereto, and operation 1001 may be omitted.

In an embodiment, in operation 1001, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 1003, the instructions stored in the memory 130 may, when executed by the processor 120, cause the electronic device 101 to receive a second user input to the first recently used screen (e.g., the first recently used screen 211 of FIG. 2A) while displaying the recent screen view. The first recently used screen may be included in the recent screen view.

In an embodiment, the second user input may include, for example, the user input 221 mentioned in FIGS. 2A, 2B, 2C, 3, and 4.

In an embodiment, in operation 1003, when the second user input to the first recently used screen (e.g., the first recent use screen 211 in FIG. 2A) is received, the instructions stored in the memory 130 may, when executed by the processor 120, cause the electronic device 101 to perform a multi-window operation.

In an embodiment, in operation 1003, when receiving the second user input to the first recently used screen (e.g., the first recent use screen 211 in FIG. 2A), the instructions stored in the memory 130 may, when executed by the processor 120, cause the electronic device 101 to enter a multi-window preview mode.

In an embodiment, in operation 1003, when receiving the second user input to the first recently used screen (e.g., the first recently used screen 211 in FIG. 2A), the instructions stored in the memory 130 may, when executed by the processor 120, cause the electronic device 101 to determine that the first recently used screen (e.g., the first recently used screen 211 in FIG. 2A) has been selected.

In an embodiment, in operation 1005, the instructions stored in the memory 130 may, when executed by the processor 120, cause the electronic device 101 to move the first recently used screen (e.g., first recently used screen 211 in FIG. 2A) on the display 160 according to the second user input.

In an embodiment, in operation 1007, the instructions stored in the memory 130 may, when executed by the processor 120, cause the electronic device 101 to determine whether to a condition of terminating a preview image for a multi-window is satisfied.

In an embodiment, in operation 1007, the instructions stored in the memory 130 may, when executed by the processor 120, cause the electronic device 101 to determine whether a condition of terminating execution of the multi-window is satisfied.

For example, when the second user input is released after the first recently used screen (e.g., the first recently used screen 211 in FIG. 2A) moves to a home card (e.g., the home card 631 in FIG. 6 or the home card 710 in FIG. 7) according to the second user input, the instructions stored in the memory 130 may, when executed by the processor 120, cause the electronic device 101 to terminate an operation of executing a multi-window.

For example, when a predetermined time has passed after the first recently used screen (e.g., the first recently used screen 211 in FIG. 2A) moves to the home card (e.g., the home card 631 in FIG. 6 or the home card 710 in FIG. 7) according to the second user input, the instructions stored in the memory 130 may, when executed by the processor 120, cause the electronic device 101 to terminate an operation of executing a multi-window.

For example, when a user input is received on the home button (e.g., the home button 811 of FIG. 8), the instructions stored in the memory 130 may, when executed by the processor 120, cause the electronic device 101 to terminate the operation of executing the multi-window and display the home screen.

For example, when the user input 211 is released after the first recently used screen (e.g., the first recently used screen 211 in FIG. 2A) moves to the home button (e.g., the home button 811 in FIG. 8) according to the second user input, the instructions stored in the memory 130 may, when executed by the processor 120, cause the electronic device 101 to terminate the operation of executing the multi-window and display the home screen.

For example, when a predetermined time has passed after the first recently used screen (e.g., the first recently used screen 211 in FIG. 2A) moves to the home button (e.g., the home button 811 in FIG. 8) according to the second user input, the instructions stored in the memory 130 may, when executed by the processor 120, cause the electronic device 101 to terminate the operation of executing the multi-window and display the home screen.

For example, when a user input is received on the cancel button (e.g., the cancel button 812 in FIG. 8), the instructions stored in the memory 130 may, when executed by the processor 120, cause the electronic device 101 to terminate the operation of executing the multi-window.

For example, when the user input 221 is released after the first recently used screen (e.g., the first recently used screen 211 in FIG. 2A) moves to the cancel button (e.g., the cancel button 812 in FIG. 8) according to the second user input, the instructions stored in the memory 130 may, when executed by the processor 120, cause the electronic device 101 to terminate the operation of executing the multi-window.

For example, when a predetermined time has passed after the first recently used screen (e.g., the first recently used screen 211 in FIG. 2A) moves to the cancel button (e.g., the cancel button 812 in FIG. 8) according to the second user input, the instructions stored in the memory 130 may, when executed by the processor 120, cause the electronic device 101 to terminate the operation of executing the multi-window.

For example, when a user input is received on the home button (e.g., the home button 811 of FIG. 8), the instructions stored in the memory 130 may, when executed by the processor 120, cause the electronic device 101 to terminate the operation of executing the multi-window and display the home screen.

For example, when the second user input is released after the first recently used screen (e.g., the first recently used screen 211 in FIG. 2A) moves to the home button (e.g., the home button 811 in FIG. 8) according to the second user input, the instructions stored in the memory 130 may, when executed by the processor 120, cause the electronic device 101 to terminate the operation of executing the multi-window and display the home screen.

For example, when a predetermined time has passed after the first recently used screen (e.g., the first recently used screen 211 in FIG. 2A) moves to the home button (e.g., the home button 811 in FIG. 8) according to the second user input, the instructions stored in the memory 130 may, when executed by the processor 120, cause the electronic device 101 to terminate the operation of executing the multi-window and display the home screen.

In an embodiment, when a condition of terminating the preview image for the multi-window is satisfied, the instructions stored in the memory 130 may, when executed by the processor 120, cause the electronic device 101 to branch from operation 1007 to operation 1009.

In an embodiment, when a condition of terminating the preview image for the multi-window is not satisfied, the instructions stored in the memory 130 may, when executed by the processor 120, cause the electronic device 101 to branch from operation 1007 to operation 1005.

In an embodiment, in operation 1009, the instructions stored in the memory 130 may, when executed by the processor 120, cause the electronic device 101 to terminate the operation of displaying the preview image for the multi-window.

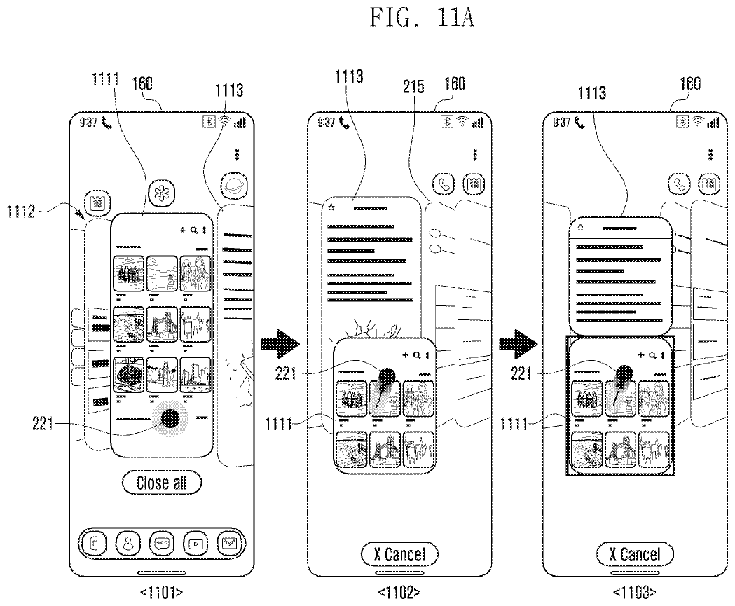

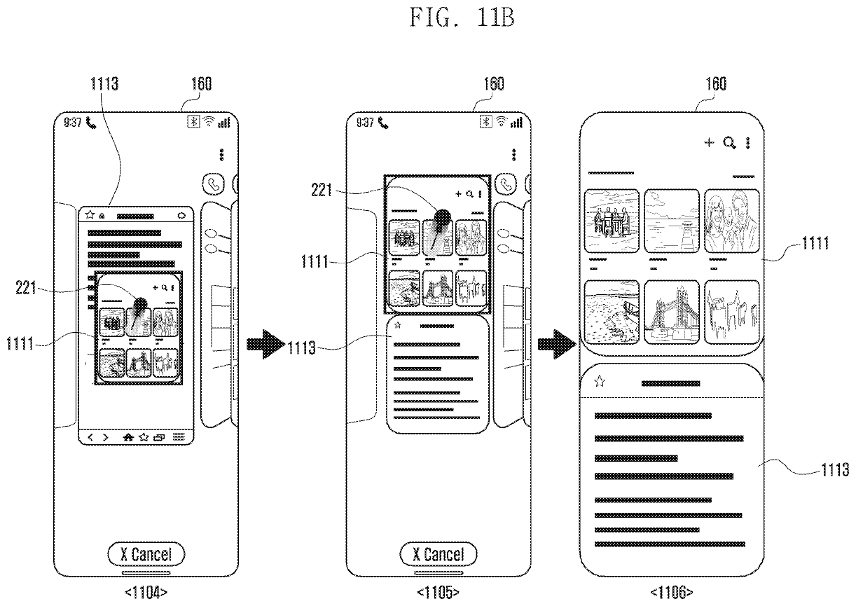

FIGS. 11A and 11B are diagrams illustrating an example screen display method of the electronic device 101 according to various example embodiments.

In the screen 1101, when the recent screen view is executed, the instructions stored in the memory 130 may, when executed by the processor 120, cause the electronic device 101 to display the recently used screens 1111, 1112, and 1113 of the previously or currently executed applications three-dimensionally on the display 160. The recently used screens 1111, 1112, and 1113 may include a ninth recently used screen 1111, a tenth recently used screen 1112, or an eleventh recently used screen 1113.

In the screen 1101, in a recent screen viewing screen, each of the recently used screens 1111, 1112, and 1113 of previously or currently executed applications may include an image rendered in perspective.

When the recent screen view is executed in screen 1101, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the 1101 screen, the instructions stored in the memory 130 may, when executed by the processor 120, cause the electronic device 101 to start an operation of executing the multi-window when a user input 221 for the ninth recently used screen 1111 is received.

In the screen 1101, when the recent screen view is executed, the instructions stored in the memory 130 may, when executed by the processor 120, cause the electronic device 101 to start an operation of executing the multi-window when the user input 221 for the ninth recently used screen 1111 is received.

In the screen 1102, when the multi-window is executed, the instructions stored in the memory 130 may, when executed by the processor 120, cause the electronic device 101 to resize and display the size of the ninth recently used screen 1111. The size of the ninth recently used screen 1111 may be resized to a size corresponding to at least one window of the multi-window. Resizing of the ninth recently used screen 1111 may include reducing the length of the long axis among the long and short axes.

In the screen 1102, when the operation of executing the multi-window is triggered, the instructions stored in the memory 130 may, when executed by the processor 120, cause the electronic device 101 to display the ninth recently used screen (e.g., the ninth recently used screen 1111) selected according to a user input (e.g., the user input 221) as a preview on the display 160.

In the screen 1102, the instructions stored in the memory 130 may, when executed by the processor 120, cause the electronic device 101 to arrange and display other recently used screens (e.g., the tenth recently used screen 1112 or the eleventh recently used screen 1113) excluding the selected ninth recently used screen 1111 on the display 160.

In the screen 1102, the instructions stored in the memory 130 may, when executed by the processor 120, cause the electronic device 101 to display other recently used screens (e.g., the tenth recently used screen 1112 or the eleventh recently used screen 1113) excluding the selected ninth recently used screen 1111 on the display 160 as images rendered in perspective.

In the screen 1102, the instructions stored in the memory 130 may, when executed by the processor 120, cause the electronic device 101 to arrange other recently used screens 214 and 215 excluding the selected recently used screen (for example, the first recent use screen 211)) as images rendered in a perspective view and display the same on the display 160.

In the screen 1102, the instructions stored in the memory 130 may, when executed by the processor 120, cause the electronic device 101 to display movement of the ninth recently used screen 1111 selected based on the user input 221 on the display 160.

In the screen 1102, the ninth recently used screen 1111 may be displayed while being overlaid on another recently used screen (e.g., the eleventh recently used screen 1113).

In the 1103 screen, when the ninth recently used screen 1111 moving according to the user input 221 reaches a first specific location of a target recently used screen (e.g., eleventh recently used screen 1113), the instructions stored in the memory 130 may, when executed by the processor 120, cause the electronic device 101 to display a multi-window including the ninth recently used screen 1111 and the target recently used screen (e.g., eleventh recently used screen 1113) as a preview image.

For example, the first specific location may include a location between the lower part of the target recently used screen (for example, the eleventh recently used screen 1113) and 30% from the lower part.

In the screen 1103, when the ninth recently used screen 1111 reaches the first specific location of the target recently used screen (e.g., eleventh recently used screen 1113), the instructions stored in the memory 130 may, when executed by the processor 120, cause the electronic device 101 to display, as a preview image, a multi-window including the ninth recently used screen 1111 at the lower part of the multi-window and including the target recently used screen (e.g., eleventh recently used screen 1113) at the upper part of the multi-window.

In the 1104 screen, when the ninth recently used screen 1111 moving according to the user input 221 reaches a second specific location of the target recently used screen (e.g., eleventh recently used screen 1113), the instructions stored in the memory 130 may, when executed by the processor 120, cause the electronic device 101 to display a multi-window including the ninth recently used screen 1111 and the target recently used screen (e.g., eleventh recently used screen 1113) as a preview image.

For example, the second specific location may include a location between about 30% from the lower part and about 30% from the upper part of the target recently used screen (e.g., the eleventh recently used screen 1113).

In the screen 1104, when the ninth recently used screen 1111 reaches the second specific location of the target recently used screen (e.g., the 11th recently used screen 1113), the instructions stored in the memory 130 may, when executed by the processor 120, cause the electronic device 101 to overlay the ninth recently used screen 1111, displayed as a pop-up window, on the target recently used screen (e.g., the eleventh recently used screen 1113) to display a multi-window as a preview image.

In the 1105 screen, when the ninth recently used screen 1111 moving according to the user input 221 reaches a third specific location of the target recently used screen (e.g., eleventh recently used screen 1113), the instructions stored in the memory 130 may, when executed by the processor 120, cause the electronic device 101 to display a multi-window including the ninth recently used screen 1111 and the target recently used screen (e.g., eleventh recently used screen 1113) as a preview image.

For example, the third specific location may include a location between the upper part of the target recently used screen (e.g., eleventh recently used screen 1113) and about 30% from the upper part.

In the 1105 screen, when the ninth recently used screen 1111 reaches the third specific location of the target recently used screen (e.g., the eleventh recently used screen 1113), the instructions stored in the memory 130 may, when executed by the processor 120, cause the electronic device 101 to display a multi-window including the ninth recently used screen 1111 in the upper part of the multi-window and including the target recently used screen (e.g., the eleventh recently used screen 1113) in the lower part of the multi-window as a preview image.

In the screen 1106, when the user input 221 is released, the instructions stored in the memory 130 may, when executed by the processor 120, cause the electronic device 101 to display the preview image on the display 160 as a multi-window.

In the screen 1106, the ninth recently used screen 1111 moving according to the user input 221 remains at a specific location of the target recently used screen (e.g., the eleventh recently used screen 1113) for a predetermined time, the instructions stored in the memory 130 may, when executed by the processor 120, cause the electronic device 101 to display a preview image on the display 160 as a multi-window.

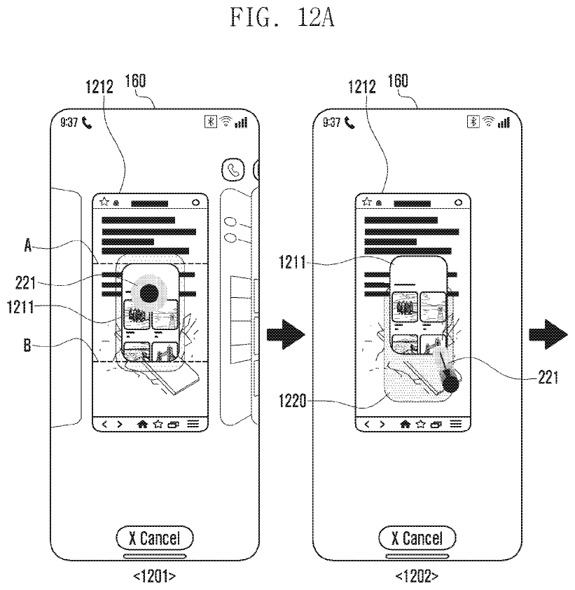

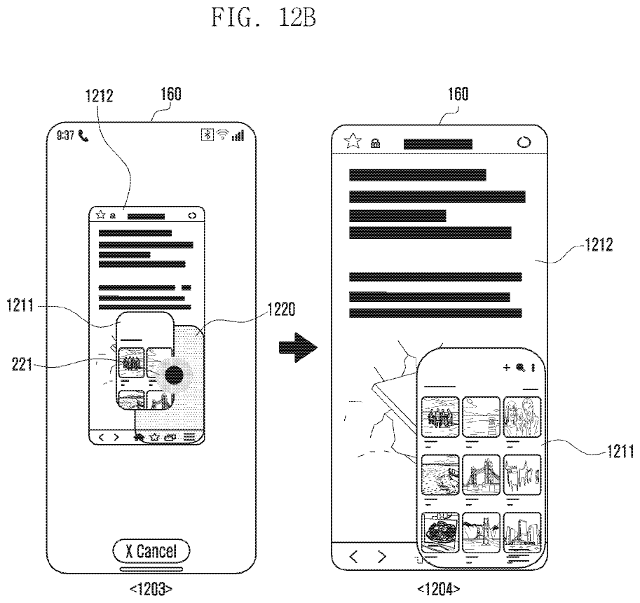

FIGS. 12A and 12B are diagrams illustrating an example screen display method of the electronic device 101 according to various example embodiments.

In the 1201 screen, when a twelfth recently used screen 1211 moving according to the user input 221 reaches a second specific location of a target recently used screen (e.g., thirteenth recently used screen 1212), the instructions stored in the memory 130 may, when executed by the processor 120, cause the electronic device 101 to display a multi-window including the twelfth recently used screen 1211 and the target recently used screen (e.g., thirteenth recently used screen 1212) as a preview image.

For example, the second specific location may include a location between about 30% (B) from the lower part and about 30% (A) from the upper part of the target recently used screen (e.g., the eleventh recently used screen 1113).

In the screen 1201, when the twelfth recently used screen 1211 reaches the second specific location of the target recently used screen (e.g., the thirteenth recently used screen 1212), the instructions stored in the memory 130 may, when executed by the processor 120, cause the electronic device 101 to overlay the ninth recently used screen 1111, displayed as a pop-up window, on the target recently used screen (e.g., the eleventh recently used screen 1113) to display a multi-window as a preview image.

In the 1202 screen, when the twelfth recently used screen 1211 reaches the second specific location of the target recently used screen (e.g., the thirteenth recently used screen 1212), the instructions stored in the memory 130 may, when executed by the processor 120, cause the electronic device 101 to display a guide interface 1220 indicating a location on the target recently used screen (e.g., thirteenth recently used screen 1212) where the pop-up window is to be displayed.

For example, the location of the pop-up window to be displayed on the target recently used screen (for example, thirteen recently used screen 1212) may include one of the nine-divided locations of the target recently used screen.

In the 1203 screen, the instructions stored in the memory 130 may, when executed by the processor 120, cause the electronic device 101 to move the twelfth recently used screen 1211 to one of the nine-divided locations according to the user input 221.

In the screen 1204, when the user input 221 is released, the instructions stored in the memory 130 may, when executed by the processor 120, cause the electronic device 101 to overlay the twelfth recently used screen 1211, moved to one of the nine-divided locations of the target recently used screen, on the target recently used screen (e.g., thirteenth recently used screen 1212) and display the same as a pop-up window.

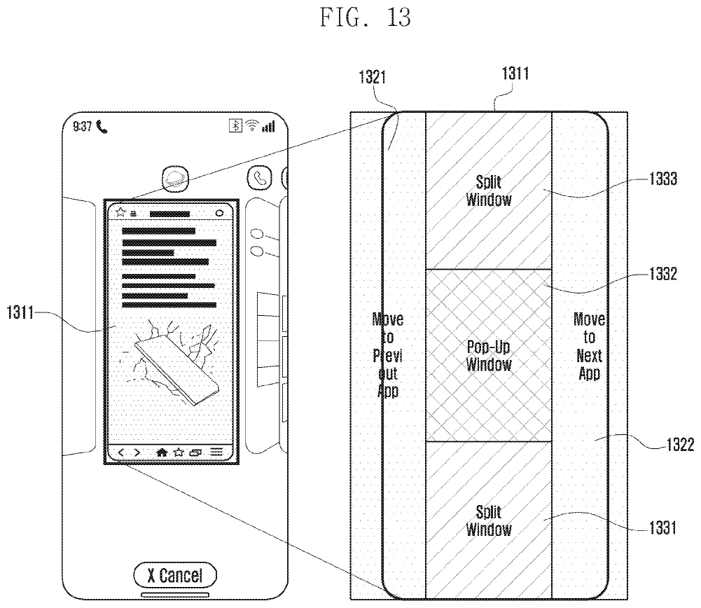

FIG. 13 is a diagram illustrating an example screen display method of the electronic device 101 according to various example embodiments.

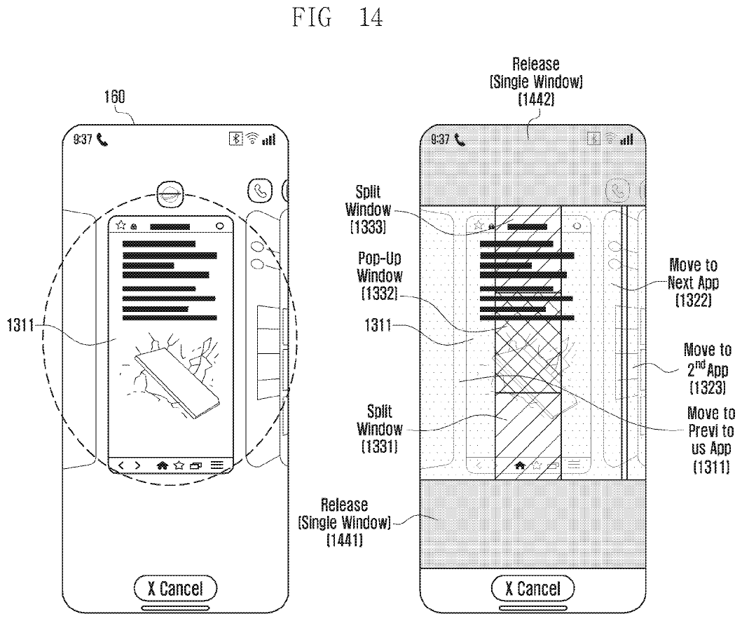

FIG. 14 is a diagram illustrating an example screen display method of the electronic device 101 according to various example embodiments.

Referring to FIG. 13, under control of the processor 120, the electronic device 101 may display a target recently used screen 1311 to be displayed as a multi-window. The target recently used screen 1311 may be paired with the selected recently used screen moving according to a user input to configure a multi-window.

Referring to FIG. 13, under control of the processor 120, the electronic device 101 may determine a layout of the multi-window according to the selected recently used screen disposed at a specific location of the target recently used screen 1311.

Referring to FIG. 13, under control of the processor 120, the electronic device 101 may release a pairing according to the selected recently used screen disposed at the specific location of the target recently used screen 1311.

Referring to FIG. 13, when the selected recently used screen moving according to the user input reaches a specific location (e.g., a location 1331 between the lower part of the target recently used screen and about 30% from the lower part) of the target recently used screen 1311, the electronic device 101 may display a multi-window preview image on the display 160 in which the target recently used screen 1311 is placed at the upper part and the selected recently used screen is placed at the lower part according to the control of the processor 120.

Referring to FIG. 13, when the selected recently used screen moving according to the user input reaches a specific location (e.g., a location 1333 between the upper part and about 30% from the upper part) of the target recently used screen 1311, the electronic device 101 may display a multi-window preview image on the display 160, in which the target recently used screen 1311 is placed at the lower part and the selected recently used screen is placed at the upper part according to the control of the processor 120.

Referring to FIG. 13, when the selected recently used screen moving according to the user input reaches a specific location (e.g., a location 1332 between about 30% above and below the center of the target recently used screen) of the target recently used screen 1311, the electronic device 101 may display a multi-window preview image on the display 160 in which the target recently used screen 1311 is placed in the entire screen and the selected recently used screen is placed as a popup window according to the control of the processor 120.

Referring to FIG. 13, when the selected recently used screen moving according to the user input reaches a specific location (e.g., a location 1321 between the left corner of the target recently used screen and about 30% from the left corner) of the target recently used screen 1311, the electronic device 101 may release the pairing between the target recently used screen 1311 and the selected recently used screen and pair the selected recently used screen with another recently used screen (e.g., a previous recently used screen) according to the control of the processor 120.

Referring to FIG. 13, when the selected recently used screen moving according to the user input reaches a specific location (e.g., a location 1322 between the right corner of the target recently used screen and about 30% from the right corner) of the target recently used screen 1311, the electronic device 101 may release the pairing between the target recently used screen 1311 and the selected recently used screen and pair the selected recently used screen with another recently used screen (e.g., the next recently used screen) according to the control of the processor 120.

Referring to FIG. 14, when the selected recently used screen moving according to the user input reaches a specific location (e.g., a location 1441 between the lower part of the display 160 and the recent screen view) of the display 160, the electronic device 101 may release execution of the multi-window, expand the size of the selected recently used screen, and display the same on the display 160 according to the control of the processor 120.

Referring to FIG. 14, when the selected recently used screen moving according to the user input reaches a specific location (e.g., a location 1442 between the upper part of the display 160 and the recent screen view) of the display 160, the electronic device 101 may, according to the control of the processor 120, release execution of the multi-window, expand the size of the selected recently used screen, and display the same on the display 160.

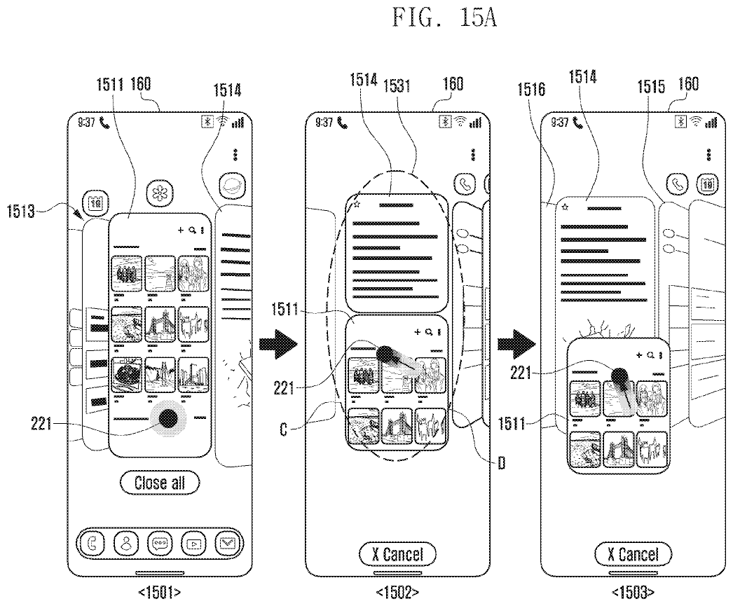

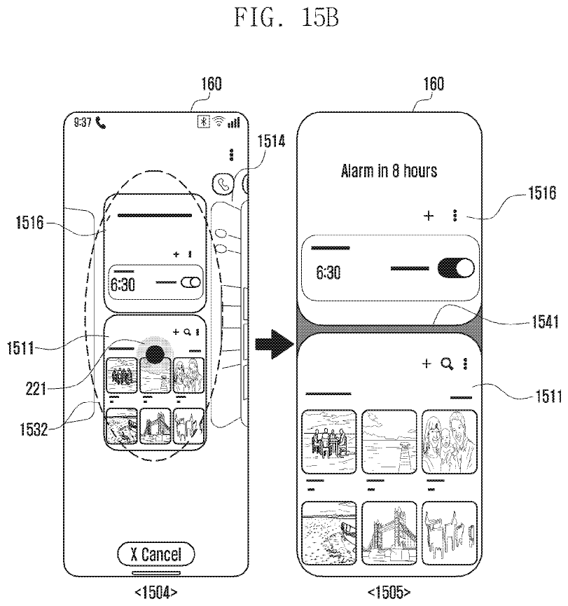

FIGS. 15A and 15B are diagrams illustrating an example screen display method of the electronic device 101 according to various example embodiments.

In the screen 1501, the instructions stored in the memory 130 may, when executed by the processor 120, cause the electronic device 101 to display the recent screen view on the display 160, based on the user input.

In the screen 1501, when the recent screen view is executed, the instructions stored in the memory 130 may, when executed by the processor 120, cause the electronic device 101 to display recently used screens 1511, 1513, and 1514 of previously or currently executed applications on the display 160. The recently used screens 1511, 1513, and 1514 may include a fourteenth recently used screen 1511, a fifteenth recently used screen 1513, or a sixteenth recently used screen 1514. In the recent screen view screen, each of the recently used screens 1511, 1513, and 1514 of the previously or currently executed applications may include a thumbnail image. In the recent screen view screen, the instructions stored in the memory 130 may, when executed by the processor 120, cause the electronic device 101 to display the recently used screens 1511, 1513, and 1514 of previously or currently executed applications three-dimensionally on the display 160. In the recent screen view, each of the recently used screens 1511, 1513, and 1514 of the previously or currently executed applications may include an image rendered in perspective.

When the recent screen view is executed in screen 1501, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 1501, the instructions stored in the memory 130 may, when executed by the processor 120, cause the electronic device 101 to start an operation of executing a multi-window when the user input 221 for the fourteenth recently used screen 1511 is received.

In the screen 1501, the instructions stored in the memory 130 may, when executed by the processor 120, cause the electronic device 101 to trigger the operation of executing the multi-window when the user input 221 for the 14th recently used screen 1511 is received.

In the screen 1501, the user input 221 may include a long-press input for one (e.g., the fourteenth recently used screen 1511) of the recently used screens 1511, 1513, and 1514. However, the disclosure is not limited thereto, and the user input 221 may be a touch input for one (e.g., the fourteenth recently used screen 1511) of the recently used screens 1511, 1513, and 1514.

In the screen 1502, when the selected recently used screen (e.g., the fourteenth recently used screen 1511) moving according to the user input 221 moves to the target recently used screen (e.g., the sixteenth recently used screen 1514), the instructions stored in the memory 130 may, when executed by the processor 120, cause the electronic device 101 to display the target recently used screen (e.g., the sixteenth recently used screen 1514) as a plane (or front) image on the display 160.

In the screen 1502, when the selected recently used screen (e.g., the fourteenth recently used screen 1511) moving according to the user input 221 reaches a specific location (e.g., the first specific location of FIG. 11) of the target recently used screen (e.g., the sixteenth recently used screen 1514), the instructions stored in the memory 130 may, when executed by the processor 120, cause the electronic device 101 to display a preview image 1531 on the display 160. The preview image 1531 may include the target recently used screen (e.g., the sixteenth recently used screen 1514) and the selected recently used screen (e.g., the eleventh recently used screen 1511). The preview image 1531 may include a layout when the preview image is shown as a multi-window. The preview image 1531 may include a layout in which the selected recently used screen (e.g., fourteenth recently used screen 1511) is disposed at the lower part and the target recently used screen (e.g., sixteenth recently used screen 1514) is disposed at the upper part.

In the screen 1502 and the screen 1503, when the selected recently used screen (e.g., the fourteenth recently used screen 1511) moving according to the user input 221 moves beyond critical areas (C and D) of the target recently used screen (e.g., the sixteenth recently used screen 1514), the instructions stored in the memory 130 may, when executed by the processor 120, cause the electronic device 101 to remove the display of the preview image 1531. When the recently used screen (e.g., the fourteenth recently used screen 1511) moves in the recent screen view, the instructions stored in the memory 130 may, when executed by the processor 120, cause the electronic device 101 to display a seventeenth recently screen 1515 and an eighteenth recently used screen 1516 on the display 160.

In the screen 1504, when the selected recently used screen (e.g., the fourteenth recently used screen 1511) moving according to the user input 221 moves to the target recently used screen (e.g., the eighteenth recently used screen 1516), the instructions stored in the memory 130 may, when executed by the processor 120, cause the electronic device 101 to display the target recently used screen (e.g., the eighteenth recently used screen 1516) as a plane (or front) image on the display 160.

In the screen 1504, when the selected recently used screen (e.g., the fourteenth recently used screen 1511) moving according to the user input 221 reaches a specific location (e.g., the first specific location of FIG. 11) of the target recently used screen (e.g., the eighteenth recently used screen 1516), the instructions stored in the memory 130 may, when executed by the processor 120, cause the electronic device 101 to display the preview image 1532 on the display 160.

In an embodiment, the preview image 1532 may include the target recently used screen (e.g., the eighteenth recently used screen 1516) and the selected recently used screen (e.g., the fourteenth recently used screen 1511). The preview image 1532 may include a layout when the preview image is shown as a multi-window. The preview image 1532 may include a layout in which the selected recently used screen (e.g., fourteenth recently used screen 1511) is disposed at the lower part and the target recently used screen (e.g., eighteenth recently used screen 1516) is disposed at the upper part.

In the screen 1505, when the user input 221 is released, the instructions stored in the memory 130 may, when executed by the processor 120, cause the electronic device 101 to display the target recently used screen (e.g., the eighteenth recently used screen 1516) and the selected recently used screen (e.g., the fourteenth recently used screen 1511) as a multi-window on the display 160. The instructions stored in the memory 130 may, when executed by the processor 120, cause the electronic device 101 to display an additional bar 1541 on the display 160 between the target recently used screen (e.g., the eighteenth recently used screen 1516) and the selected recently used screen (e.g., the fourteenth recently used screen 1511). The instructions stored in the memory 130 may, when executed by the processor 120, cause the electronic device 101 to move the bar according to the user input and display the same on the display 160. According to the movement of the bar, the screen ratio of the target recently used screen (e.g., the eighteenth recently used screen 1516) and the selected recently used screen (e.g., the fourteenth recently used screen 1511) may be different.

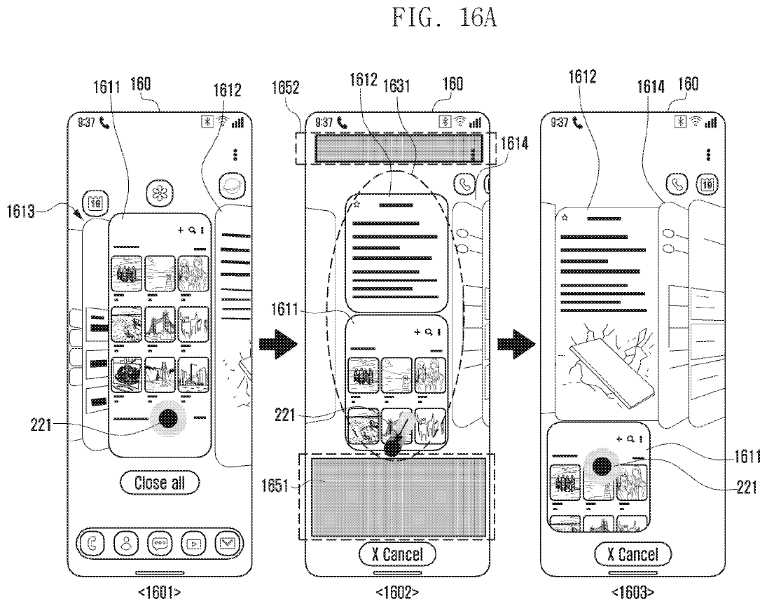

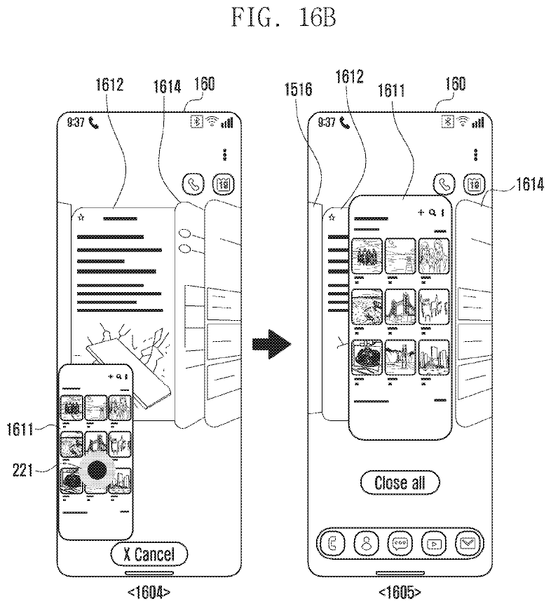

FIGS. 16A and 16B are diagrams illustrating an example screen display method of the electronic device 101 according to various example embodiments.

In the screen 1601, the electronic device 101 may display a recent screen view on the display 160, based on a user input, according to the control of the processor 120.

In the screen 1601, when the recent screen view is executed, the instructions stored in the memory 130 may, when executed by the processor 120, cause the electronic device 101 to display recently used screens 1611, 1612, and 1613 of previously or currently executed applications on the display 160. The recently used screens 1611, 1612, and 1613 may include a nineteenth recently used screen 1611, a twentieth recently used screen 1612, or twenty first recently used screen 1613.

When the recent screen view is executed in screen 1601, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 1601, the instructions stored in the memory 130 may, when executed by the processor 120, cause the electronic device 101 to start an operation of executing a multi-window when the user input 221 for the nineteenth recently used screen 1611 is received.

In the screen 1601, the instructions stored in the memory 130 may, when executed by the processor 120, cause the electronic device 101 to trigger the operation of executing the multi-window when the user input 221 for the nineteenth recently used screen 1611 is received.

In the screen 1601, the user input 221 may include a long-press input for one (e.g., the nineteenth recently used screen 1611) of the recently used screens 1611, 1612, and 1613. However, the disclosure is not limited thereto, and the user input 221 may be a touch input for one (e.g., the nineteenth recently used screen 1611) of the recently used screens 1611, 1612, and 1613.

In the screen 1602, when the selected recently used screen (e.g., the nineteenth recently used screen 1611) moving according to the user input 221 moves to the target recently used screen (e.g., the twentieth recently used screen 1612), the instructions stored in the memory 130 may, when executed by the processor 120, cause the electronic device 101 to display the target recently used screen (e.g., the twentieth recently used screen 1612) as a plane (or front) image on the display 160.

In the screen 1602, when the selected recently used screen (e.g., the nineteenth recently used screen 1611) moving according to the user input 221 reaches a specific location (e.g., the first specific location of FIG. 11) of the target recently used screen (e.g., the twentieth recently used screen 1612), the instructions stored in the memory 130 may, when executed by the processor 120, cause the electronic device 101 to display the preview image 1631 on the display 160. The preview image 1631 may include the target recently used screen (e.g., the twentieth recently used screen 1612) and the selected recently used screen (e.g., the nineteenth recently used screen 1611). The preview image 1631 may include a layout when the preview image is shown as a multi-window. The preview image 1631 may include a layout in which the selected recently used screen (e.g., nineteenth recently used screen 1611) is disposed at the lower part and the target recently used screen (e.g., twentieth recently used screen 1612) is disposed at the upper part.

In the screen 1603, when the user input 221 is released after the selected recently used screen (e.g., nineteenth recently used screen 1611) moving according to the user input 221 moves to a first release area 1651 or a second release area 1652, the instructions stored in the memory 130 may, when executed by the processor 120, cause the electronic device 101 to display the selected recently used screen (e.g., nineteenth recently used screen 1611) at a location where the user input 221 is released.

In the screen 1603, when the user input 1621 is released after the selected recently used screen (e.g., the nineteenth recently used screen 1611) moving according to the user input 1621 moves to the first release area 1651 or the second release area 1652, the instructions stored in the memory 130 may, when executed by the processor 120, cause the electronic device 101 to execute a single window. The first release area 1651 or the second release area 1652 may include an area located below or above the recent screen view on the display 160. The instructions stored in the memory 130 may, when executed by the processor 120, cause the electronic device to trigger the single window when a touch input is released after reaching the first release area 1651 or the second release area 1652.

In the screen 1603, when the user input 221 is released after the selected recently used screen (e.g., the nineteenth recently used screen 1611) moving according to the user input 221 reaches the first release area 1651 or the second release area 1652, the instructions stored in the memory 130 may, when executed by the processor 120, cause the electronic device 101 to extend and display the target recently used screen (e.g., the twentieth recently used screen 1612).

In the screen 1603, when the user input 221 is released after the selected recently used screen (e.g., nineteenth recently used screen 1611) moving according to the user input moves to the first release area 1651 or the second release area 1652, the instructions stored in the memory 130 may, when executed by the processor 120, cause the electronic device 101 to trigger displaying of the single window on the display 160.

In the screen 1604, when the user input 221 is released after the selected recently used screen (e.g., the nineteenth recently used screen 1611) moving according to the user input 221 reaches the first release area 1651 or the second release area 1652, the instructions stored in the memory 130 may, when executed by the processor 120, cause the electronic device 101 to extend and display the selected recently used screen (e.g., the twentieth recently used screen 1611).

In the screen 1604 and the screen 1605, the instructions stored in the memory 130 may, when executed by the processor 120, cause the electronic device 101 to receive the user input 221 again for the recently used screen 1611 (e.g., the nineteenth recently used screen 1611) extended and currently displayed. For example, the recently used screen (for example, the twentieth recently used screen 1611) extended and being displayed may move based on the user input 221. The instructions stored in the memory 130 may, when executed by the processor 120, cause the electronic device 101 to display, on the display 160, movement of the recently used screen (for example, the nineteenth recently used screen 1611) according to the user input 221. The instructions stored in the memory 130 may, when executed by the processor 120, cause the electronic device 101 to display, on the display 160, that the recently used screen (e.g., the nineteenth recently used screen 1611) is disposed between other recently used screens 1612 and 1614 according to the user input 221.

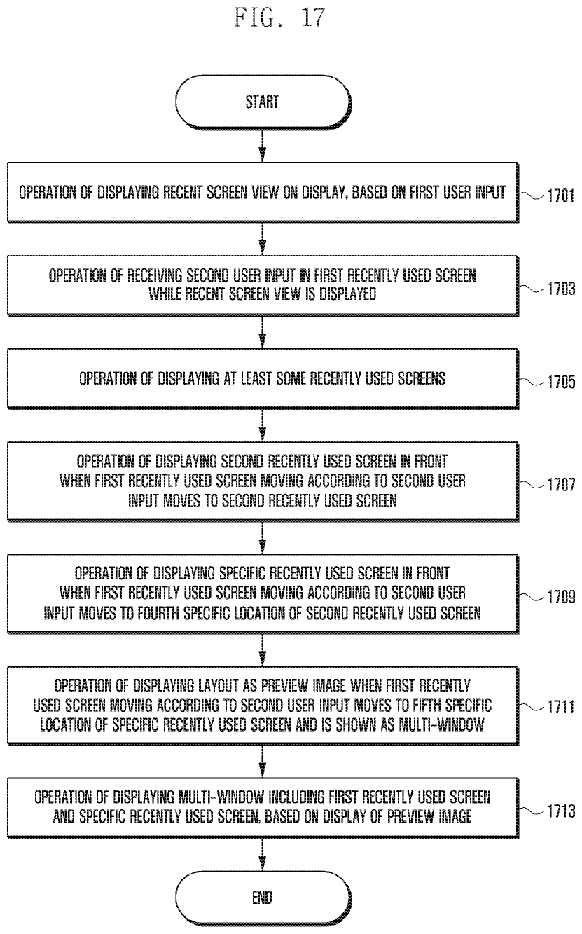

FIG. 17 is a flowchart illustrating an example screen display method of the electronic device 101 according to various example embodiments.

In an embodiment, the memory 130 may store instructions. The instructions may, when executed by the processor 120, cause the electronic device 101 to perform the screen display method in FIG. 17.

In an embodiment, in operation 1701, the instructions stored in the memory 130 may, when executed by the processor 120, cause the electronic device 101 to display a recent screen view on the display 160, based on a first user input. The first user input may include the first user input mentioned in FIG. 3. However, the disclosure is not limited thereto, and operation 1701 may be omitted.

In an embodiment, in operation 1701, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 1703, the instructions stored in the memory 130 may, when executed by the processor 120, cause the electronic device 101 to receive a second user input to the first recently used screen (e.g., the first recently used screen 211 of FIG. 2A) while displaying the recent screen view. The first recently used screen may be included in the recent screen view.

In an embodiment, the second user input may include, for example, the user input 221 mentioned in FIGS. 2A, 2B, 2C, 3, and 4.

In an embodiment, in operation 1705, the instructions stored in the memory 130 may, when executed by the processor 120, cause the electronic device 101 to display at least some of the recently used screens on the display 160.

In an embodiment, in operation 1705, the instructions stored in the memory 130 may, when executed by the processor 120, cause the electronic device 101 to display other recently used screens as images rendered in perspective.

However, the disclosure is not limited thereto, and in operation 1705, the instructions stored in the memory 130 may, when executed by the processor 120, cause the electronic device 101 to rotate at least some of the recently used screens about a specific axis or render them frontally without rotation and display them as images.

In an embodiment, in operation 1705, the instructions stored in the memory 130 may, when executed by the processor 120, cause the electronic device 101 to render and display the recently used screens in a form in which they vanish into one point, and display images.

In an embodiment, in operation 1705, the instructions stored in the memory 130 may, when executed by the processor 120, cause the electronic device 101 to display other recently used screens excluding the first recently used screen (e.g., the first recently used screen 211 in FIG. 2A)) as images rendered in perspective.

In an embodiment, in operation 1707, when the first recently used screen (e.g., the first recently used screen 211 in FIG. 2A) moving according to the second user input (e.g., the drag input) moves to the second recently used screen (e.g., the second recently used screen 214 in FIG. 2A) or the target recently used screen (e.g., the second recently used screen 214 in FIG. 2A) among the recently used screens, the instructions stored in the memory 130 may, when executed by the processor 120, cause the electronic device 101 to display a layout as a preview image on the display 160.

In an embodiment, in operation 1707, when the first recently used screen (e.g., the first recently used screen 211 in FIG. 2A) moving according to the second user input (e.g., the drag input) moves to the second recently used screen (e.g., the second recently used screen 214 in FIG. 2A) or the target recently used screen (e.g., the second recently used screen 214 in FIG. 2A) among the recently used screens while the second user input is maintained in the multi-window, the instructions stored in the memory 130 may, when executed by the processor 120, cause the electronic device 101 to display a layout as a preview image on the display 160.

In an embodiment, in operation 1707, when the first recently used screen (e.g., the first recently used screen 211 in FIG. 2A) moving according to the second user input (e.g., drag input) moves to the second recently used screen (e.g., the second recently used screen 214 in FIG. 2A) or the target recently used screen (e.g., the second recently used screen 214 in FIG. 2A), the instructions stored in the memory 130 may, when executed by the processor 120, cause the electronic device 101 to display, on the display 160, the second recently used screen (e.g., the second recently used screen 214 in FIG. 2A) in front.

In an embodiment, in operation 1709, when the first recently used screen (e.g., the first recently used screen 211 in FIG. 2A) moving according to the second user input (e.g., the drag input) moves to a fourth specific location among recently used screens, the instructions stored in the memory 130 may, when executed by the processor 120, cause the electronic device 101 to display a layout as a preview image on the display 160.

In an embodiment, in operation 1709, when the first recently used screen (e.g., the first recently used screen 211 in FIG. 2A) moving according to the second user input (e.g., the drag input) moves to the fourth specific location among the recently used screens while the second user input is maintained in the multi-window preview mode, the instructions stored in the memory 130 may, when executed by the processor 120, cause the electronic device 101 to display a layout as a preview image on the display 160.

In an embodiment, in operation 1709, when the first recently used screen (e.g., the first recently used screen 211 in FIG. 2A) moving according to the second user input (e.g., the drag input) moves to the fourth specific location among the recently used screens, the instructions stored in the memory 130 may, when executed by the processor 120, cause the electronic device 101 to display a specific recently used screen in front on the display 160. The specific recently used screen becomes a new target recently used screen, and the specific recently used screen may include a thumbnail image located on the left or right of the second recently used screen (e.g., the second recently used screen 214 in FIG. 2A) in the recent screen view. The fourth specific location may include, for example, critical areas (C and D) of the target recently used screen (e.g., sixteenth recently used screen 1514) in FIG. 15.

In an embodiment, in operation 1709, when the first recently used screen (e.g., the first recently used screen 211 in FIG. 2A) moving according to the second user input (e.g., the drag input) moves to the fourth specific location while the second user input is maintained in the multi-window preview mode, the instructions stored in the memory 130 may, when executed by the processor 120, cause the electronic device 101 to display the specific recently used screen on the display 160 in front. The specific recently used screen becomes a new target recently used screen, and the specific recently used screen may include a thumbnail image located on the left or right of the second recently used screen (e.g., the second recently used screen 214 in FIG. 2A) in the recent screen view. The fourth specific location may include, for example, critical areas (C and D) of the target recently used screen (e.g., sixteenth recently used screen 1514) in FIG. 15.

However, the disclosure is not limited thereto, and in operation 1709, when the first recently used screen (e.g., the first recently used screen 211 in FIG. 2A) moving according to the second user input (e.g., the drag input) moves to the fourth specific location, the instructions stored in the memory 130 may, when executed by the processor 120, cause the electronic device 101 to display the specific recently used screen on the display 160 in various ways (e.g., rotating the screen about a specific axis or displaying the screen in front without rotation).

In an embodiment, in operation 1711, when the first recently used screen (e.g., the first recently used screen 211 in FIG. 2A) moving according to the second user input (e.g., the drag input) moves to a fifth specific location and is shown as a multi-window, the instructions stored in the memory 130 may, when executed by the processor 120, cause the electronic device 101 to display a layout as a preview image. For example, the fifth specific location may include one of the first specific location, the second specific location, or the third specific location in FIG. 11.

In an embodiment, in operation 1711, when the first recently used screen (e.g., the first recently used screen 211 in FIG. 2A) moving according to the second user input (e.g., the drag input) moves to the fifth specific location and is shown as a multi-window while the second user input is maintained in the multi-window preview mode, the instructions stored in the memory 130 may, when executed by the processor 120, cause the electronic device 101 to display a layout as a preview image. For example, the fifth specific location may include one of the first specific location, the second specific location, or the third specific location in FIG. 11.

In an embodiment, in operation 1713, when the second user input is released while the preview image is being displayed, the instructions stored in the memory 130 may, when executed by the processor 120, cause the electronic device 101 to display a multi-window including the first recently used screen (e.g., the first recently used screen 211 in FIG. 2A) and the specific recently used screen, based on the display of the preview image.

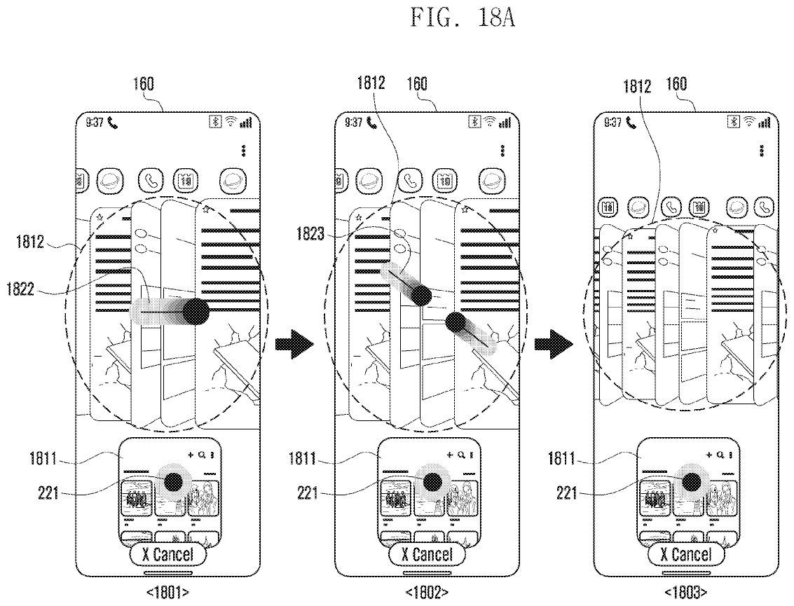

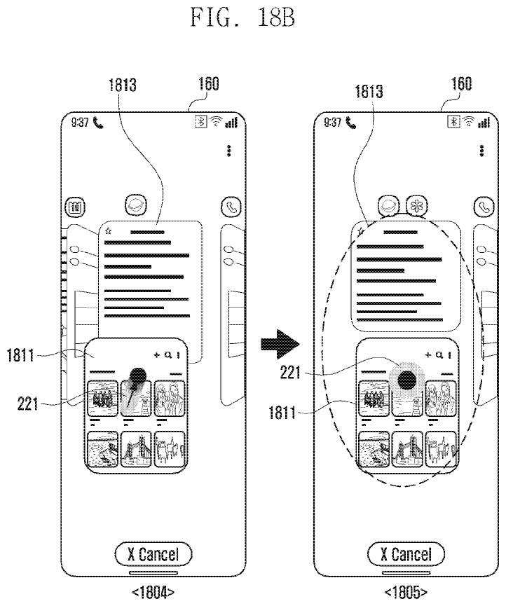

FIGS. 18A and 18B are diagrams illustrating an example screen display method of the electronic device 101 according to various example embodiments.

In the screen 1801, the instructions stored in the memory 130 may, when executed by the processor 120, cause the electronic device 101 to display the recent screen view on the display 160, based on the user input.

In the screen 1801, the instructions stored in the memory 130 may, when executed by the processor 120, cause the electronic device 101 to display recently used screens 1812 of previously or currently executed applications on the display 160. Each of the recently used screens 1812 may include a thumbnail image. The recently used screens 1812 of the previously or currently executed applications may be three-dimensionally displayed on the display 160.

In the screen 1801, when the recent screen view is executed, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 1801, the instructions stored in the memory 130 may, when executed by the processor 120, cause the electronic device 101 to select one (e.g., a twenty second recently used screen 1811) of the recently used screens 1812, based on the user input 221.

In an embodiment, while the user input 221 for the recently used screen (e.g., the twenty second recently used screen 1811) is received, the instructions stored in the memory 130 may, when executed by the processor 120, cause the electronic device 101 to receive a fifth user input 1822 for the recently used screens 1812. The instructions stored in the memory 130 may, when executed by the processor 120, cause the electronic device 101 to scroll a list of the recently used screens 1812 currently displayed in the recent screen view according to a fifth user input 1822 and display the same on the display 160.

In the screen 1802, the instructions stored in the memory 130 may, when executed by the processor 120, cause the electronic device 101 to select one (e.g., the twenty second recently used screen 1811) of the recently used screens 1812, based on the user input 221. While the user input 221 for the recently used screen (e.g., the twenty second recently used screen 1811), the instructions stored in the memory 130 may, when executed by the processor 120, cause the electronic device 101 to receive a sixth user input 1823 for the recently used screens 1812.

In the screen 1803, the instructions stored in the memory 130 may, when executed by the processor 120, cause the electronic device 101 to add and display a list of the recently used screens 1812 according to a sixth user input 1823.

In the screen 1803, the instructions stored in the memory 130 may, when executed by the processor 120, cause the electronic device 101 to select one (e.g., the twenty second recently used screen 1811) of the recently used screens 1812, based on the user input 221.

In the screen 1803, the instructions stored in the memory 130 may, when executed by the processor 120, cause the electronic device 101 to reduce and display the size of the list of the recently used screens 1812 according to the sixth user input 1823.

For example, the sixth user input 1823 may include a multi-touch input. The sixth user input 1823 may include a zoom-in gesture input or a zoom-out gesture input. The sixth user input 1823 may include, for example, a pinch zoom in or pinch zoom out input.

In the screen 1804, when the selected recently used screen (e.g., the twenty second recently used screen 1811) moving according to the user input 221 moves to a target recently used screen (e.g., a twenty third recently used screen 1813), the electronic device 101 may display the target recently used screen (e.g., the twenty third recently used screen 1813) as a plane (or front) image on the display 160 according to the control of the processor 120.

Referring to the screen 1804 and the screen 1805, the selected recently used screen (e.g., the twenty second recently used screen 1811) moving according to the user input 221 reaches a specific location (e.g., the first specific location in FIG. 11) of the target recently used screen (e.g., the twenty third recently used screen 1813), the instructions stored in the memory 130 may, when executed by the processor 120, cause the electronic device 101 to display a preview image 1831 on the display 160. The preview image 1831 may include the target recently used screen (e.g., the twenty third recently used screen 1813) and the selected recently used screen (e.g., the twenty second recently used screen 1811). The preview image 1831 may include a layout when the preview image is shown as a multi-window. The preview image 1831 may include a layout in which the selected recently used screen (e.g., twenty second recently used screen 1811) is disposed at the lower part and the target recently used screen (e.g., twenty third recently used screen 1813) is disposed at the upper part.

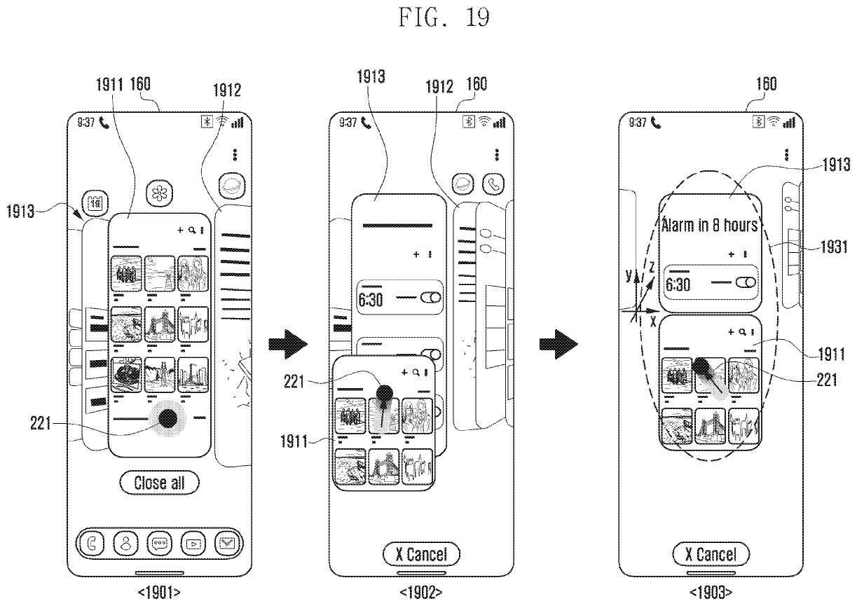

FIG. 19 is a diagram illustrating an example screen display method of the electronic device 101 according to various example embodiments.

In the screen 1901, the instructions stored in the memory 130 may, when executed by the processor 120, cause the electronic device 101 to display the recent screen view on the display 160, based on the user input. When a recent screen view is executed, the instructions stored in the memory 130 may, when executed by the processor 120, cause the electronic device 101 to display recently used screens 1911, 1912, and 1913 on the display 160. Each of the recently used screens 261 may include a thumbnail image. Each of the recently used screens 1911, 1912, and 1913 may include an image rendered in perspective.

In the screen 1901, when the recent screen view is executed, the instructions stored in the memory 130 may, when executed by the processor 120, cause the electronic device 101 to display a user interface of the recent screen view, which allows the electronic device 101 to browse a plurality of recently used screens, on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In the screen 1901, the instructions stored in the memory 130 may, when executed by the processor 120, cause the electronic device 101 to start an operation of executing a multi-window when the user input 221 for a twenty fourth recently used screen 1911 is received. When the operation of executing the multi-window is triggered, the instructions stored in the memory 130 may, when executed by the processor 120, cause the electronic device 101 to display other recently used screens except for the selected twenty fourth recently used screen 1911 according to the user input 221 on the display 160 as images rendered in perspective The user input 721 may include, for example, a long press input. The user input may include, for example, a long press input followed by a drag input.

Referring to screen 1902, when the selected twenty fourth recently used screen 1911 is displayed as a preview, the instructions stored in the memory 130 may, when executed by the processor 120, cause the electronic device 101 to reduce and display the size of the selected twenty fourth recently used screen 1911 compared to the previous size. When the selected twenty fourth recently used screen 1911 moving according to the user input 221 moves to the target recently used screen 1913, the instructions stored in the memory 130 may, when executed by the processor 120, cause the electronic device 101 to display the target recently used screen 1913 as a plane (or front) image on the display 160.

Referring to the screen 1903, when the selected twenty fourth recently used screen 1911 reaches a specific location (e.g., the first specific location in FIG. 11) of the target recently used screen 1913, the instructions stored in the memory 130 may, when executed by the processor 120, cause the electronic device 101 to display a preview image 1931 on the display 160. The preview image 1931 may include the target recently used screen 1913 and the selected twenty fourth recently used screen 1911. The preview image 1931 may include a layout when the preview image is shown as a multi-window. The preview image 1931 may include a layout in which the selected twenty fourth recently used screen 1911 is disposed at the lower part and the target recently used screen 1913 is disposed at the upper part. The instructions stored in the memory 130 may, when executed by the processor 120, cause the electronic device 101 to display the preview image 1931 on the display 160 such that the preview image is enlarged and displayed in front of the other recently used screens. The instructions stored in the memory 130 may, when executed by the processor 120, cause the electronic device 101 to display the preview image 1931 on the display 160 such that the preview image is enlarged and moved in a-z axis direction, and is displayed on the display 160 compared to other arranged recently used screens.

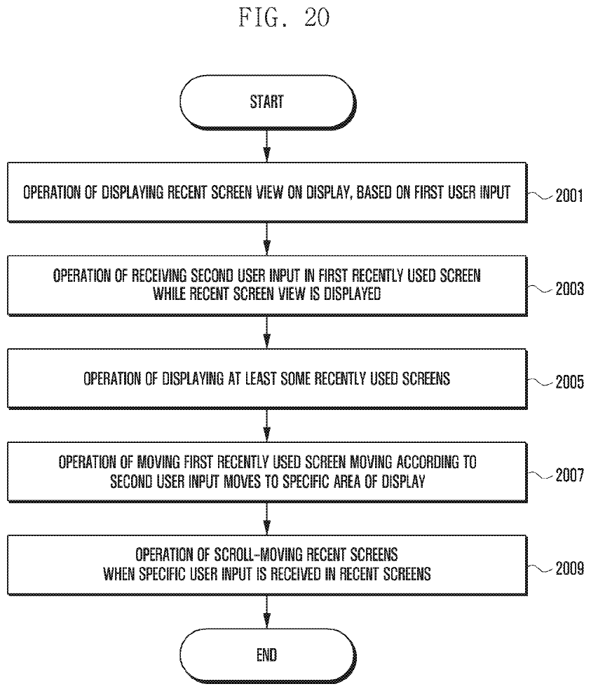

FIG. 20 is a flowchart illustrating an example screen display method of the electronic device 101 according to various example embodiments.

In an embodiment, the memory 130 may store instructions. The instructions may, when executed by the processor 120, cause the electronic device 101 to perform the screen display method in FIG. 20.

In an embodiment, in operation 2001, the instructions stored in the memory 130 may, when executed by the processor 120, cause the electronic device 101 to display a recent screen view on the display 160, based on a first user input. The first user input may include the first user input mentioned in FIG. 3. However, the disclosure is not limited thereto, and operation 2001 may be omitted.

In an embodiment, in operation 2001, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 2003, the instructions stored in the memory 130 may, when executed by the processor 120, cause the electronic device 101 to receive a second user input to the first recently used screen (e.g., the first recently used screen 211 of FIG. 2A) while displaying the recent screen view. The first recently used screen may be included in the recent screen view.

In an embodiment, the second user input may include, for example, the user input 221 mentioned in FIGS. 2A, 2B, 2C, 3, and 4.

In an embodiment, in operation 2005, the instructions stored in the memory 130 may, when executed by the processor 120, cause the electronic device 101 to display at least some of the recently used screens on the display 160.

In an embodiment, in operation 2005, the instructions stored in the memory 130 may, when executed by the processor 120, cause the electronic device 101 to display other recently used screens as images rendered in perspective.

However, the disclosure is not limited thereto, and in operation 2005, the instructions stored in the memory 130 may, when executed by the processor 120, cause the electronic device 101 to rotate at least some of the recently used screens about a specific axis or render them frontally without rotation and display them as images.

In an embodiment, in operation 2005, the instructions stored in the memory 130 may, when executed by the processor 120, cause the electronic device 101 to render and display the recently used screens in a form in which they vanish into one point, and display images.

In an embodiment, in operation 2005, the instructions stored in the memory 130 may, when executed by the processor 120, cause the electronic device 101 to display other recently used screens excluding the first recently used screen (e.g., the first recently used screen 211 in FIG. 2A)) as images rendered in perspective.

In an embodiment, in operation 2007, the instructions stored in the memory 130 may, when executed by the processor 120, cause the electronic device 101 to move the first recently used screen (e.g., the first recently used screen 211 in FIG. 2A) moving according to the second user input (e.g., the drag input) to a specific area of the display 160. For example, the specific area of the display 160 may include an external area of the recent view screen.

In an embodiment, in operation 2007, the instructions stored in the memory 130 may, when executed by the processor 120, cause the electronic device 101 to move the first recently used screen (e.g., the first recently used screen 211 in FIG. 2A) moving according to the second user input (e.g., the drag input) to a specific area of the display 160 while the second user input is maintained in the multi-window preview mode. For example, the specific area of the display 160 may include an external area of the recent view screen.

In an embodiment, in operation 2009, when a specific user input (for example, the fifth user input 1822) is received after the first recently used screen (e.g., the first recently used screen 211 in FIG. 2A) moves to a specific area of the display 160, the instructions stored in the memory 130 may, when executed by the processor 120, cause the electronic device 101 to scroll and display a list of the recently used screens displayed in the recent screen view on the display 160.

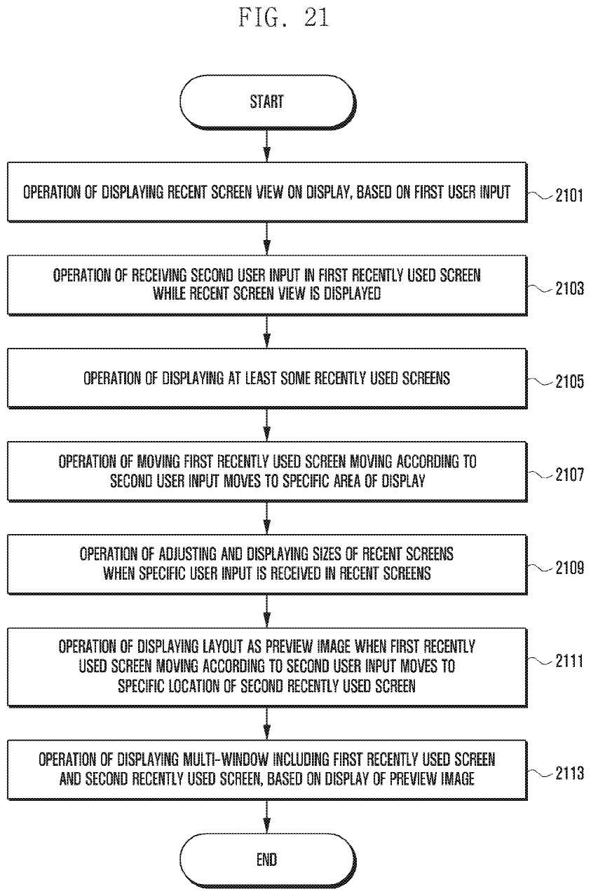

FIG. 21 is a flowchart illustrating an example screen display method of the electronic device 101 according to various example embodiments.

In an embodiment, the memory 130 may store instructions. The instructions may, when executed by the processor 120, cause the electronic device 101 to perform the screen display method in FIG. 21.

In an embodiment, in operation 2101, the instructions stored in the memory 130 may, when executed by the processor 120, cause the electronic device 101 to display a recent screen view on the display 160, based on a first user input. The first user input may include the first user input mentioned in FIG. 3. However, the disclosure is not limited thereto, and operation 2101 may be omitted.

In an embodiment, in operation 2101, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 2103, the instructions stored in the memory 130 may, when executed by the processor 120, cause the electronic device 101 to receive a second user input to the first recently used screen (e.g., the first recently used screen 211 of FIG. 2A) while displaying the recent screen view. The first recently used screen may be included in the recent screen view.

In an embodiment, the second user input may include, for example, the user input 221 mentioned in FIGS. 2A, 2B, 2C, 3, and 4.

In an embodiment, in operation 2105, the instructions stored in the memory 130 may, when executed by the processor 120, cause the electronic device 101 to display at least some of the recently used screens on the display 160.

In an embodiment, in operation 2105, the instructions stored in the memory 130 may, when executed by the processor 120, cause the electronic device 101 to display other recently used screens excluding the first recently used screen (e.g., the first recently used screen 211 in FIG. 2A)) as images rendered in perspective.

However, the disclosure is not limited thereto, and in operation 2105, the instructions stored in the memory 130 may, when executed by the processor 120, cause the electronic device 101 to rotate at least some of the recently used screens about a specific axis or render them frontally without rotation and display them as images.

In an embodiment, in operation 2105, the instructions stored in the memory 130 may, when executed by the processor 120, cause the electronic device 101 to render and display the recently used screens in a form in which they vanish into one point, and display images.

In an embodiment, in operation 2107, the instructions stored in the memory 130 may, when executed by the processor 120, cause the electronic device 101 to move the first recently used screen (e.g., the first recently used screen 211 in FIG. 2A) moving according to the second user input (e.g., the drag input) to s specific area of the display 160. For example, the specific area of the display 160 may include an external area of the recent view screen.

In an embodiment, in operation 2107, the instructions stored in the memory 130 may, when executed by the processor 120, cause the electronic device 101 to move the first recently used screen (e.g., the first recently used screen 211 in FIG. 2A) moving according to the second user input (e.g., the drag input) to a specific area of the display 160 while the second user input is maintained. For example, the specific area of the display 160 may include an external area of the recent view screen.

In an embodiment, in operation 2109, when a specific user input (e.g., the sixth user input 1823) is received after the instructions stored in the memory 130 may, when executed by the processor 120, cause the electronic device 101 to move the first recently used screen (e.g., the first recently used screen 211 in FIG. 2A) to a specific area of the display 160, the instructions stored in the memory 130 may, when executed by the processor 120, cause the electronic device 101 to adjust the sizes of recently used screens displayed in the recent screen view and display the same on the display 160.

In an embodiment, in operation 2111, when the first recently used screen (e.g., the first recently used screen 211 in FIG. 2A) moves to a specific position of the second recently used screen (for example, the second recently used screen 214 in FIG. 2A) and is shown as a multi-window, when the instructions stored in the memory 130, the instructions stored in the memory 130 may, when executed by the processor 120, cause the electronic device 101 to display a layout as a preview image.

In an embodiment, in operation 2113, the instructions stored in the memory 130 may, when executed by the processor 120, cause the electronic device 101 to display a multi-window including the first recently used screen (e.g., first recently used screen 211 in FIG. 2A) and the second recently used screen (e.g., second recently used screen 214 in FIG. 2A), based on display of the preview image.

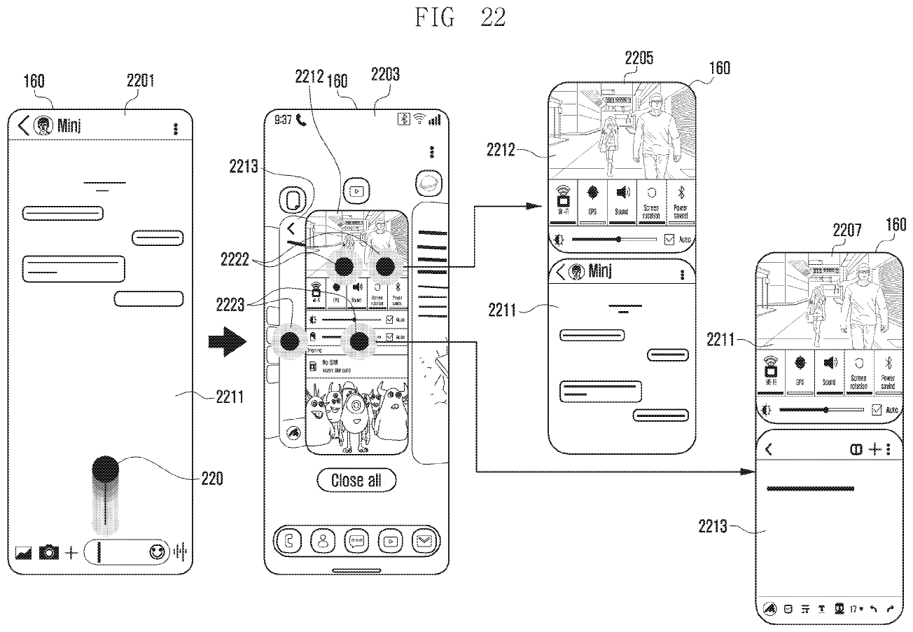

FIG. 22 is a diagram illustrating an example screen display method of the electronic device 101 according to various example embodiments.

In the screen 2201, the instructions stored in the memory 130 may, when executed by the processor 120, cause the electronic device 101 to display an application execution screen 2211 on the entire display 160.

In the screen 2201, the instructions stored in the memory 130 may, when executed by the processor 120, cause the electronic device 101 to receive the third user input 220 while the application execution screen 2211 is displayed on the display 160. The third user input 220 may include a swipe input.

In the screen 2201, when the third user input 220 is received, the instructions stored in the memory 130 may, when executed by the processor 120, cause the electronic device 101 to execute a recent screen view.

In the screen 2203, when the recent screen view is executed, the instructions stored in the memory 130 may, when executed by the processor 120, cause the electronic device 101 to display recently used screens 2212 and 2213 on the display 160.

In the screen 2203, the instructions stored in the memory 130 may, when executed by the processor 120, cause the electronic device 101 to receive a multi-touch input.

In screen 2203, the instructions stored in the memory 130 may, when executed by the processor 120, cause the electronic device 101 to receive a seventh user input 2222 for a twenty fifth recently used screen 2212.

In the screen 2205, when a seventh user input 2222 for the twenty fifth recently used screen 2212 is received, the instructions stored in the memory 130 may, when executed by the processor 120, cause the electronic device 101 to display the twenty fifth recently used screen 2212 and the execution screen 2211 of the recently executed application as a multi-window on the display 160. For example, the twenty fifth recently used screen 2212 may be included in the upper part of the multi-window, and the screen 2211 of the recently executed application may be included in the lower part of the multi-window.

In the screen 2203, the instructions stored in the memory 130 may, when executed by the processor 120, cause the electronic device 101 to receive an eighth user input 2223 for the twenty fifth recently used screen 2212 and the twenty sixth recently used screen 2213.

In the screen 2207, when the 8th user input 2223 for the twenty fifth recently used screen 2212 and the twenty sixth recently used screen 2213 are received, the instructions stored in the memory 130 may, when executed by the processor 120, cause the electronic device 101 to display the twenty fifth recently used screen 2212 and the twenty sixth recently used screen 2213 as a multi-window on the display 160. For example, the twenty fifth recently used screen 2212 may be included in the upper part of the multi-window, and the twenty sixth recently used screen 2213 may be included in the lower part of the multi-window.

Referring to FIG. 22, the instructions stored in the memory 130 may, when executed by the processor 120, cause the electronic device 101 to receive a multi-touch input for the recently used screens. The recently used screens included in the multi-window may vary depending on a combination of the recently used screens selected according to the multi-touch input.

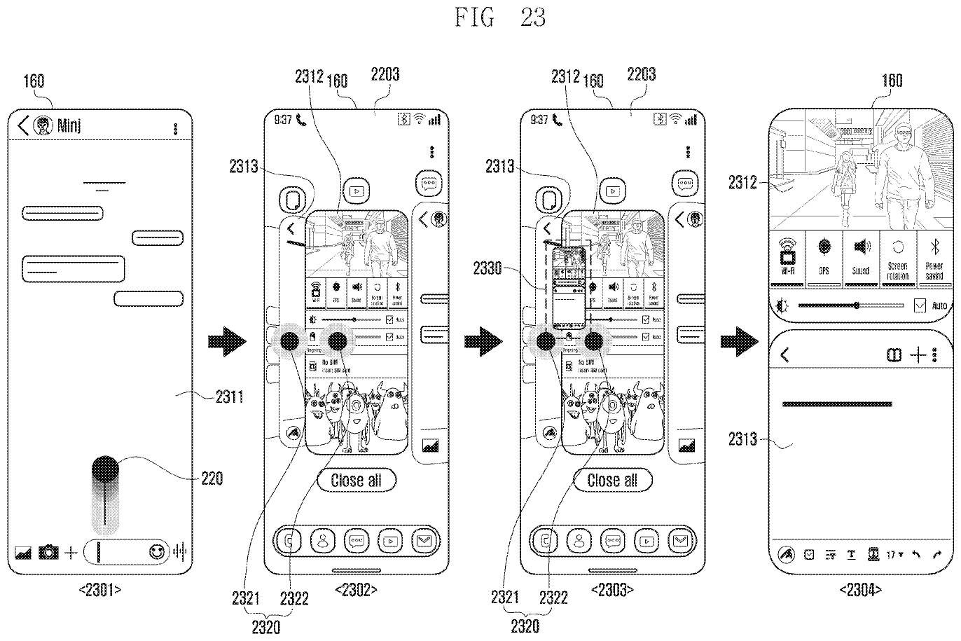

FIG. 23 is a diagram illustrating an example screen display method of the electronic device 101 according to various example embodiments.

In the screen 2301, the instructions stored in the memory 130 may, when executed by the processor 120, cause the electronic device 101 to display an application execution screen 2311 on the entire display 160.

In the screen 2301, the instructions stored in the memory 130 may, when executed by the processor 120, cause the electronic device 101 to receive the third user input 220 while the application execution screen 2211 is displayed on the display 160. The third user input 220 may include a swipe input.

In the screen 2301, when the third user input 220 is received, the instructions stored in the memory 130 may, when executed by the processor 120, cause the electronic device 101 to execute a recent screen view.

In the screen 2302, when the recent screen view is executed, the instructions stored in the memory 130 may, when executed by the processor 120, cause the electronic device 101 to display recently used screens 2212 and 2213 on the display 160.

In the screen 2302, the instructions stored in the memory 130 may, when executed by the processor 120, cause the electronic device 101 to receive a multi-touch input.

In the screen 2302, the instructions stored in the memory 130 may, when executed by the processor 120, cause the electronic device 101 to receive a ninth user input 2320 for a twenty seventh recently used screen 2312 and a twenty eighth recently used screen 2313.

In an embodiment, the ninth user input 2320 may include a two-finger multi-touch input. The ninth user input 2320 may include a first touch input 2321 and a second touch input 2322.

In an embodiment, when the first touch input 2321 to the twenty eighth recently used screen 2313 is received and the second touch input 2322 to the twenty seventh recently used screen 2312 is received, the instructions stored in the memory 130 may, when executed by the processor 120, cause the electronic device 101 to determine that the twenty seventh recently used screen 2312 and the twenty eighth recently used screen 2313 have been selected as recently used screens to be displayed on a multi-window.

In the screen 2303, when the ninth user input 2320 for the twenty seventh recently used screen 2312 and the twenty eighth recently used screen 2313 is received, the instructions stored in the memory 130 may, when executed by the processor 120, cause the electronic device 101 to display a preview image 2330 or a visual cue 2330 on at least a part of the display 160. For example, the preview image 2330 or the visual cue 2330 may be displayed while being overlaid on at least a part of the recent screen view. The preview image 2330 or the visual cue 2330 may be translucently or opaquely displayed while being overlaid on at least a part of the recent screen view. The preview image 2330 or the visual cue 2330 may include a screen related to the multi-window including recently used screens selected by the multi-touch input (e.g., ninth user input 2320).

In the screen 2304, when the ninth user input 2320 is released while the preview image 2330 or the visual cue 2330 for the twenty seventh recently used screen 2312 and the twenty eighth recently used screen 2313 is displayed, the instructions stored in the memory 130 may, when executed by the processor 120, cause the electronic device 101 to display the twenty seventh recently used screen 2312 and the twenty eighth recently used screen 2313 as a multi-window on the display 160. For example, the twenty seventh recently used screen 2312 may be included in the upper part of the multi-window, and the twenty eighth recently used screen 2313 may be included in the lower part of the multi-window.

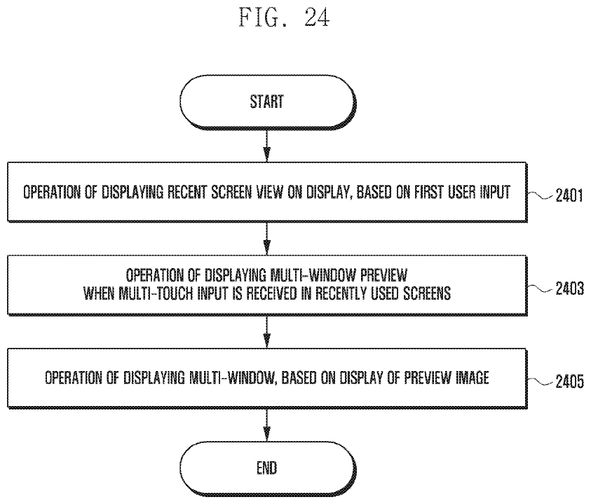

FIG. 24 is a flowchart illustrating an example screen display method of the electronic device 101 according to various example embodiments.

In an embodiment, in operation 2401, the instructions stored in the memory 130 may, when executed by the processor 120, cause the electronic device 101 to display a recent screen view on the display 160, based on a first user input. When the recent screen view is executed, the instructions stored in the memory 130 may, when executed by the processor 120, cause the electronic device 101 to display the recently used screens on the display 160.

In an embodiment, in operation 2401, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 2403, instructions stored in the memory 130 may, when executed by the processor 120, cause the electronic device 101 to display a multi-window preview on the display 160 when a multi-touch input to recently used screens is received.

In an embodiment, in operation 2403, the instructions stored in the memory 130 may cause, when executed by the processor 120 the electronic device 101 to display a multi-window preview (e.g., the preview image 2330 or the visual cue 2330 in FIG. 23) on at least a part of the display 160.

For example, the multi-window preview (e.g., the preview image 2330 or the visual cue 2330 in FIG. 23) may be displayed while being overlaid on at least a part of the recent screen view. The multi-window preview (e.g., the preview image 2330 or the visual cue 2330 in FIG. 23) may be translucently or opaquely displayed while being overlaid on at least a part of the recent screen view. The multi-window preview (e.g., the preview image 2330 or the visual cue 2330 in FIG. 23) may include a screen for a multi-window including recently used screens selected by a multi-touch input (e.g., the ninth user input 2320 in FIG. 23).

In an embodiment, in operation 2405, when the multi-touch input is released, the instructions stored in the memory 130 may, when executed by the processor 120, cause the electronic device 101 to display a multi-window, based on the display of the preview image.

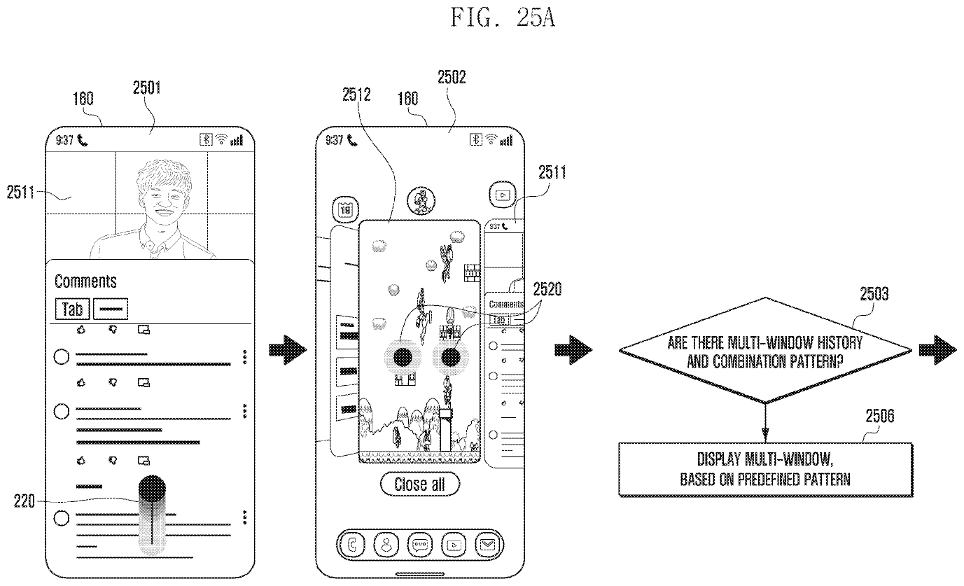

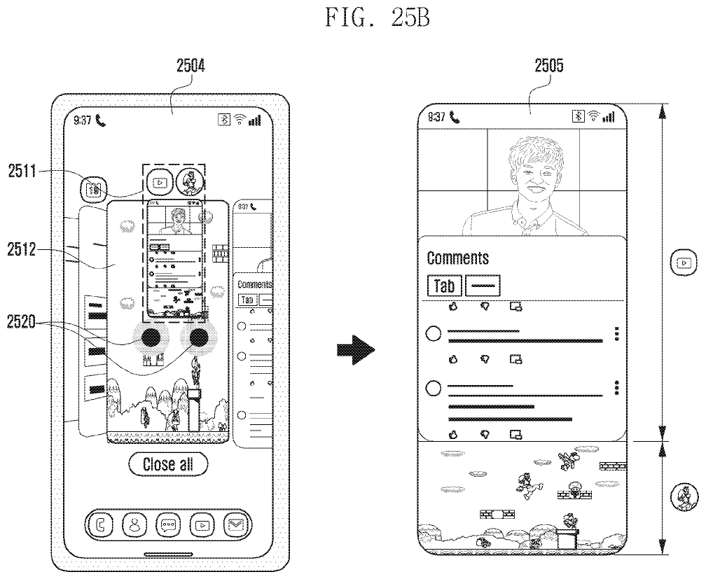

FIGS. 25A and 25B are diagrams illustrating an example screen display method of the electronic device 101 according to various example embodiments.

In an embodiment, the memory 130 may store instructions. The instructions stored in the memory 130 may, when executed by the processor 120, cause the electronic device 101 to perform the screen display method of FIG. 25.

In the screen 2501, the instructions stored in the memory 130 may, when executed by the processor 120, cause the electronic device 101 to display a screen 2511 corresponding to an application being executed on the display 160. However, the disclosure is not limited thereto, and the screen displayed on the display 160 in screen 2501 may include one of a screen corresponding to the application being executed, a home screen, or a lock screen.

In the screen 2501, while the screen 2511 corresponding to the application being executed is displayed, the instructions stored in the memory 130 may, when executed by the processor 120, cause the electronic device 101 to determine whether a third user input 220 has been received.

In the screen 2501, when the third user input 220 is received, the instructions stored in the memory 130 may, when executed by the processor 120, cause the electronic device 101 to execute a recent screen view. The recent screen view may include the twenty ninth recently used screen 2312 and a thirtieth recently used screen 2313.

In the screen 2502, instructions stored in the memory 130 may, when executed by the processor 120, cause the electronic device 101 to receive a multi-touch input 2520.

In screen 2502, the instructions stored in the memory 130 may, when executed by the processor 120, cause the electronic device 101 to receive the multi-touch input 2520 for the twenty ninth recently used screen 2312.

In the operation 2503, when the multi-touch input 2520 for the twenty ninth recently used screen 2312 is received, the instructions stored in the memory 130 may, when executed by the processor 120, cause the electronic device 101 to determine whether there is a history of generating a multi-window using the twenty ninth recently used screen 2312 and whether there is a combination pattern based on an application capable of generating a multi-window together with the twenty ninth recently used screen 2312.

When there is no history of generating a multi-window using the twenty ninth recently used screen 2312, or when there is no combination pattern based on an application capable of generating a multi-window together with the twenty ninth recently used screen 2312, in operation 2506, the instructions stored in the memory 130 may, when executed by the processor 120, cause the electronic device 101 to display a multi-window including the twenty ninth recently used screen 2312, based on a predefined pattern.

When there is a history of generating a multi-window using the twenty ninth recently used screen 2312, or when there is a combination pattern based on an application capable of generating a multi-window together with the twenty ninth recently used screen 2312, in screen 2504, the instructions stored in the memory 130 may, when executed by the processor 120, cause the electronic device 101 to automatically generate a layout of a multi-window and display the same as a preview image 2511.

For example, when the twenty ninth recently used screen 2312 is a game execution screen and the application capable of generating a multi-window with the twenty ninth recently used screen 2312 is a video reproduction application, the screen ratio between the video reproduction application and the game application in the multi-window may be set such that the screen ratio of the video reproduction application, which requires greater focus on the video, is greater than that of the game application.

In the screen 2505, when the multi-touch input 2520 is released, the instructions stored in the memory 130 may, when executed by the processor 120, cause the electronic device 101 to display a multi-window, based on the preview image 2511.

The preview image 2511 may include a visual cue. For example, the preview image 2511 or the visual cue may be displayed while being overlaid on at least a part of the recent screen view. The preview image 2511 or the visual cue may be translucently or opaquely displayed while being overlaid on at least a part of the recent screen view. The preview image 2511 or the visual cue may include a screen for a multi-window including recently used screens selected by a multi-touch input (e.g., the multi-touch input 2520).

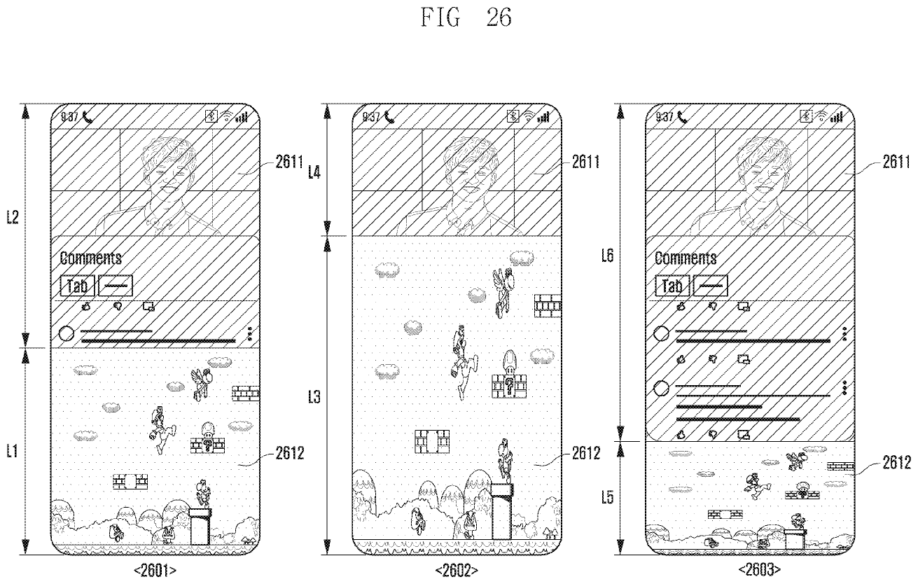

FIG. 26 is a diagram illustrating an example screen display method of the electronic device 101 according to various example embodiments.

Referring to the screen 2504, the instructions stored in the memory 130 may, when executed by the processor 120, cause the electronic device 101 to automatically generate a layout of the multi-window and display the same as a preview image 2511. FIG. 26 is a diagram illustrating a layout which may be displayed by the electronic device 101 according to various example embodiments.

In the screen 2601, the instructions stored in the memory 130 may, when executed by the processor 120, cause the electronic device 101 to automatically generate a layout of the multi-window at the same ratio and display the same as a preview image 2511 or the multi-window (screen 2505). For example, a thirty first recently used screen 2611 and a thirty second recently used screen 2612 may have the same ratio of a horizontal length to a vertical length. When the vertical length of the thirty first recently used screen 2611 is L2 and the vertical length of the thirty second recently used screen 2612 is L1, the lengths of L1 and L2 may be the same.

In the screen 2602, the instructions stored in the memory 130 may, when executed by the processor 120, cause the electronic device 101 to automatically generate a layout of the multi-window so that the upper window is smaller than the lower window, and display the preview image 2511 or the multi-window (screen 2505). For example, the thirty first recently used screen 2611 and the thirty second recently used screen 2612 may have the same horizontal length, but different vertical length ratios. When the vertical length of the thirty first recently used screen 2611 is L3 and the vertical length of the thirty second recently used screen 2612 is L4, the lengths of L3 and L4 may be different from each other, and the ratio may be 3:1.

In the screen 2603, the instructions stored in the memory 130 may, when executed by the processor 120, cause the electronic device 101 to automatically generate a layout of the multi-window in which the upper window is larger than the lower window and display the same as the preview image 2511 or the multi-window 2505. For example, the thirty first recently used screen 2611 and the thirty second recently used screen 2612 may have the same horizontal length, but different vertical length ratios. When the vertical length of the thirty first recently used screen 2611 is L5 and the vertical length of the thirty second recently used screen 2612 is L6, the lengths of L5 and L6 may be different from each other, and the ratio may be 1:3.

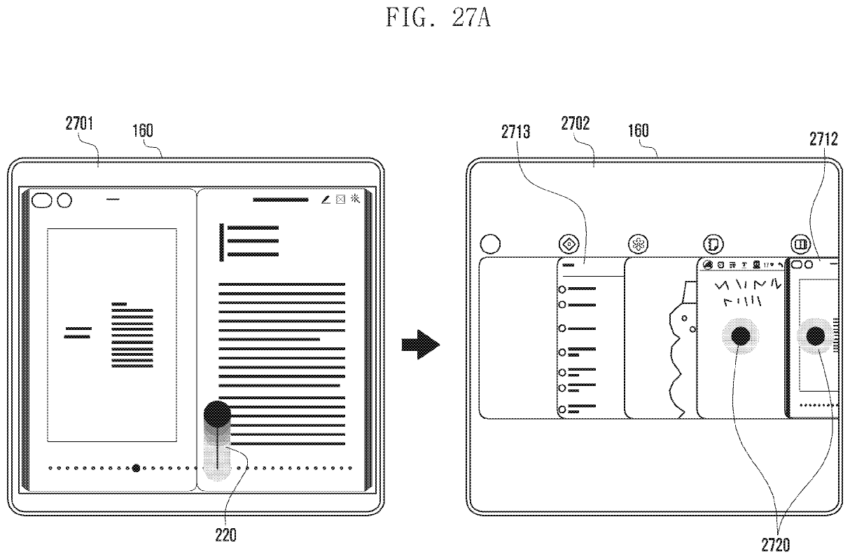

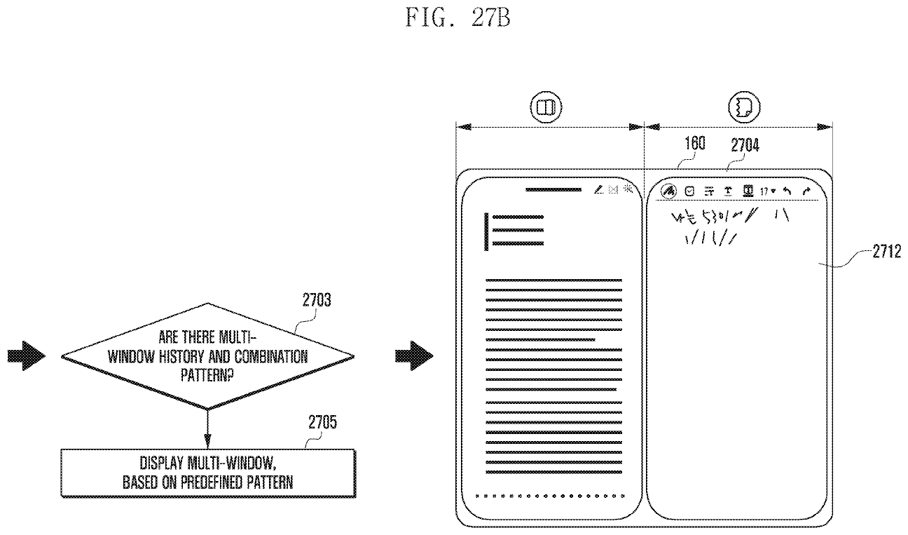

FIGS. 27A and 27B are diagrams illustrating an example screen display method of the electronic device 101 according to various example embodiments.

In an embodiment, the memory 130 may store instructions. The instructions stored in the memory 130 may, when executed by the processor 120, cause the electronic device 101 to perform the screen display method of FIG. 27.

FIGS. 25A and 25B illustrate a screen display method when the orientation of the electronic device 101 is in a portrait mode, and FIGS. 27A and 27B may illustrate a screen display method when the orientation of the electronic device 101 is in a landscape mode.

In the screen 2701, the instructions stored in the memory 130 may, when executed by the processor 120, cause the electronic device 101 to display a screen 2511 corresponding to an application being executed on the display 160. However, the disclosure is not limited thereto, and the screen displayed on the display 160 in screen 2701 may include one of a screen corresponding to the application being executed, a home screen, or a lock screen.

In the screen 2701, while the screen 2511 corresponding to the application being executed is displayed, the instructions stored in the memory 130 may, when executed by the processor 120, cause the electronic device 101 to determine whether a third user input 220 has been received.

In the screen 2701, when the third user input 220 is received, the instructions stored in the memory 130 may, when executed by the processor 120, cause the electronic device 101 to execute a recent screen view. The recent screen view may include a thirty third recently used screen 2712 and a thirty fourth recently used screen 2713.

In the screen 2702, instructions stored in the memory 130 may, when executed by the processor 120, cause the electronic device 101 to receive a multi-touch input 2720.

In screen 2702, the instructions stored in the memory 130 may, when executed by the processor 120, cause the electronic device 101 to receive a multi-touch input 2720 for the thirty third recently used screen 2712.

In operation 2703, when the multi-touch input 2720 for the thirty third recently used screen 2712 is received, the instructions stored in the memory 130 may, when executed by the processor 120, cause the electronic device 101 to determine whether there is a history of generating a multi-window using the thirty third recently used screen 2712 and whether there is a combination pattern based on an application capable of generating a multi-window together with the thirty third recently used screen 2712.

When there is no history of generating a multi-window using the thirty third recently used screen 2712 or when there is no combination pattern based on an application capable of generating a multi-window together with the thirty third recently used screen 2712, in operation 2705, the instructions stored in the memory 130 may, when executed by the processor 120, cause the electronic device 101 to display a multi-window including the thirty third recently used screen 2712, based on a predefined pattern.

When there is a history of generating a multi-window using the thirty third recently used screen 2712 and when there is a combination pattern based on an application capable of generating a multi-window together with the thirty third recently used screen 2712, if the multi-touch input 2520 is released in screen 2704, the instructions stored in the memory 130 may, when executed by the processor 120, cause the electronic device 101 to automatically generate a layout of the multi-window and display the multi-window. In the screen 2704, the instructions stored in the memory 130 may, when executed by the processor 120, cause the electronic device 101 to display the multi-window including the thirty third recently used screen 2712 as a preview image (not shown).

The preview image (not shown) may include a visual cue. For example, the preview image (not shown) or the visual cue may be displayed while being overlaid on at least a part of the recent screen view. The preview image (not shown) or the visual cue may be translucently or opaquely displayed while being overlaid on at least a part of the recent screen view. The preview image (not shown) or the visual cue may include a screen for the multi-window including recently used screens selected by a multi-touch input (e.g., multi-touch input 2720).

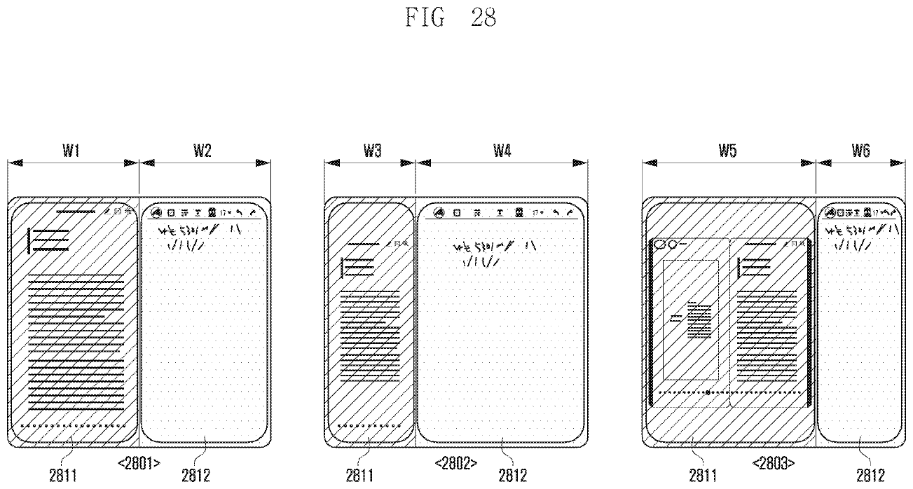

FIG. 28 is a diagram illustrating an example screen display method of the electronic device 101 according to various example embodiments.

Referring to the screen 2704, the instructions stored in the memory 130 may, when executed by the processor 120, cause the electronic device 101 to automatically generate a layout of the multi-window and display the same as a preview image 2511. FIG. 28 is a diagram illustrating a layout which may be displayed by the electronic device 101 according to various example embodiments.

In the screen 2801, the instructions stored in the memory 130 may, when executed by the processor 120, cause the electronic device 101 to automatically generate a layout of the multi-window at the same ratio and display the same as a multi-window (screen 2704). For example, a thirty fifth recently used screen 2811 and a thirty sixth recently used screen 2812 may have the same ratio of the horizontal length and the vertical length. When the horizontal length of the thirty fifth recently used screen 2811 is W1 and the horizontal length of the thirty sixth recently used screen 2812 is W1, the lengths of W1 and W2 may be the same.

In the screen 2802, the instructions stored in the memory 130 may, when executed by the processor 120, cause the electronic device 101 to display a multi-window 2704 such that the layout of the multi-window is automatically generated so that the upper window is smaller than the lower window and is displayed as the multi-window (screen 2704). For example, the thirty fifth recently used screen 2811 and the thirty sixth recently used screen 2812 may have the same vertical length but different horizontal length ratios. When the horizontal length of the thirty fifth recently used screen 2811 is W3 and the horizontal length of the thirty sixth recently used screen 2812 is W4, the lengths of W3 and W4 are different from each other, and the ratio may be 1:3.

In the screen 2803, the instructions stored in the memory 130 may, when executed by the processor 120, cause the electronic device 101 to automatically generate a layout of the multi-window such that the upper window is larger than the lower window and to display the same as the multi-window (screen 2704). For example, the thirty fifth recently used screen 2811 and the thirty sixth recently used screen 2812 may have the same vertical length but different horizontal length ratios. When the horizontal length of the thirty fifth recently used screen 2811 is W5 and the horizontal length of the thirty sixth recently used screen 2812 is W6, the lengths of W5 and W6 are different, and the ratio is 3:1.

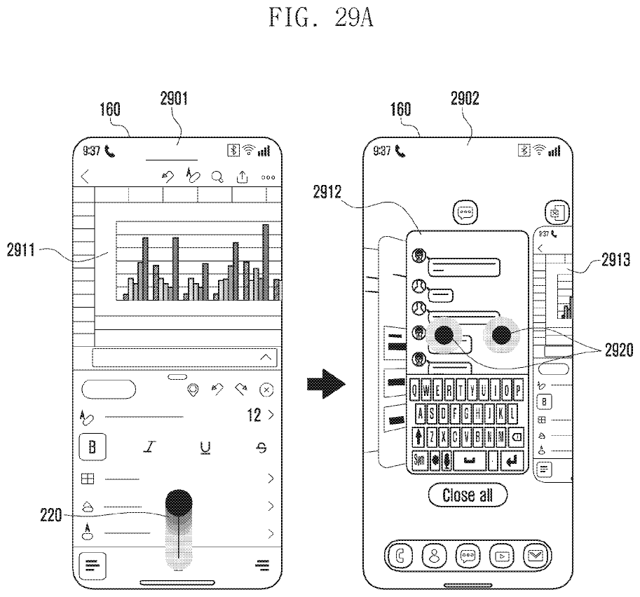

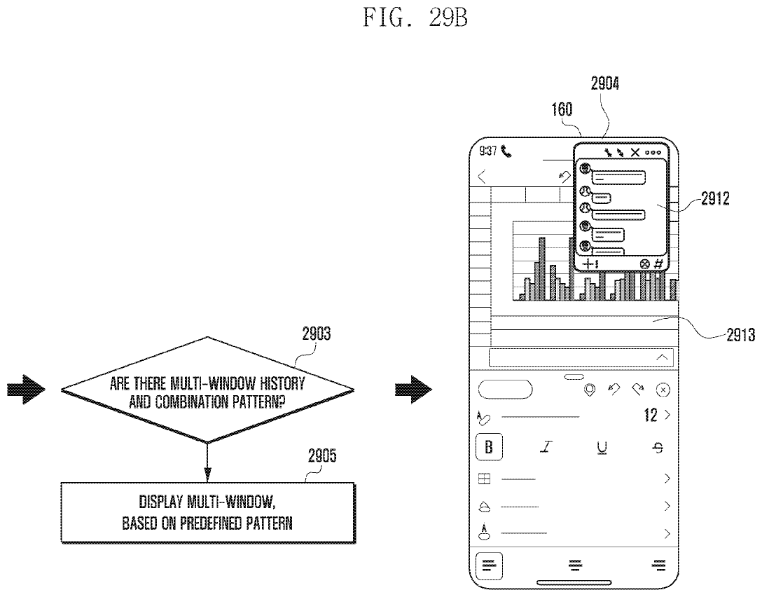

FIGS. 29A and 29B are diagrams illustrating an example screen display method of the electronic device 101 according to various example embodiments.

In an embodiment, the memory 130 may store instructions. The instructions stored in the memory 130 may, when executed by the processor 120, cause the electronic device 101 to perform the screen display method of FIG. 29.

FIGS. 25A, 25B, 27A, and 27B may illustrate a screen display method of a multi-window of the electronic device 101 of which the orientation is split, and FIGS. 29A and 29B may illustrate a screen display method of an overlaid multi-window of the electronic device 101 of which the orientation is split.

In the screen 2901, the instructions stored in the memory 130 may, when executed by the processor 120, cause the electronic device 101 to display a screen 2511 corresponding to an application being executed on the display 160. However, the disclosure is not limited thereto, and the screen displayed on the display 160 in screen 2901 may include one of a screen corresponding to the application being executed, a home screen, or a lock screen.

In the screen 2901, while the screen 2911 corresponding to the application being executed is displayed, the instructions stored in the memory 130 may, when executed by the processor 120, cause the electronic device 101 to determine whether a third user input 220 has been received.

In the screen 2901, when the third user input 220 is received, the instructions stored in the memory 130 may, when executed by the processor 120, cause the electronic device 101 to execute a recent screen view. The recent screen view may include a thirty seventh recently used screen 2912 and a thirty eighth recently used screen 2913.

In the screen 2902, instructions stored in the memory 130 may, when executed by the processor 120, cause the electronic device 101 to receive a multi-touch input 2920.

In screen 2902, the instructions stored in the memory 130 may, when executed by the processor 120, cause the electronic device 101 to receive a multi-touch input 2920 for the thirty seventh recently used screen 2912.

In operation 2903, when the multi-touch input 2920 for the thirty seventh recently used screen 2912 is received, the instructions stored in the memory 130 may, when executed by the processor 120, cause the electronic device 101 to determine whether there is a history of generating a multi-window using the thirty seventh recently used screen 2912 and whether there is a combination pattern based on an application capable of generating a multi-window together with the thirty seventh recently used screen 2912.

When there is no history of generating a multi-window using the thirty seventh recently used screen 2912 or when there is no combination pattern based on an application capable of generating a multi-window together with the thirty seventh recently used screen 2912, in operation 2905, the instructions stored in the memory 130 may, when executed by the processor 120, cause the electronic device 101 to display a multi-window including the thirty seventh recently used screen 2912, based on a predefined pattern.

When there is a history of generating a multi-window using the thirty seventh recently used screen 2912 and when there is a combination pattern based on an application capable of generating a multi-window together with the thirty seventh recently used screen 2912, in screen 2904, the instructions stored in the memory 130 may, when executed by the processor 120, cause the electronic device 101 to automatically generate a layout of the multi-window and display the multi-window. In the screen 2904, the instructions stored in the memory 130 may, when executed by the processor 120, cause the electronic device 101 to display the multi-window including the thirty seventh recently used screen 2912 as a preview image (not shown). In the screen 2904, the multi-window may display the pop-up window to be overlaid.

The preview image (not shown) may include a visual cue. For example, the preview image (not shown) or the visual cue may be displayed while being overlaid on at least a part of the recent screen view. The preview image (not shown) or the visual cue may be translucently or opaquely displayed while being overlaid on at least a part of the recent screen view. The preview image (not shown) or the visual cue may include a screen for the multi-window including recently used screens selected by a multi-touch input (e.g., multi-touch input 2920).

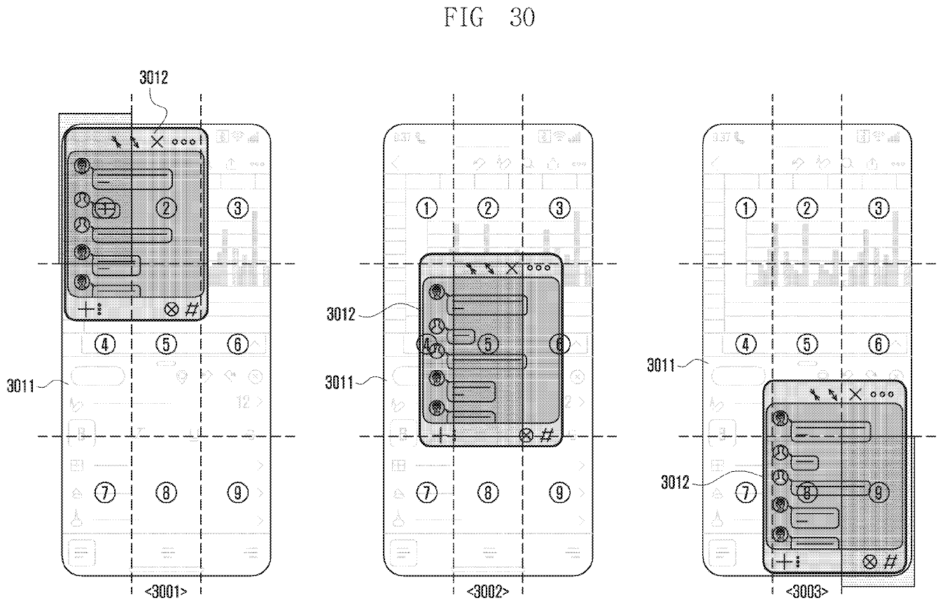

FIG. 30 is a diagram illustrating an example screen display method of the electronic device 101 according to various example embodiments.

Referring to the screen 2904, the instructions stored in the memory 130 may, when executed by the processor 120, cause the electronic device 101 to automatically generate a layout of the multi-window and display the same as a preview image 2511. FIG. 30 is a diagram illustrating a layout which may be displayed by the electronic device 101 according to various example embodiments.

In screens 3001, 3002, and 3003, the instructions stored in the memory 130 may, when executed by the processor 120, cause the electronic device 101 to automatically generate a layout of a multi-window and display the same as a multi-window (screen 2904). The multi-window (screen 2904) screen may display a fortieth recently used screen 3012 as a pop-up window above a thirty ninth recently used screen 3011. In this case, a display location or a layout of the pop-up window (e.g., fortieth recently used screen 3012) on the thirty ninth recently used screen 3011 may be automatically generated and displayed. For example, the screen may be divided into three parts in the vertical direction and three parts in the horizontal direction, resulting in a total of nine parts, and the fortieth recently used screen 3012 may be generated in one of the nine parts, based on the history and the combination pattern.

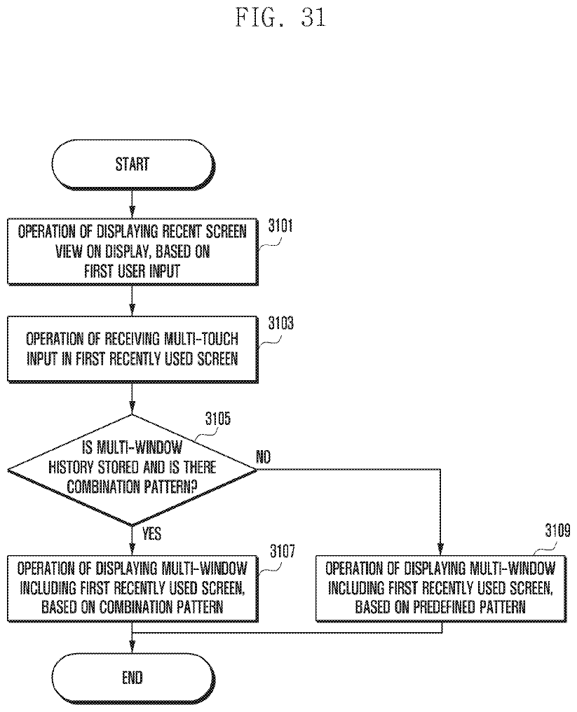

FIG. 31 is a flowchart illustrating an example method a screen display method of the electronic device 101 according to various example embodiments.

In an embodiment, the memory 130 may store instructions. The instructions may, when executed by the processor 120, cause the electronic device 101 to perform the screen display method in FIG. 31.

In an embodiment, in operation 3101, the instructions stored in the memory 130 may, when executed by the processor 120, cause the electronic device 101 to display a recent screen view on the display 160, based on a first user input. The first user input may include the first user input mentioned in FIG. 3. However, the disclosure is not limited thereto, and operation 3101 may be omitted.

In an embodiment, in operation 3101, when the recent screen view is executed, the instructions stored in the memory 130 may, when executed by the processor 120, cause the electronic device 101 to display a user interface of the recent screen view that allows the user to browse a plurality of recently used screens on the display 160. Each of the plurality of recently used screens may represent an execution screen of an application previously executed or currently being executed in the electronic device 101. The user interface of the recent screen view may provide interactions such as operation of browsing of a plurality of recently used screens, entering a multi-window mode, and/or performing full-screen execution with regard to a selected recently used screen.

In an embodiment, in operation 3103, the instructions stored in the memory 130 may, when executed by the processor 120, cause the electronic device 101 to receive a multi-touch input on a first recently used screen (e.g., the first recently used screen 211 in FIG. 2A) while a recent screen view is displayed. The first recently used screen may be included in the recent screen view.

In an embodiment, in operation 3105, the instructions stored in the memory 130 may, when executed by the processor 120, cause the electronic device 101 to determine whether there is a history of generating a multi-window using the first recently used screen (e.g., the first recently used screen 211 in FIG. 2A) and whether there is a combination pattern, based on an application capable of generating a multi-window together with the first recently used screen (e.g., the first recently used screen 211 in FIG. 2A).

When there is a history of generating a multi-window using the first recently used screen (e.g., first recently used screen 211 in FIG. 2A) and there is a combination pattern, based on an application capable of generating a multi-window together with the first recently used screen (e.g., first recently used screen 211 in FIG. 2A), the instructions stored in the memory 130 may, when executed by the processor 120, cause the electronic device 101 to branch from operation 3105 to operation 3107.

When there is no history of generating a multi-window using the first recently used screen (e.g., first recently used screen 211 in FIG. 2A) and there is no combination pattern, based on an application capable of generating a multi-window together with the first recently used screen (e.g., first recently used screen 211 in FIG. 2A), the instructions stored in the memory 130 may, when executed by the processor 120, cause the electronic device 101 to branch from operation 3105 to operation 3109.

In an embodiment, in operation 3107, the instructions stored in the memory 130 may, when executed by the processor 120, cause the electronic device 101 to automatically generate a layout of a multi-window including the first recently-used screen (e.g., the first recently-used screen 211 in FIG. 2A), based on the combination pattern, and display the multi-window.

In an embodiment, in operation 3109, the instructions stored in the memory 130 may, when executed by the processor 120, cause the electronic device 101 to display a multi-window including the first recently used screen (e.g., the first recently used screen 211 in FIG. 2A), based on a predefined pattern.

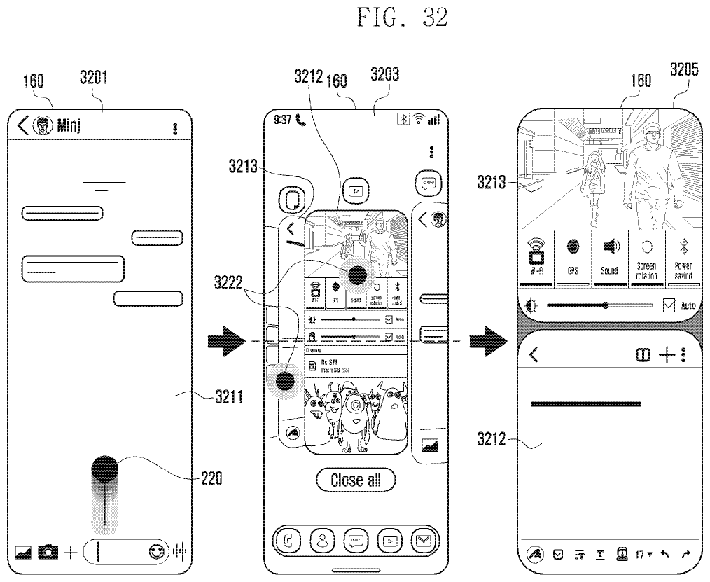

FIG. 32 is a diagram illustrating an example screen display method of the electronic device 101 according to various example embodiments.

In the screen 3201, the instructions stored in the memory 130 may, when executed by the processor 120, cause the electronic device 101 to display an application execution screen 3211 on the entire display 160.

In the screen 3201, the instructions stored in the memory 130 may, when executed by the processor 120, cause the electronic device 101 to receive the third user input 220 while the application execution screen 3211 is displayed on the display 160. The third user input 220 may include a swipe input.

In the screen 3203, when the third user input 220 is received, the instructions stored in the memory 130 may, when executed by the processor 120, cause the electronic device 101 to display recently used screens 3212 and 3213.

In the screen 3203, the electronic device 101 may receive a tenth user input 3222 for a forty first recently used screen 3212 and a forty second recently used screen 3213 according to the control of the processor 120. The tenth user input 3222 may include a multi-touch input. The tenth user input 3222 may include a two-finger long press input. The tenth user input 3222 may include an input in which one input is long-pressed in the forty first recently used screen 3212 and another input is long-pressed on the forty second recently used screen 3213.

In an embodiment, the instructions stored in the memory 130 may, when executed by the processor 120, cause the electronic device 101 to dispose the recently used screen (e.g., the forty second recently used screen 3213) for receiving a touch input inputted above a specific location reference (E) on the upper part of the multi-window and to dispose the recently used screen (e.g., the forty first recently used screen 3212) for receiving a touch input inputted below the specific location reference (E) on the lower part of the multi-window. The specific location reference (E) may include, for example, a thumbnail image center location. The specific location reference (E) may include, for example, the intermediate location between two touch points of the tenth user input 3222.

In the screen 3205, the instructions stored in the memory 130 may, when executed by the processor 120, cause the electronic device 101 to display the forty first recently used screen 3212 and the forty second recently used screen 3213 for receiving the tenth user input 3222 on the display 160 as a multi-window. The forty first recently used screen 3212 may be located at the lower part of the multi-window, and the forty second recently used screen 3213 may be located at the upper part of the multi-window.

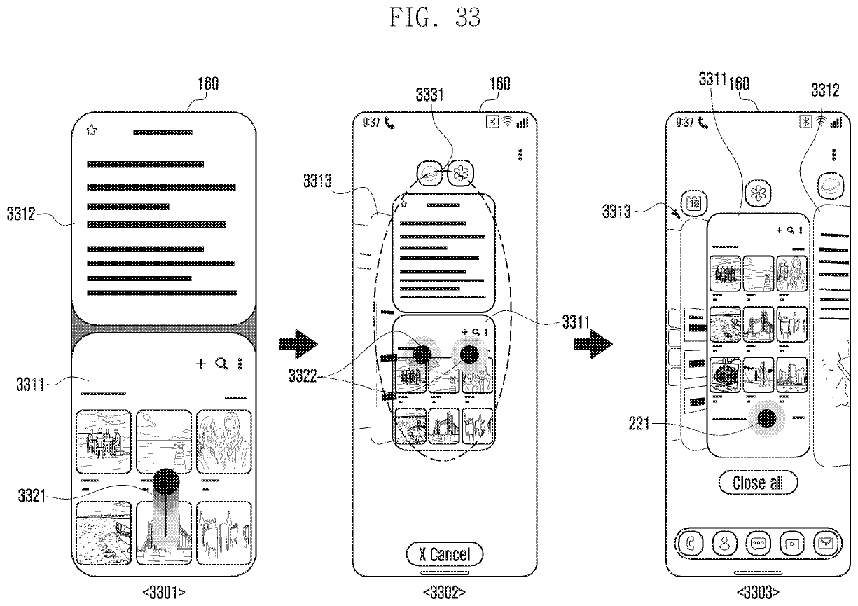

FIG. 33 is a diagram illustrating an example screen display method of the electronic device 101 according to various example embodiments.

In the screen 3301, the instructions stored in the memory 130 may, when executed by the processor 120, cause the electronic device 101 to display an execution screen on the display 160 as a multi-window. For example, the lower part of the multi-window may include a first application execution screen 3211, and the upper part of the multi-window may include a second application execution screen 3212. A bar may be displayed between the first application execution screen 3211 and the second application execution screen 3212.

In the screen 3301, the instructions stored in the memory 130 may, when executed by the processor 120, cause the electronic device 101 to receive a user input 3321 (e.g., the third user input 220) while an execution screen is displayed as the multi-window on the display 160.

In the screen 3302, when a user input (e.g., the third user input 220) is received, the instructions stored in the memory 130 may, when executed by the processor 120, cause the electronic device 101 to display recently used screens 3313 and 3331. The multi-window screen may be displayed as a forty third recently used screen 3331. The forty third recently used screen 3331 may include a multi-window preview.

In the screen 3302, the instructions stored in the memory 130 may, when executed by the processor 120, cause the electronic device 101 to receive a multi-touch input 3322 for one (e.g., the first application execution screen 3311) of the forty third recently used screens 3331. The multi-touch input 3322 may include a two-finger long press input.

In the screen 3303, when the multi-touch input 3322 to one (e.g., the first application execution screen 3311) of the forty third recently used screens 3331 is received, the instructions stored in the memory 130 may, when executed by the processor 120, cause the electronic device 101 to separate the first application execution screen 3311 and the second application execution screen 3312 in the multi-window preview screen and display the same together with another recently used screen 3313 on the display 160.

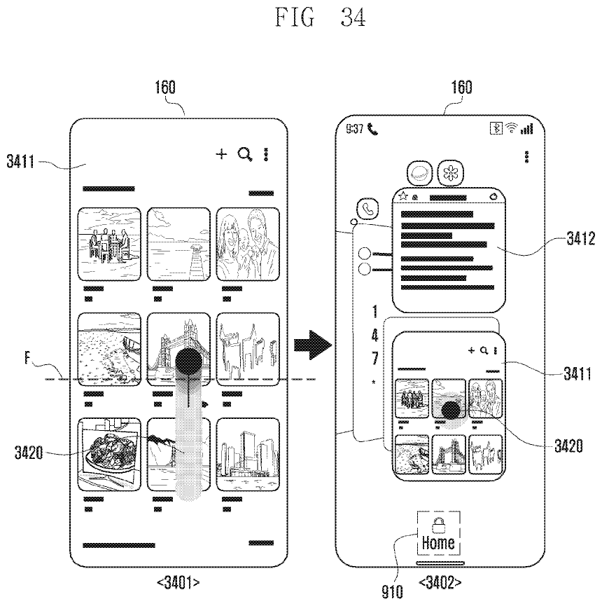

FIG. 34 is a diagram illustrating an example screen display method of the electronic device 101 according to various example embodiments.

In the screen 3401, the instructions stored in the memory 130 may, when executed by the processor 120, cause the electronic device 101 to display an execution screen 3411 corresponding to an application on the display 160.

In the 3401 screen, the instructions stored in the memory 130 may, when executed by the processor 120, cause the electronic device 101 to receive an eleventh user input 3420. In the screen 3401, the instructions stored in the memory 130 may, when executed by the processor 120, cause the electronic device 101 to determine whether the eleventh user input 3420 is input beyond a critical point (F) from the lower part of the display 160 or whether the eleventh user input 3420 is maintained for a time longer than a predetermined time after a swipe operation.

When the eleventh user input 3420 is input beyond the critical point (F) from the lower part or the eleventh user input 3420 is maintained for the time longer than the predetermined time after the swipe operation, in the 3402 screen, the instructions stored in the memory 130 may cause, executed by the processor 120, the electronic device 101 to display a multi-window preview screen using the displayed execution screen 3411 together with the recent screen view. The multi-window preview screen may include a forty four recently used screen 3411 and a forty fifth recently used screen 3412 corresponding to the displayed execution screen 3411.

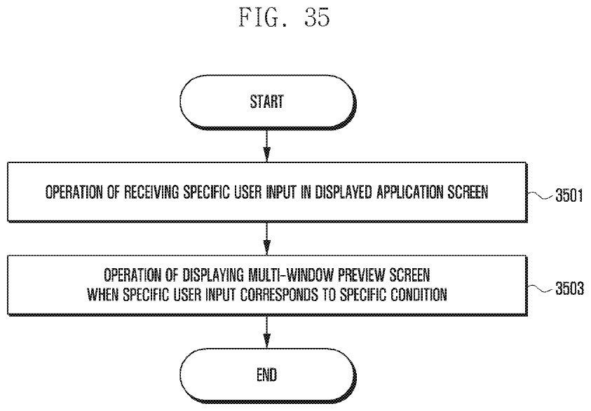

FIG. 35 is a flowchart illustrating an example screen display method of the electronic device 101 according to various example embodiments.

In an embodiment, the memory 130 may store instructions. The instructions may, when executed by the processor 120, cause the electronic device 101 to perform the screen display method in FIG. 35.

In an embodiment, in operation 3501, the instructions stored in the memory 130 may, when executed by the processor 120, cause the electronic device 101 to receive a specific user input on the displayed application.

In an embodiment, in operation 3503, the instructions stored in the memory 130 may, when executed by the processor 120, cause the electronic device 101 to display a multi-window preview screen using the displayed execution screen 3411 together with the recent screen view when the specific user input corresponds to a specific condition.

In an embodiment, in operation 3503, the instructions stored in the memory 130 may, when executed by the processor 120, cause the electronic device 101 to determine whether the specific user input is input beyond a critical point from the lower part of the display 160 or whether the specific user input maintains a press input for a time longer than a predetermined time after a swipe operation.

In an embodiment, in operation 3501, the instructions stored in the memory 130 may, when executed by the processor 120, cause the electronic device 101 to display the multi-window preview screen using the displayed execution screen 3411 together with the recent screen view when the specific user input is input beyond the critical point from the lower part of the display 160 or whether the specific user input maintains the press input for the time longer than the predetermined time after the swipe operation.

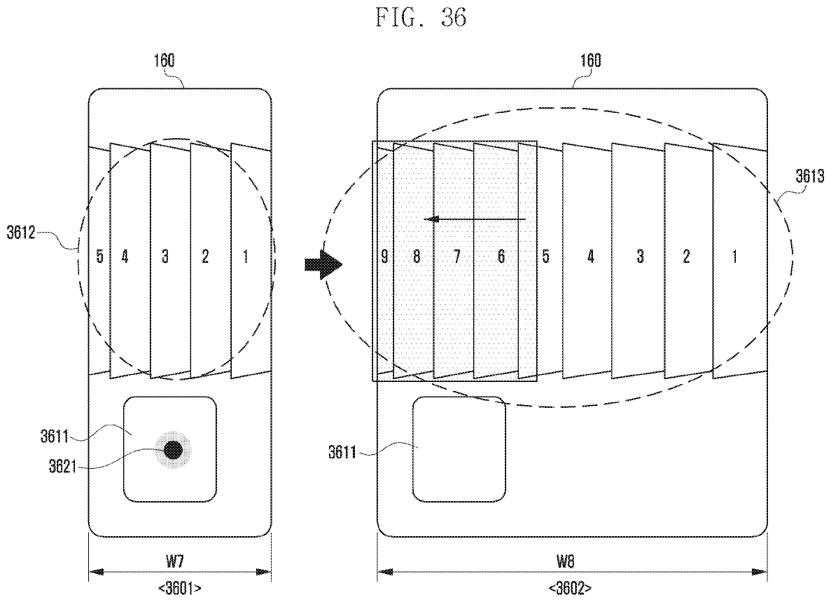

FIG. 36 is a diagram illustrating an example screen display method of the electronic device 101 according to various example embodiments.

The electronic device 101 of the disclosure may further include a movable or slidable housing. The display 160 may include a flexible display having a size changeable according to expansion and reduction of the slidable housing.

In the screen 3601, when the slidable housing has a first width (W7), the instructions stored in the memory 130 may, when executed by the processor 120, cause the electronic device 101 to display a recently used screen 1212 including five lists or thumbnails. When a user input 3621 to a specific recently used screen 3611 is received in the recently used screen 3612, execution of a multi-window may be triggered.

In the screen 3602, when the slidable housing has a second width (W8), the instructions stored in the memory 130 may, when executed by the processor 120, cause the electronic device 101 to display a recently used screen 3613 including nine lists or thumbnails. The second width (W8) may be longer than the first width (W7).

In an embodiment, the electronic device 101 may include the display 160, the memory 130 configured to store instructions, and the processor 120.

In an embodiment, the instructions may, when executed by the processor 120, cause the electronic device 101 to display a user interface of the recent screen view, which enables browsing a plurality of recently used screens, on the display 160 by executing the recent screen view, based on the first user input.

In an embodiment, each of the plurality of recently used screens may represent an execution screen of an application previously executed or currently being executed in the electronic device 101.

In an embodiment, the instructions, when executed by the processor 120, may cause the electronic device 101 to enter a multi-window preview mode in response to receiving a second user input on a first recently used screen displayed on the display 160 among a plurality of recently used screens through the recent screen viewer's user interface.

In an embodiment, the instructions may, when executed by the processor 120, cause the electronic device 101 to display at least some of the plurality of recently used screens in a multi-window preview mode, and when the first recently used screen moves to a specific location for the target recently used screen among the plurality of recently used screens according to the second user input while the second user input is maintained in the multi-window preview mode, to display a layout of the multi-window, in which the first recently used screen and the target recently used screen may be displayed together.

In an embodiment, when the second user input is released, the instructions may, when executed by the processor 120, cause the electronic device 101 to display a multi-window including the first recently used screen and the target recently used screen and corresponding to the preview image.

In an embodiment, the instructions may, when executed by the processor 120, cause the electronic device 101 to display the target recently used screen when the first recently used screen moving according to the second user input moves to the target recently used screen.

In an embodiment, the instructions may, when executed by the processor 120, cause the electronic device 101 to identify whether there is an application to be recommended when entering a multi-window preview mode, and when there is the application to be recommended display an icon of the application to be recommended and recently used screens.

In an embodiment, the instructions may, when executed by the processor 120, cause the electronic device 101 to display a usage screen of the application to be recommended and the recently used screens when there is the application to be recommended.

In an embodiment, the instructions may, when executed by the processor 120, cause the electronic device 101 to identify whether there is an application to be recommended, based on at least one of a multi-window usage history learned in relation to the first application, an association between the first application and the application to be recommended, categories of the first application and the application to be recommended, or a usage time of the application to be recommended.

In an embodiment, the instructions may, when executed by the processor 120, cause the electronic device 101 to display a multi-window such that the first recently used screen is included in the lower part of the multi-window and the target recently used screen is included in the upper part of the multi-window when the first recently used screen moving according to the second user input moves to a first specific location of the target recently used screen.

In an embodiment, when the instructions may, when executed by the processor 120, cause the electronic device 101 to display the multi-window such that the first recently used screen is overlaid as a pop-up on the target recently used screen when the first recently used screen moving according to the second user input moves to a second specific location of the target recently used screen.

In an embodiment, the instructions may, when executed by the processor 120, cause the electronic device 101 to display a multi-window including the first recently used screen and an execution screen of a most recently executed application when a multi-touch input to the first recently used screen is received while the recent screen view is displayed.

In an embodiment, the instructions may, when executed by the processor 120, cause the electronic device 101 to display a multi-window including the first recently used screen and the target recently used screen when a multi-touch input to the first recently used screen and the target recently used screen is received while the recent screen view is displayed.

In an embodiment, the instructions may, when executed by the processor 120, cause the electronic device 101 to determine whether there is a history of generating a multi-window using the first recently used screen and whether there is a combination pattern, based on an application capable of generating a multi-window together with the first recently used screen when a multi-touch input to the first recently used screen is received while the recent screen view is displayed.

In an embodiment, when there is a history of generating a multi-window using the first recently used screen and there is a combination pattern, based on an application capable of generating a multi-window together with the first recently used screen, the instructions may, when executed by the processor 120, cause the electronic device 101 to automatically generate and display a layout of the multi-window.

In an embodiment, the screen display method of the electronic device 101 may include an operation of displaying a user interface of a recent screen view, which enables browsing a plurality of recently used screens, on the display 160 by executing the recent screen view, based on a first user input.

In an embodiment, each of the plurality of recently used screens may indicate an execution screen of an application previously executed or currently being executed in the electronic device 101.

In an embodiment, the method may include an operation of entering a multi-window preview mode in response to reception of a second user input to a first recently used screen displayed on the display among the plurality of recently used screens through the user interface of the recent screen view, an operation of displaying at least some of the plurality of recently used screens in the multi-window preview mode, an operation of, when the first recently used screen moves to a specific location for a target recently used screen among the plurality of recently used screens in which the first recently used screen is displayed according to the second user input while the second user input is maintained in the multi-window preview mode, displaying a layout of a multi-window for displaying both the first recently used screen and the target recently used screen as a preview image, and an operation of, when the second user input is released, displaying the multi-window including the first recently used screen and the target recently used screen and corresponding to the preview image.

In an embodiment, the screen display method of the electronic device 101 may include an operation of, when the first recently used screen moving according to the second user input moves to the target recently used screen, displaying the target recently used screen.

In an embodiment, the screen display method of the electronic device 101 may include an operation of, in case of entering the multi-window preview mode, identifying whether there is an application to be recommended, and an operation of, when there is an application to be recommended, displaying an icon of the application to be recommended and the recently used screens.

In an embodiment, the screen display method of the electronic device 101 may include an operation of, when there is an application to be recommended, displaying the application to be recommended and recently used screens.

In an embodiment, the screen display method of the electronic device 101 may include an operation of identifying whether there is the application to be recommended, based on at least one of a multi-window usage history learned in relation to a first application, an association between the first application and the application to be recommended, categories of the first application and the application to be recommended, or a usage time of the application to be recommended.

In an embodiment, the screen display method of the electronic device 101 may include an operation of, when the first recently used screen moving according to the second user input moves to a first specific location of the target recently used screen, displaying a multi-window such as the first recently used screen is included in the lower part of the multi-window and the target recently used screen is included in the upper part of the multi-window.

In an embodiment, the screen display method of the electronic device 101 may include an operation of, when the first recently used screen moving according to the second user input moves to a second specific location of the target recently used screen, displaying a multi-window such that the first recently used screen is overlaid as a pop-up on the target recently used screen.

In an embodiment, the screen display method of the electronic device 101 may include an operation of displaying a multi-window including the first recently used screen and an execution screen of a most recently executed application when a multi-touch input to the first recently used screen is received while the recent screen view is displayed.

In an embodiment, the screen display method of the electronic device 101 may include an operation of displaying a multi-window including the first recently used screen and the target recently used screen when a multi-touch input to the first recently used screen and the target recently used screen is received while the recent screen view is displayed.

In an embodiment, the screen display method of the electronic device 101 may include an operation of, when the multi-touch input to the first recently used screen is received while the recent screen view is displayed, determining whether there is a history of generating the multi-window using the first recently used screen and whether there is a combination pattern, based on an application capable of generating the multi-window together with the first recently used screen and an operation of, when there is the history of generating the multi-window using the first recently used screen and whether there is the combination pattern, based on the application capable of generating the multi-window together with the first recently used screen, automatically generate and display a layout of the multi-window.

An electronic device according to various embodiments disclosed herein may be any of various types of devices. The electronic devices may include, for example, a portable communication device (e.g., a smartphone), a computer device, a portable multimedia device, a portable medical device, a camera, a wearable device, a home appliance, or the like. The electronic device according to various embodiments disclosed herein is not limited to the above-described devices.

It is to be understood that various embodiments of the disclosure and terms for describing various embodiments are not intended to limit the technical features disclosed herein to specific embodiments, and that various embodiments may include various modifications, equivalents, or substitutions of the corresponding embodiments. In relation to the description of the drawings, similar reference numerals may be used for similar or related components. The singular form of a noun corresponding to an item may include one item or a plurality of items unless the context clearly indicates otherwise. In the disclosure, each of phrases, such as “A or B,” “at least one of A and B,” “at least one of A or B,” “A, B, or C,” “at least one of A, B, and C,” and “at least one of A, B, or C” may include any one of the items listed together in the corresponding phrase or all possible combinations of the items. Such terms as “a first”, “a second”, “the first”, and “the second” may be used to simply distinguish a corresponding element from another, and does not limit the elements in other aspect (e.g., importance or order). When a certain (e.g., a first) component is mentioned as being “coupled” or “connected” to another (e.g., a second) component, with or without a term “functionally” or “communicatively,” the certain component may be connected to the other component directly (e.g., wiredly), wirelessly, or via a third component.

The term “module” used in various embodiments of the disclosure may include a unit implemented in hardware, software, or firmware, or any combination thereof, and may be used interchangeably with terms such as “logic,” “logic block,” “component,” “circuit,” or the like. The module may be an integrally configured component or a minimum unit or a portion of the component, which performs one or more functions. For example, according to an embodiment, the module may be implemented in the form of an application-specific integrated circuit (ASIC).

Various embodiments disclosed herein may be implemented by software (e.g., the program 140) including one or more instructions stored in a storage medium (e.g., internal memory 136 or external memory 138) readable by a machine (e.g., an electronic device 101). For example, a processor (e.g., the processor 120) of a device (e.g., the electronic device 101) may invoke and execute at least one of the stored one or more instructions from the storage medium. This enables the device to be operated to perform at least one function in response to the at least one invoked instruction. The one or more instructions may include codes generated by a compiler or code capable of being executed by an interpreter. The machine-readable storage medium may be provided in the form of a non-transitory storage medium. Here, the “non-transitory” storage medium is a tangible device and may not contain a signal (e.g., electromagnetic waves), and this term is not intended to distinguish a case where data is permanently stored on the storage medium and a case where data is temporarily stored.

According to an embodiment, a method according to various embodiments set forth herein may be included and provided in a computer program product. The computer program product may be traded as a product between a seller and a purchaser. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each of the above-described components (e.g., module or program) may include either a single entity or multiple entities, and some of the multiple entities may be placed separately from other components. According to various embodiments, one or more of the components or operations described above may be omitted, or one or more other components or operations may be added. Alternatively, or additionally, multiple components (e.g., modules or programs) may be integrated into a single component. In such a case, the integrated element may perform one or more functions of each of the plurality of elements in the same or similar manner as they are performed by a corresponding one of the plurality of elements before the integration. According to various embodiments, operations performed by a module, a program, or other components may be executed sequentially, in parallel, repetitively, or heuristically, one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a display;
memory storing instructions; and
at least one processor, comprising processing circuitry,
wherein the instructions that, when executed by the at least one processor, individually and/or collectively, cause the electronic device to:
display a user interface of a recent screen view, enabling browsing a plurality of recently used screens, on the display by executing the recent screen view, based on a first input, each of the plurality of recently used screens indicating an execution screen of an application previously executed or currently being executed in the electronic device;
enter a multi-window preview mode in response to receiving a second input to a first recently used screen displayed on the display among the plurality of recently used screens through the user interface of the recent screen view;
display at least some of the plurality of recently used screens in the multi-window preview mode and, based on the first recently used screen moving to a specific location for a target recently used screen among the displayed plurality of recently used screens according to the second input while the second user is maintained in the multi-window preview mode, display a layout of a multi-window, enabling displaying both the first recently used screen and the target recently used screen, as a preview image; and
based on the second input being released, display the multi-window including the first recently used screen and the target recently used screen and corresponding to the preview image.

2. The electronic device of claim 1, wherein the instructions that, when executed by the at least one processor, individually and/or collectively, cause the electronic device to:
based on the first recently used screen moving according to the second input moving to the target recently used screen, display the target recently used screen.

3. The electronic device of claim 1, wherein the instructions that, when executed by the at least one processor, individually and/or collectively, cause the electronic device to:
based on entering the multi-window preview mode, identify whether there is an application to be recommended; and
based on there being the application to be recommended, display an icon of the application to be recommended and the recently used screens.

4. The electronic device of claim 2, wherein the instructions that, when executed by the at least one processor, individually and/or collectively, cause the electronic device to:
based on there being an application to be recommended, display a usage screen of the application to be recommended and the recently used screens.

5. The electronic device of claim 2, wherein the instructions that, when executed by the at least one processor, individually and/or collectively, cause the electronic device to:
identify whether there is the application to be recommended, based on at least one of a multi-window usage history learned in relation to a first application, an association between the first application and the application to be recommended, categories of the first application and the application to be recommended, and/or a usage time of the application to be recommended.

6. The electronic device of claim 1, wherein the instructions that, when executed by the at least one processor, individually and/or collectively, cause the electronic device to:
based on the first recently used screen moving according to the second input moving to a first specific location of the target recently used screen, display the multi-window such that the first recently used screen is included in a lower part of the multi-window and the target recently used screen is included in an upper part of the multi-window.

7. The electronic device of claim 1, wherein the instructions that, when executed by the at least one processor, individually and/or collectively, cause the electronic device to:
based on the first recently used screen moving according to the second input moving to a second specific location of the target recently used screen, display the multi-window such that the first recently used screen is overlaid as a pop-up on the target recently used screen.

8. The electronic device of claim 1, wherein the instructions that, when executed by the at least one processor, individually and/or collectively, cause the electronic device to:
based on a multi-touch input to the first recently used screen being received while the recent screen view is displayed, display a multi-window including the first recently used screen and an execution screen of a most recently executed application.

9. The electronic device of claim 1, wherein the instructions that, when executed by the at least one processor, individually and/or collectively, cause the electronic device to, based on a multi-touch input to the first recently used screen and the target recently used screen being received while the recent screen view is displayed, display a multi-window including the first recently used screen and the target recently used screen.

10. The electronic device of claim 8, wherein the instructions that, when executed by the at least one processor, individually and/or collectively, cause the electronic device to:
based on the multi-touch input to the first recently used screen being received while the recent screen view is displayed, determine whether there is a history of generating the multi-window using the first recently used screen and whether there is a combination pattern based on an application capable of generating the multi-window together with the first recently used screen; and
based on there being the history of generating the multi-window using the first recently used screen and there being the combination pattern based on the application capable of generating the multi-window together with the first recently used screen, automatically generate and display a layout of the multi-window.

11. A method of displaying a screen of an electronic device, the method comprising:
displaying a user interface of a recent screen view, enabling browsing a plurality of recently used screens, on a display by executing the recent screen view, based on a first input, each of the plurality of recently used screens indicating an execution screen of an application previously executed or currently being executed in the electronic device;
entering a multi-window preview mode in response to receiving a second input to a first recently used screen displayed on the display among the plurality of recently used screens through the user interface of the recent screen view;
displaying at least some of the plurality of recently used screens in the multi-window preview mode;
based on the first recently used screen moving to a specific location for a target recently used screen among the displayed plurality of recently used screens according to the second input while the second input is maintained in the multi-window preview mode, displaying a layout of a multi-window, enabling displaying both the first recently used screen and the target recently used screen, as a preview image; and
based on the second input being released, displaying the multi-window including the first recently used screen and the target recently used screen and corresponding to the preview image.

12. The method of claim 11, further comprising:
based on the first recently used screen moving according to the second input moving to the target recently used screen, displaying the target recently used screen.

13. The method of claim 11, further comprising:
based on entering the multi-window preview mode, identifying whether there is an application to be recommended; and
based on there being the application to be recommended, displaying an icon of the application to be recommended and the recently used screens.

14. The method of claim 12, further comprising:
based on there being an application to be recommended, displaying a usage screen of the application to be recommended and the recently used screens.

15. The method of claim 12, further comprising:
identifying whether there is the application to be recommended, based on at least one of a multi-window usage history learned in relation to a first application, an association between the first application and the application to be recommended, categories of the first application and the application to be recommended, and/or a usage time of the application to be recommended.

16. The method of claim 11, further comprising, based on the first recently used screen moving according to the second input moving to a first specific location of the target recently used screen, displaying the multi-window such that the first recently used screen is included in a lower part of the multi-window and the target recently used screen is included in an upper part of the multi-window.

17. The method of claim 11, further comprising, based on the first recently used screen moving according to the second input moving to a second specific location of the target recently used screen, display the multi-window such that the first recently used screen is overlaid as a pop-up on the target recently used screen.

18. The method of claim 11, further comprising, based on a multi-touch input to the first recently used screen being received while the recent screen view is displayed, displaying a multi-window including the first recently used screen and an execution screen of a most recently executed application
19. The method of claim 11, further comprising, based on a multi-touch input to the first recently used screen and the target recently used screen being received while the recent screen view is displayed, displaying a multi-window including the first recently used screen and the target recently used screen.

20. The method of claim 18, further comprising:
based on the multi-touch input to the first recently used screen being received while the recent screen view is displayed, determining whether there is a history of generating the multi-window using the first recently used screen and whether there is a combination pattern based on an application capable of generating the multi-window together with the first recently used screen; and
based on there being the history of generating the multi-window using the first recently used screen and there being the combination pattern based on the application capable of generating the multi-window together with the first recently used screen, automatically generate and display a layout of the multi-window.
